(19) United States
(12) Patent Application Publication
(10) Pub. No.: US 2008/0241513 A1
(43) Pub. Date: Oct. 2, 2008

(54) RARE EARTH MAGNET AND MANUFACTURING METHOD THEREOF

(76) Inventors: Matahiro Komuro, Hitachi (JP); Yuichi Satsu, Hitachi (JP); Yoshii Morishita, Tsukuba (JP); Shigeaki Funyu, Tsuchiura (JP); Mitsuo Katayose, Tsukuba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/020,941

(22) Filed: Jan. 28, 2008

(30) Foreign Application Priority Data
Mar. 29, 2007 (JP) 2007-086321
Aug. 2, 2007 (JP) 2007-201444

(51) Int. Cl. B32B 5/16; B05D 5/00

(52) U.S. Cl. 428/328; 427/127

(57) ABSTRACT

A structure of a magnet wherein a magnet consisting of a magnetic body including iron and rare earths, a plurality of fluorine compound layers or oxyfluorine compound layers are formed interior of the magnetic body, and the fluorine compound layer or oxyfluorine compound layer has a major axis which is greater than the mean particle size of the crystal grains of the magnetic body.

### CLAIM OF PRIORITY

The present application claims priority from Japanese application serial No. 2007-86321, filed on Mar. 29, 2007 and serial No. 2007-201444, filed on Aug. 2, 2007, the contents of which are incorporated by reference into this application.

### FIELD OF INVENTION

The present invention relates to a rare earth magnet and a manufacturing method thereof, specifically, relates to a magnet and a manufacturing method thereof which reduces the amount of heavy rare earth element usage and has a high energy product and high thermal resistance.

### BACKGROUND OF THE INVENTION

Recently, in order to improve the properties of magnets, there has been progress in the development of a structure for a rare earth magnet, which contains a fluorine compound or oxyfluorine compound. For instance, in JP-A No. 2003-282312, JP-A No. 2006-303436, JP-A No. 2006-303435, JP-A No. 2006-303434, JP-A No. 2006-303433, technologies are disclosed in which a phase including fluorine is formed over the surface of a magnet by using a fluorine compound in the form of a powder or a mixture of a solvent and a fluorine compound in the form of a powder.

In the prior art, since a phase including fluorine is formed to be a layer-shape in NdFeB magnetic particles, ground particles of a fluorine compound, etc. is used for a raw material and there is no description of a state of the solution. Therefore, it is difficult to achieve an improvement of the magnetic properties and a decrease in the rare earth element concentration in magnetic particles where the heat-treatment temperature required for diffusion is high and the magnetic properties are deteriorated at a lower temperature than in a sintered magnet.

In the aforementioned in JP-A No. 2003-282312, JP-A No. 2006-303436, JP-A No. 2006-303435, JP-A No. 2006-303434, JP-A No. 2006-303433, since the fluorine compound used in the treatment is in the form of a powder or a mixture of powder and a solvent, it is difficult to form a phase including fluorine efficiently along the magnetic particles. Moreover, in the aforementioned prior art, since the fluorine compound which is used for the treatment for the surface of the magnetic particles makes point-contact, and the phase including fluorine does not easily make surface-contact over the magnetic particles, the amount of processed raw material and the high heat-treatment temperature which are required are more than is necessary. Furthermore, there is no description concerning iron in the fluorine compound, and there is no description concerning the content of iron in the fluorine compound.

The present invention is one which is based on these problems, and it is an objective to provide a processing method of a fluorine compound which is easier and more efficient than the prior art and a configuration of a magnet achieved by using this method.

### SUMMARY OF THE INVENTION

In order to solve the aforementioned problems, a fluorine compound solution is used in the present invention, which does not include ground particles and has optical transparency. By using these solutions, a plate-shaped or layer-shaped fluorine compound is formed at the grain boundaries or within grains and the grain size of these fluorine compound system layered materials is made greater than the mean particle size of the parent phase, thereby, an increase in the coercivity is possible which is consistent with securing the remanent flux density.

As a means for forming a fluorine compound in a layer-shape, a surface treatment using the aforementioned solution can be utilized. The surface treatment is a means where a fluorine compound which includes at least one or more selected from the group of alkali metal elements, alkaline earth elements, and rare earth elements or a fluorine oxygen compound which partially includes oxygen (hereinafter, it is called an oxyfluorine compound) is coated on the surface of the magnetic particles.

This treatment process of the magnet includes a first step for coating a fluorine compound solution over the magnetic body and a second step for removing the solvent by heating the magnetic body after the first step. At this time, as a fluorine compound solution, a solution is used where a gel fluorine compound is dispersed in an alcohol solvent. After the surface of the magnetic particles is coated with this solution, the solvent is removed by heat-treating at a temperature from 200° C. to 400° C., and oxygen, rare earth elements, and elements included in the fluorine compound diffuse to the interface between the fluorine compound and the magnetic particles during the heat-treatment at a temperature from 500° C. to 800° C.

The oxygen content included in the magnetic particles is from 10 to 5000 ppm, and, as other impurity elements, light elements such as H, C, P, Si, and Al, etc. or transition metal elements such as Mo, Cr, Ti, Nb, Cu, and Sn, etc. are included. Oxygen contained in the magnetic particles not only exists as a rare earth oxide and an oxide of a light element such as Si and Al, etc. but also exists in the parent phase and at the grain boundaries as a phase including an oxide which is a composition shifted from the stoichiometric composition. Such a phase including oxygen decreases the magnetization of the magnetic particles and influences the shape of the magnetization curve. Specifically, it causes a decrease in the value of the remanent flux density, decrease in the anisotropic magnetic field, decrease in the square-loop characteristics of the demagnetization curve, decrease in the coercivity, increase in the irreversible demagnetizing factor, increase in the thermal demagnetization, deviation of magnetization properties, deterioration of the corrosion resistance, and decrease in the mechanical properties, resulting in the reliability of the magnet being decreased. Since oxygen influences a lot of characteristics like this, a process where oxygen is not allowed to remain in the magnetic particles has been considered.

When the rare earth fluoride compound is formed over the surface of the magnetic particles, REF₃ or REF₂ is grown by heat-treatment at a temperature of 400° C. or less (RE is a rare earth element) and kept at a temperature from 500° C. to 800° C. with a vacuum level of 1×10⁻⁴ Torr or less. The holding time is 30 minutes. In this heat-treatment, iron atoms, the rare earth elements, and oxygen diffuse into the fluorine compound, and they can be seen interior of REF₃, REF₂, or RE(OF) or at the neighborhood of grain boundaries thereof.

By using the aforementioned processing liquid, it is possible to diffuse a fluorine compound interior of the magnetic particles at a relatively low temperature from 200° C. to 800° C., thereby, the following advantages can be obtained.
1) The amount of fluorine compound necessary for the treatment can be decreased.
2) Thin fluorine compound layers and thick plate-shaped fluorine compound system layers can be formed at the grain boundaries.
3) When the crystal grains of the parent phase are small, a layer-like or plate-like fluorine compound greater than the crystal grain size of the parent phase can be formed.
4) A plate-like fluorine compound can be formed discontinuously.
5) Since powder is not used, reliability is improved for components where cleanliness is required.
6) The amount of heavy rare earths can be decreased more than powder and a slurry using it, so that the diffusion length can be controlled and the diffusion length is long. According to these characteristics, effects such as an increase in the remanent flux density, an increase in the coercive force, an improvement of the square-loop characteristics of the demagnetization curve, an improvement of thermal demagnetization, an improvement of the magnetization characteristics, an improvement of the anisotropy, an improvement of the corrosion resistance, a decrease in the loss, and an improvement of the mechanical properties, etc. become noticeable.

As for the characteristics of the magnet after the fluoride compound treatment, these are in the aforementioned 2) to 4). In a magnet of the present invention, a plurality of (discontinuous) fluorine compound layers (or oxyfluorine compound layers) are formed on the interior of the magnetic body constituting the magnet. And, there is a characteristic where this fluorine compound (or oxyfluorine compound) has a larger major axis than the mean particle size of the crystal grains of the magnetic body.

Concretely, when the mean particle size of the crystal grains of the magnetic body is 10 nm or more and 50 nm or less, the major axis of the fluorine compound layer (or oxyfluorine compound layer) is 50 nm or more and 500 nm or less which is greater than that of the parent phase. Moreover, the fluorine compound layer (or oxyfluorine compound layer) has a plate-like long and slender shape and the ratio of major axis/minor axis becomes about 2 to 20.

If the magnetic body is magnetic particles herein, the fluorine compound layer (or oxyfluorine compound layer) is precipitated interior of each magnetic particle, and a magnet is formed by compression-molding such magnetic particles.

Moreover, if the magnetic body is a sintered magnet, the mean particle size of the crystal grain becomes even greater. However, even in such a case, the fluorine compound layer (or oxyfluorine compound layer) is precipitated interior of the sintered magnet.

If magnetic particles are in a NdFeB system, Nd, Fe, B, the additional elements, or the impurity elements diffuse in the fluorine compound at a heating temperature of 200° C. or more. A part of the fluorine starts diffusing at a temperature lower than 200° C. The concentration of fluorine in the fluorine compound at the above-mentioned temperature differs according to location, and REF₂, REF₃ (RE is a rare earth element), or an oxyfluorine compound thereof is formed discontinuously in a layer-like or a plate-like.

Moreover, at grain boundaries of the parent phase in the vicinity of the plate-like fluorine compound, segregation of fluorine atoms on the order of one-tenth the thickness or 2 nm or less has been observed by an electron beam energy loss analysis. However, they do not necessary segregate at all grain boundaries continuously, and layers including plate-like fluorine compounds, oxyfluorine compounds, or fluorine and a rare earth element are viewed as discontinuous due to such a morphology.

There is a possibility that a part of the fluorine atoms is substituted by boron atoms or iron atoms of the parent phase. The driving force of diffusion is temperature, stress (strain), a concentration difference, and defects, etc. and the results of diffusion can be observed by using an electron microscope. However, since diffusion can occur at a low temperature by using a solution in which ground powder of a fluorine compound is not included, the thickness of the fluorine compound easily becomes discontinuous as described-above, resulting in the amount of the fluorine compound used being reduced, and, specifically, it is effective for NdFeB magnetic particles where the magnetic properties thereof deteriorate at high temperatures. Although elements such as Nd and B in the fluorine compound are not elements which change the magnetic properties of the fluorine compound drastically, the magnetic properties can be made constant as a magnet by limiting the concentration because iron atoms change the magnetic properties of the fluorine compound depending on the concentration. The structure of the fluorine compound can be maintained by making the concentration of iron 50 atomic % or less when the total amount of elements except for B is assumed to be 100%, but if it exceeds 50%, a phase which includes a non-crystalline material or iron as a main part appears and a phase having small coercive force is admixed. Therefore, it is necessary to make the iron concentration in the fluorine compound 50% or less. Magnetic particles which have the same phase as the crystal structure of Nd₂Fe₁₄B are included in the aforementioned NdFeB magnetic particles as a main phase, and a transition metal such as Al, Co, Cu, and Ti, etc. may be included in the aforementioned main phase. Moreover, a part of B may be substituted by C. Furthermore, in addition to the main phase, compounds such as Fe₃B and Nd₂Fe₂₃B₃, etc. or oxides may be included. Since the fluorine compound layer has a higher resistance than that of NdFeB system magnetic particles at a temperature lower than 800° C., the resistance of a NdFeB sintered magnet can be increased by forming the fluorine compound layer. As a result, it is possible to decrease the loss.

It is no problem if an impurity is included in the fluorine compound layer, if it is an element which does not have ferromagnetism at around room temperature where the effect on the magnetic properties, in addition to the fluorine compound, is small. For the purpose of increasing the resistance, fine particles such as a nitrogen compound and a carbon compound may be mixed in the fluorine compound. As described above, the magnetic properties of the NdFeB system sintered magnet can be improved by using a solution treatment and a heat-treatment, so that it can be applied to a magnet for electric components which is used for an HDD and, specifically, it is suitable for a permanent magnet such as a voice coil motor and a spindle motor. Moreover, since it uses a solution treatment, it can be applied to a variety of patterning processes and etching processes; partial treatment of a 10 nm width is possible; the diffusion distance from the surface of the magnet can be controlled; and magnetic property control in the depth direction from 10 nm to 100 nm from the surface is also possible. Accordingly, it can be applied to speakers, headphones, CD optical pickups, winding motors for cameras, focus actuators, stepping motors, actuators for printers, accelerators, angulations for synchrotron radiation, polarization magnets, electrical equipment for automobiles, medical equipment such as MRI, and micro-machines, etc.

By using the present invention, a magnet having high resistance, low coercive force, and high flux density can be achieved. In addition, by applying this magnet to a rotating machine, low iron loss and high induced voltage can be enabled, and it can be applied to a magnetic circuit including a variety of rotating machines which are characterized by low iron loss.

### BRIEF DESCRIPTION OF THE DRAWINGS

FIG. 1 is a light field image from a transmission electron microscope observed in the cross-section of a magnetic particle of the present invention.

FIG. 2 is an EDX profile measured in a fluorine compound layer (1) observed in FIG. 1.

FIG. 3 is a light field image from a transmission electron microscope image observed in the cross-section of a magnetic particle of the present invention.

FIG. 4 is a structure of a voice coil motor to which a magnet of the present invention is applied.

FIG. 5A is an image from a transmission electron microscope (TEM) in the vicinity of a grain boundary in a cross-section of a magnet of the present invention.

FIG. 5B is an image from a transmission electron microscope in the vicinity of a grain boundary in a cross-section of a conventional magnet.

FIG. 6 is an example of the concentration distribution in the cross-section of a sintered magnet.

FIG. 7 is another example of the concentration distribution in the cross-section of a sintered magnet.

FIG. 8 is a still another example of the concentration distribution in the cross-section of a sintered magnet.

FIG. 9 is a further example of the concentration distribution in the cross-section of a sintered magnet.

FIG. 10 is another example of the concentration distribution in the cross-section of a sintered magnet.

FIG. 11 is another example of the concentration distribution in the cross-section of a sintered magnet.

### DETAILED DESCRIPTION OF THE PREFERRED EMBODIMENTS

Hereinafter, the best modes to execute this invention will be described as follows.

### First Embodiment

As NdFeB system powder, a quenched powder including Nd₂Fe₁₄B as a main component is formed and a fluorine compound is formed at the surface thereof. When DyF₃ is formed at the surface of the quenched powder, Dy(CH₃COO)₃ is dissolved in H₂O as a raw material and HF is added to it. By adding HF, gelatinous DyF₃.XH₂O or DyF₃.X(CH₃COO) (X is a positive number) is formed. After it is centrifuged to remove the solvent and made into a solution with optical transparency, it is mixed with the aforementioned NdFeB powder. The solvent of the mixture is evaporated, and the hydrated water is evaporated by heating. The coating film formed as described above is analyzed by using XRD. As a result, when the heating temperature is lower than 200° C., the full width at half maximum of the X-ray diffraction peak is twice larger than the peak width of that after heat-treatment, which means that a broadened peak is included. The full width at half maximum of this broadened peak is one degree or more. By using a heat-treatment higher than 200° C., the crystal structure of the fluorine compound film is changed and it was understood that it consists of DyF₃, DyF₂, and DyOF, etc.

Magnetic particles having a remanent flux density of 0.8 T or more, where a high resistance layer is formed over the surface, can be obtained by heating the NdFeB system magnetic particles having a particle size from 1 to 300 μm while preventing oxidation at a heat-treatment temperature lower than 800° C. where the magnetic properties thereof being decreased. When the grain size is smaller than 1 μm, it is difficult to be oxidized and easy to be deteriorated. When it is greater than 300 μm, the improvement effects of the magnetic properties by formation of the fluorine compound, which are an increase in resistance and other effects, become smaller. Regarding the magnetic properties of the magnetic particles, the coercive force increases about 10 to 20% by the heat-treatment at 600 to 800° C., and it becomes difficult to demagnetize.

The magnetic properties of the magnetic particles obtained are a remanent flux density of 0.8 to 1.0 T and a coercive force of 10 to 20 kOe. The resistance of the magnetic particles depends on the film thickness of the coating fluorine compound, and if the film thickness is 50 nm or more, the resistance reaches M(mega)Ω.

### Second Embodiment

As NdFeB system powder, a quenched powder including Nd₂Fe₁₄B as a main component is formed and a fluorine compound is formed at the surface thereof. When DyF₃ is formed at the surface of the quenched powder, Dy(CH₃COO)₃ is dissolved in H₂O as a raw material and HF is added to it. By adding HF, gelatinous DyF₃.XH₂O is formed. It is centrifuged to remove the solvent. When the concentration of the sol-state rare earth fluorine compound is 10 g/dm³ or more, the permeability of an optical path length of 1 cm is 5% or more in a wavelength of 700 nm for the processing liquid. Such a solution with optical transparency is mixed with the aforementioned NdFeB powder. The solvent of the mixture is evaporated, and the hydrated water is evaporated by heating.

It is understood that the crystal structure of the fluorine compound film consists of a NdF₃ structure and NdF₂ structure, etc. by performing the heat-treatment at 500° C.

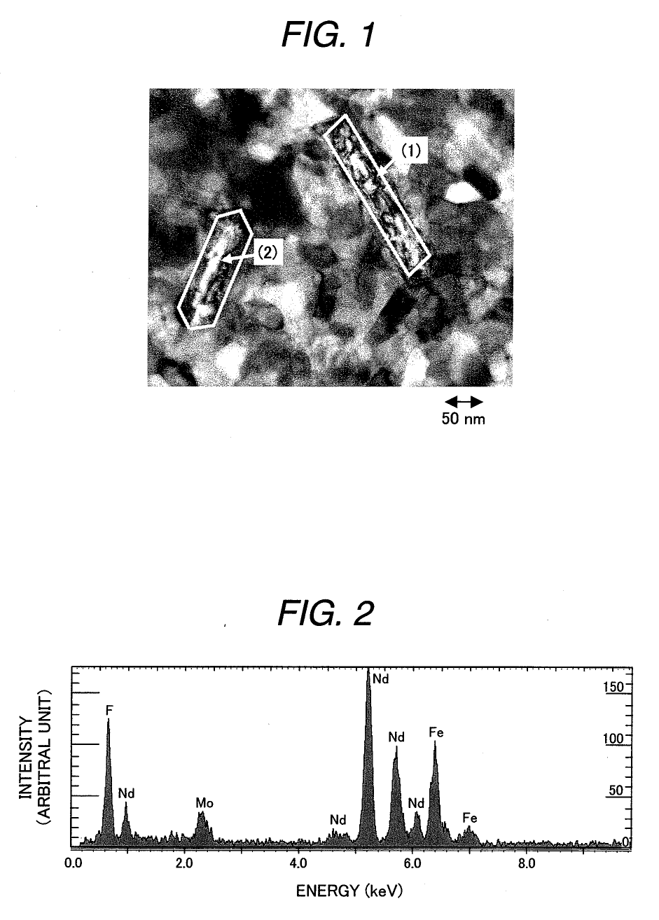

The cross-section of a magnetic particle after the heat treatment was observed by using a transmission electric microscope. A light field image is shown in FIG. 1. The crystal grain size of the parent phase was 50 nm or less and the crystal orientation was random. A plate-like crystal greater than the crystal grain size of the parent phase could be confirmed, and, as shown in the arrow of (1) and (2) in FIG. 1, the morphology is different from that of the parent phase. The major axis of the plate-like crystal of (1) has a length of about 250 nm and the major axis of the plate-like crystal of (2) is about 150 nm, which are greater than the particles of the parent phase (50 nm or less). Contrast is observed in the plate-like crystals.

It is considered that the contrast is due to different crystal orientations of the plate-like crystals, their being divided into crystal particles, or strain being induced. As shown in (1) and (2) of FIG. 1, the plate-like crystals are separated by the crystal grains of the parent phase and are not continuous, and they are not grown on all crystal grain boundaries of the parent phase.

The length of the minor axis of the plate-like crystals is about 20 to 50 nm and it is the same as or less than the thickness of the crystal grains of the parent phase. The axis ratio of the major axis/minor axis of the plate-like crystals is from 2 to 20. They also exist at the center of the magnetic particles and grow at the grain boundaries of the parent phase or within crystal grains of the parent phase. Contrast is observed so as to surround the plate-like crystals. It is suggested that lattice strain exists between the plate-like crystals and the parent phase. This plate-like crystal is one formed by reacting a part of the parent phase with fluorine elements and rare earth elements which are diffused from the fluorine compound coated outside of the magnetic particles through the grain boundaries of the parent phase by the heat-treatment.

Accordingly, in this embodiment, it is characterized that the plate-like crystals of the fluorine compound layer are formed even interior of the NdFeB system magnetic particles and that the size of the plate-like crystals is greater than the mean particle size of the crystal grain of the parent phase.

FIG. 2 shows an EDX profile which is measured at the position (1) (diameter of 10 nm) in FIG. 1.

As peaks in the EDX, fluorine (F), neodymium (Nd), iron (Fe), and molybdenum (Mo) are observed. Mo is used as a sample mesh of the electron microscope, so that it is not related to the magnetic particles. Peaks detected from the sample are three elements: F, Nd, and Fe. Herein, the elements which exist before the coating process in the parent phase are Nd and Fe. The ratio of Fe:Nd:F is 14:15:71. As a consequence of various evaluations, the ratio of rare earth: fluorine was in the range from 1:1 to 1:7.

Moreover, there are some cases where peaks of oxygen and carbon are observed in an EDX profile which includes fluorine, so that it is considered that the plate-like crystals of (1) and (2) are composed of F, Nd, Dy, Fe, C, and O. Since B is unclear because it cannot be detected by EDX, there is no wonder if a part of it diffuses and exists with the fluorine. Although the plate-like crystals of (1) and (2) are fluorine compounds, oxyfluorine compounds, or oxyfluorine carbon compounds, the main component is a fluorine compound which partially contains oxygen or an oxyfluorine compound which partially contains fluorine.

The aforementioned plate-like crystals include more Nd than Dy, but more Dy is included in a part of the diffusion path for forming the plate-like crystals compared with that in the plate-like crystals. As a consequence of these results, it can be presumed that the concentration distributions of rare earth elements, oxygen, and fluorine in the plate-like crystals and along the diffusion path of the plate-like crystals contribute to an increase in the coercive force. Accordingly, it is considered that segregation of Dy and Nd along the diffusion path where the plate-like crystals are formed and segregation of Nd and Dy in the plate-like crystals contribute to an increase in the anisotropic energy and improvement of lattice-matching at the grain boundaries, and that the reduction of the parent phase by fluorine contributes to an improvement of the magnetic properties, decrease in Nd₂Fe₁₄B in the vicinity of the grain boundaries and decrease in the magnetic moment fluctuation at the grain boundaries.

### Third Embodiment

The processing liquid for forming a coating film of rare earth fluoride or alkaline earth metal fluoride is prepared by adding a rare earth acetate or alkaline earth metal acetate into water and then adding diluted hydrofluoric acid into it. After the gel-state precipitation of fluorine compound or oxyfluorine compound or the solution where oxyfluorine carbide is formed is stirred by using ultrasonic stirrer and centrifuged, methanol is added and gel-state methanol solution is stirred to remove anion and made it transparent.

The anion is removed until the permeability being 5% or more in visible light. This solution is coated over the magnetic particles and the solvent is removed. As NdFeB system power, a quenched powder including Nd₂Fe₁₄B as a main structure is formed and Dy fluorine compound is formed at the surface thereof. As described above, after a solution with optical transparency is mixed with the aforementioned NdFeB powder, solvent of the mixture is evaporated. By the heat-treatment at 200 to 700° C. and quench after the heat-treatment, the crystal structure of the fluorine compound film becomes an NdF₃ structure and NdF₂ structure, etc. The cross-section of a magnetic particle after the heat-treatment was observed by using a transmission electric microscope.

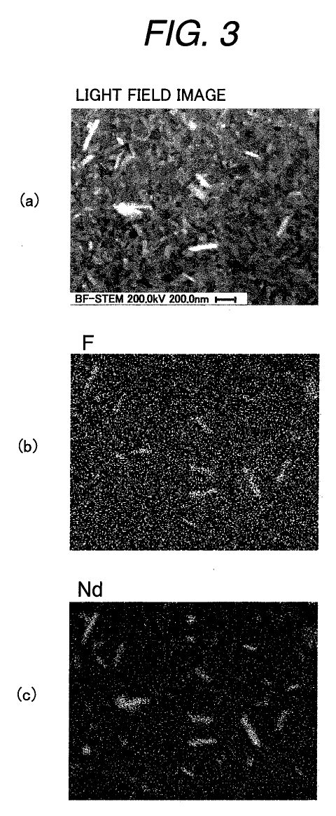

A light field image is shown in FIG. 3. White plate-like and layer-like crystals are observed in the light field image. The crystal grain size of the parent phase is 50 nm or less and many major axes of the plate-like crystals are larger than these of the crystal grains of the parent phase, and the length of the minor axes thereof is the same or smaller than these of the crystal grains of the parent phase. Moreover, the plate-like crystals are grown contacting with a plurality of crystal grains of the parent phase and the direction of the major axes was almost random. Below the light field image, analysis images of F (fluorine) and Nd (neodymium) are shown. The position of observation is the same as the analysis position for the light field image, F, and Nd.

As shown in the F and Nd analysis images below, the plate-like crystals which are observed as white particles are the places where the concentrations of F and Nd are high. Accordingly, it is understood that the plate-like crystals include a rare earth element and fluorine. As a consequence of observations of the selected area electron diffraction images of the plate-like crystals, it has a base structure of the rare earth fluorine compound. Although the structure has a base structure of NdF₂ and NdF₃, oxygen is partially included, so that there is a possibility that it becomes an oxyfluorine compound. If the processing liquid is only heat-treated, it has a structure of an NdF₃ structure and the fluorine concentration of the plate-like crystal is lower than the fluorine concentration of a fluorite compound formed of only the processing liquid. It is indicated that the fluorine compound existing around the periphery of the magnetic particles reacts with the magnetic particles during the heat treatment after the surface treatment, and that fluorine atoms around the periphery thereof migrate with rare earth atoms.

From the above-mentioned results, it is assumed that concentration distributions of the rare earth element, oxygen, and fluorine in the plate-like crystals or along the diffusion path in the plate-like crystals contribute to an increase in the coercive force. Accordingly, it is considered that segregation of Dy and Nd along the diffusion path where the plate-like crystals are formed and segregation of Nd, Dy, and fluorine in the plate-like crystals contribute to an increase in the anisotropic energy and improvement of lattice-matching at the grain boundaries, and that the reduction of the parent phase by fluorine contributes to improvement of the magnetic properties.

Fluorine compounds which give any effects of improvement in the coercive force, improvement of the square-loop characteristics, increase in the resistivity after molding, decrease in the temperature dependence of the coercive force, decrease in the temperature dependence of the remanent flux density, improvement of the corrosion resistance, increase in the mechanical properties, improvement of thermal conductivity, and improvement of adhesion performance are LiF, MgF₂, CaF₂, ScF₃, VF₂, VF₃, CrF₂, CrF₃, MnF₂, MnF₃, FeF₂, FeF₃, CoF₂, CoF₃, CuF₂, CuF₃, NiF₂, ZnF₂, AlF₃, GaF₃, SrF₂, YF₃, ZrF₃, NbF₅, AgF, InF₃, SnF₂, SnF₄, BaF₂, LaF₂, LaF₃, CeF₂, CeF₃, PrF₂, PrF₃, NdF₂, SmF₂, SmF₃, EuF₂, EuF₃, GdF₃, TbF₃, TbF₄, DyF₂, NdF₃, HoF₂, HoF₃, ErF₂, ErF₃, TmF₂, TmF₃, YbF₃, YbF₂, LuF₂, LuF₃, PbF₂, BiF₃, or a compound where oxygen and carbon are included in a fluorine compound thereof, in addition to DyF₃. They can be formed by surface treatment where a solution having the permeability of visible light or a solution where a CH base is combined with a part of the fluorine; a plate-like fluorine compound and an oxyfluorine compound are observed along the grain boundaries and within the grains.

Table 1 shows a summary of the chemical formulae of the fluorine compounds in which an improvement of the magnetic properties was observed.

TABLE 1

| Elements | | | | | |
|---|---|---|---|---|---|
| contained in a | | | | | |
| fluorine | | | | | |
| compound | | | | | |
| solution | Diffraction Peaks | | | | |
| Li | LiF₃, LiF₂ | NdF₃ | NdF₂ | NdOF | LiOF |
| Mg | MgF₂ | NdF₃ | NdF₂ | NdOF | MgOF |
| Ca | CaF₂ | NdF₃ | NdF₂ | NdOF | CaOF |
| La | LaF₃, LaF₂ | NdF₃ | NdF₂ | NdOF | LaOF |
| Ce | CeF₃, CeF₂ | NdF₃ | NdF₂ | NdOF | CeOF |
| Pr | PrF₃, Pr₂F₂ | NdF₃ | NdF₂ | NdOF | PrOF |
| Nd | NdF₃ | NdF₃ | NdF₂ | NdOF | NdOF |
| Sm | SmF₃, SmF₂ | NdF₃ | NdF₂ | NdOF | SmOF |
| Eu | EuF₂, EuF_{2.55} | NdF₃ | NdF₂ | NdOF | EuOF |
| Gd | GdF₃ | NdF₃ | NdF₂ | NdOF | GdOF |
| Tb | TbF₃ | NdF₃ | NdF₂ | NdOF | TbOF |
| Dy | DyF₃ | NdF₃ | NdF₂ | NdOF | DyOF |
| Ho | HoF₃ | NdF₃ | NdF₂ | NdOF | HoOF |
| Er | ErF₃ | NdF₃ | NdF₂ | NdOF | ErOF |
| Tm | TmF₃ | NdF₃ | NdF₂ | NdOF | TmOF |
| Yb | YbF₂, YbF_{2.37} | NdF₃ | NdF₂ | NdOF | YbOF |
| Lu | LuF₃ | NdF₃ | NdF₂ | NdOF | LuOF |

In addition to the NdF₂ structure and the NdF₃ structure, oxyfluorine compounds including rare earth oxyfluorine compounds and components of each processing liquid were detected. Although there is a case where a light element in addition to fluorine is observed in the material as a result of Auger analysis, it hardly influences the demagnetization curve. Moreover, even if a transition metal element is segregated to a part of the crystal grain boundaries, an improvement effect of the aforementioned magnetic properties could be confirmed.

### Fourth Embodiment

A gel or sol state rare earth fluorine compound solution having optical transparency was coated over the surface of a NdFeB sintered magnet. The film thickness of the rare earth fluorine compound after coating was 1 to 10000 nm. The NdFeB sintered magnet is a sintered magnet, which contained Nd₂Fe₁₄B as a main component and, at the surface of the sintered magnet, deterioration of the magnetic properties due to polishing or oxidation was observed.

In order to mitigate such a deterioration of magnetic properties, after a rare earth fluorine compound which has the permeability of visible light is coated on the surface of the sintered magnet and dried; heat-treatment is performed at a temperature of 500° C. or more and at the sintering temperature or less. Particles of 50 nm or less and 1 nm or more are grown from the gel or sol state rare earth fluorine compound solution after coating and drying; the structure around the fluorine atoms in the solution changes from a random structure to a periodic structure; and reaction with the grain boundaries and the surface of the sintered magnet and diffusion occur by further heating. The fluorine compound is formed at almost the entire surface of the sintered magnet; and, after coating and drying, a part of the area where the rare earth element concentration is high is fluorinated at a part of the crystal grain surface of the surface of the sintered magnet before performing the heat-treatment at a temperature of 500° C. or more.

When a Dy fluorine compound or Tb and Ho fluoride compounds are used among the aforementioned rare earth fluorine compounds, Dy, Tb, and Ho, etc. which are included as the component diffuse along the crystal grain boundaries, resulting in less deterioration of the magnetic properties and an improvement in the square-loop characteristics. When the heat-treatment temperature is 800° C. or more, the mutual diffusion of the fluorine compound and the sintered magnet progresses further and Fe with a concentration of 10 ppm or more is contained in the fluorine compound layer. With increasing heat-treatment temperature, there is a tendency for the concentration of elements constituting the parent phase diffusing into the fluorine compound layer to increase.

When sintered magnets are stacked and bonded to each other, the same fluorine compound which is diffused to improve the magnetic properties or other fluoride compound or oxyfluorine compound, which becomes the adhesive layer, is coated after the aforementioned heat-treatment and stacked on each other, and only the vicinity of the adhesion layer is heated by irradiating millimeter waves, resulting in the sintered magnets being bonded to each other. The fluorine compound for the adhesion layer is a Nd fluorine compound, etc. (NdF₂₋₃, Nd(OF)₁₋₃) and it is possible to selectively heat up in the vicinity of only the adhesion layer while suppressing the temperature increase at the center of the sintered magnet by selecting the irradiation conditions of millimeter waves, and it is possible to suppress deterioration of the magnetic properties and dimensional changes of the sintered magnet associated with adhesion process.

Moreover, the heat treatment time of the differential heating can be made half or less of the conventional heat treatment time by using millimeter waves, so that it is preferable for mass production where an improvement of the magnetic properties is possible during the adhesion process. Millimeter waves can be utilized for not only adhesion of the sintered magnet but also for improvement of the magnetic properties by diffusion of the coating material, and the function of the adhesion layer can be achieved by using a material, such as an oxide, a nitride compound, and a carbide, etc. where the dielectric loss is different from the NdFeB of the parent phase, in addition to a fluorine compound.

Although it can be diffused by heating it even if millimeter waves are not used, the fluorine compound is selectively heated by using millimeter waves and utilized for adhering and joining the magnetic material, various metallic materials, and oxide materials. As for the conditions of the millimeter waves, irradiation is performed under the conditions of 28 GHz and 1 to 10 kW in Ar or N₂ atmosphere, in vacuum, or in another inert gas atmosphere for 1 to 30 minutes. Since the fluorine compound or oxyfluorine including oxygen is selectively heated up by using millimeter waves, it is possible to diffuse only a fluorine compound along the grain boundaries without changing the structure of the sintered body; diffusion of the elements constituting the fluorine compound to the interior of the crystal grains can be prevented; superior magnetic properties (any of high remanent flux density, improvement of square-loop characteristic, high coercive force, high Curie point, low thermal demagnetization, high corrosion resistance, high resistance, high strength, and low thermal expansion, etc.) can be obtained than in the case where it is simply heated up.

In addition, by selecting the conditions of the millimeter waves and the fluorine compound, it is possible to diffuse the elements constituting the fluorine compound into an area deeper from the surface of the sintered magnet than by performing a conventional heat treatment, so that it is possible to diffuse them into the center of a magnet having dimensions of 10×10×10 cm. The magnetic properties of a sintered magnet having a crystal grain size from 1 to 30 μm which is obtained by using these technique are a remanent flux density of 1.0 to 1.6 T and a coercive force of 20 to 50 kOe, and the concentration of heavy rare earth elements contained in the rare earth sintered magnet which has the same magnetic properties can be made smaller than the case of using a conventional heavy rare earth added NdFeB system magnetic particles.

Moreover, if 1 to 100 nm of fluorine compound or oxyfluorine compound including at least one of an alkali, alkaline earth and rare earth element remains at the surface of the sintered magnet, the resistance of the surface of the sintered magnet becomes higher and eddy current loss can be decreased even if it is adhered, resulting in a loss reduction being achieved in a high frequency magnetic field. Since heat generation in the magnet can be decreased due to such a loss reduction, the amount of the heavy rare earth elements used can be reduced. Accordingly, properties of the sintered magnet can be improved by performing a fluorine compound solution treatment and a subsequent heat treatment, and it can be applied to all application products of a sintered magnet because the amount of heavy rare earth element used can be decreased.

For the solution used for processing, it is also possible to keep a part from the recycling process of the sintered magnet and to extract it from the refinery process of Nd. In order to promote the diffusion of fluorine and heavy rare earth elements, a decrease in the viscosity of the solution, an increase in active fluorine atoms, optimization of the structure around the fluorine atom, control of the ionic bond, control of the concentration of ionic element, control of the treatment atmosphere, and decrease in the impurity element are promoted, and a continuous process is possible where automatic processing of liquid production, treatment, film thickness control, heat treatment, and magnetic property evaluation are included. Since the composition elements in the solution diffuse into the sintered magnet by heat treatment, the processing deterioration of the sintered magnet is improved; the processing deterioration becomes smaller than before the heat treatment even if it is processed again; and it is possible that the magnetic properties can be recovered only by heat treatment such as local heating without surface treatment, even if it is slightly deteriorated by processing.

By selecting fluorine and other elements included in the solution appropriately, the diffusion treatment using such a solution can be applied to not only a NdFeB system sintered magnet, a SmCo system sintered magnet, and other magnets but also all magnetic materials which have grain boundaries such as a Fe system, an FeCo system, and an oxide system, etc. and it can be used for all bulk, thin film, fine particle materials which have grain boundaries and interfaces when the purpose is not for an improvement of the magnetic properties but the purpose is for an increase in the electrical resistance, improvement of strength, improvement of the corrosion resistance, and improvement of optical characteristics, etc. Since the aforementioned rare earth fluorine compound is not powder and has a low viscosity, it is possible to coat even inside a fine hole from 1 nm to 100 nm, so that it can be applied to a fine magnet component for improving the magnetic properties. And, this magnet can be applied to a commutator type or brushless type permanent magnet motor, a disk type armature DC motor, a flat motor, a voice coil motor, a stepper motor, a canstack motor, a magnet sensor, an actuator, and a magnetic shaft bearing, etc.

Moreover, the processing liquid used for the fluorine compound treatment can be applied to a coating medium or a coating magnet having an arbitrary shape by mixing magnetic particles, and can also applied to variety of magnetic fluids. The magnet where fluorine is segregated in the vicinity of grain boundaries can improve reliability further by forming a protection film such as a resin and a metal, etc. over the surface according to the usage.

### Fifth Embodiment

Fe of 1 atomic % or more is added to a fluorine compound solution having the permeability of visible light to form a gel or sol-state Fe fluorine compound in which Fe ions or Fe clusters are mixed. At this time, a part of the Fe atoms is chemically coupled with one or more elements either of fluorine in the fluorine compound, alkali, alkaline earth, Cr, Mn, V or a rare earth element included in the fluorine compound. By irradiating millimeter waves or microwaves to such a gel or sol state fluorine compound or fluorine compound precursor, the number of atoms which contribute to the chemical coupling between fluorine atoms, Fe atoms, and one or more aforementioned elements included in the fluorine compound becomes greater, thereby, a ternary or greater compound system of fluorine compound which includes Fe fluoride and one or more of elements contained in the aforementioned fluorine compound is formed, and a fluorine compound having a coercive force of 10 kOe or more can be synthesized by irradiating millimeter waves.

A part of the Fe ions or another transition metal element may be added as an alternative. According to such a means, a magnetic material can be obtained without a melting and grinding process for obtaining magnetic particles as in the prior art, and it is applied to various magnetic circuits. If the alkali, alkaline earth, Cr, Mn, V, or a rare earth element contained in the aforementioned fluorine compound is assumed to be M, gel or sol state magnets with high coercive force of Fe-M-F system, a Co-M-F system, and a Ni-M-F system magnets can be obtained in a gel or sol-state using a fluorine compound in the form of a solution. And, they can be manufactured by coating and irradiating millimeter waves over a variety of substrates which are difficult to be dissolved by irradiation of millimeter waves, so that it can be applied to a magnetic component having a shape which is difficult to machine.

The structure and composition of fluorine atoms and M atoms relate to the coercive force of these materials and nano-particle state magnetic particles can be formed by heating the gel or sol, and the segregation of fluorine or M atoms in the nano particles is related to the high coercive force. One may be obtained where the properties of the coercive force and the remanent flux density are 5 kOe or more and 0.5 T or more, respectively. If atoms such as oxygen, carbon, nitrogen, and boron, etc. are mixed in the fluorine compound magnet, the effects on the magnetic properties are small. A material having a luminescence property maybe obtained in such a material system and it can be applied to an optical magnet application element, etc. as a magneto-optic material, and, using a material with high coercive force which includes fluorine from 0.1% to 80%, a permanent magnet having permeability of visible light can be formed and it is applied to an optical element. Specifically, a magnet including fluorine of 10% or more is a material having the permeability at a specific wavelength and a material including fluorine from 15% to 80% can be manufactured as a magnet with permeability of visible light.

### Sixth Embodiment

A fluorine compound solution through which visible light permeates is coated over the surface of the SmFeN system magnetic particles with a grain size of 0.1 to 100 μm. The fluorine compound is a compound including at least one or more selected from alkali, alkaline earth, and rare earth elements. Coated SmFeN system magnetic particles are introduced into the mold and compressed to form a green molded body while orientating the magnetic particles in the magnetic field direction in a field of 3 to 20 kOe. Heating the green molded body, which is anisotropic was done by millimeter wave irradiation to selectively heat the fluorine compound. Deterioration of the magnetic properties with changing of the structure of the SmFeN system magnetic particles while heating is suppressed and the fluorine compound becomes a binder, thereby, an isotropic magnet could be manufactured. As a result, a magnet can be obtained where SmFeN magnetic particles are bonded by the fluorine compound.

An SmFeN anisotropic magnet having a remanent flux density of 1.0 T or more can be obtained by making the volume of fluorine compound 0.1 to 3%. After forming the green molded body, the fluorine compound solution is impregnated and heat-treated, thereby, the magnetic properties may be improved. Although Sm—Fe—N—F or Sm—Fe—N—O is partially formed, any effect of an increase in coercive force, an improvement of square-loop characteristics, and an increase in remanent flux density is observed by reaction with the fluorine compound. When it is nitride system magnetic particles such as the SmFeN system, by forming the SmFeN system magnetic particles using millimeter waves irradiation to the SmFe powder, an increase in the coercive force is noticeable due to nitrides than in the case of a conventional ammonia nitride, resulting in a coercive force of 20 kOe or more being obtained. Bonding it as a fluorine compound using millimeter waves can be applied to other iron system materials, such as an SmFeCo system, an Fe—Si system, an Fe—C system, an FeNi system, an FeCo system, an Fe—Si—B system, and a cobalt system magnetic material, such as a SmCo system, a CoFeSiB system, a CoNiFe system, and an AlCoNi system. It can be applied to the formation of soft magnetic particles, soft magnetic ribbon, a soft magnetic molded body, hard magnetic powder, hard magnetic ribbon, and a hard magnetic molded body without losing the magnetic properties, and adhesion of other metallic materials is also possible.

### Seventh Embodiment

Fine particles including 1 atomic % or more of Fe with a grain size of 1 to 100 μm is added to a fluorine compound solution which is permeable to visible light to form a gel or sol-state Fe fluorine compound where Fe system fine particles are mixed. At this time, a part of the Fe atoms over the surface of the fine particles is chemically coupled with one or more elements either of fluorine in the fluorine compound, alkaline, alkaline earth, or a rare earth element included in the fluorine compound. By irradiating millimeter waves or microwaves to such a gel or sol-state fluorine compound or a fluorine compound precursor which includes fine particles, the number of atoms which contributes to the chemical coupling between fluorine atoms, Fe atoms, and one or more of the aforementioned elements included in the fluorine compound becomes greater, thereby, a ternary or greater compound system of a fluorine compound which includes Fe fluoride and one or more of elements contained in the aforementioned fluorine compound is formed, and a fluorine compound having a coercive force of 10 kOe or more can be synthesized by irradiating millimeter waves or microwaves. Other transition metal fine particles may be added instead of Fe system fine particles.

According to such a means, a magnetic material can be obtained without a melting and grinding process for obtaining magnetic particles as in the prior art, and it can be applied to various magnetic circuits. If the alkaline, alkaline earth, or a rare earth element contained in the aforementioned fluorine compound is assumed to be M, an Fe-M-F system, a Co-M-F system, and a Ni—N—F system magnet can be obtained in a gel stale or sol state, and a magnet with high coercive force can be obtained by using a means where the fine particles are added to the fluorine compound in the form of solution, and since they can be manufactured by coating them over various substrate and by irradiating millimeter waves, it can be applied to a magnetic component having a shape which is difficult to machine. If atoms such as oxygen, carbon, and nitrogen, etc. are mixed in the fluorine compound magnet, effects on the magnetic properties are small.

The aforementioned optically transparent fluorine compound is introduced in a shape, which is patterned by using a resist, and it is dried and heat-treated at a temperature lower than the thermal resistance temperature of the resist. Moreover, if it is heated up after removing the resist, the coercive force is increased. The aforementioned sol or gel-state fluorine compound is injected or coated over a space where the resist gap is 10 nm or more and the magnet thickness is 1 nm or more, and a three-dimensional shaped magnet can be formed without mechanical processing and small type magnets can be manufactured without a physical technique such as vapor deposition and sputtering techniques, etc. Such an Fe-M-F system magnet can absorb only light with a specific wavelength by adjusting the fluorine concentration. Therefore, such a fluorine compound can be applied to components, such as optical components and optical recording devices, etc. or a surface treatment material for the components.

### Eighth Embodiment

Particles containing at least one or more of rare earth elements with a particle size from 10 to 10000 nm are added to a fluorine compound having the permeability of visible light. As an example of particle, particles including a structure of Nd₂Fe₁₄B as a main phase are used and a fluorine compound is coated over the surface of the aforementioned particles. By using the mixing ratio of the fluorine compound solution and particles or the coating conditions as the parameter, the coating ratio of the particle surface can be changed; the increase effect of the coercive force by fluorine compound can be observed when the coating ratio becomes 1 to 10%; when it becomes 10 to 50%, an improvement of the square-loop characteristics of the demagnetization curve or an increase in Hk (the magnetic field on the demagnetization curve at 90% remanent flux density) (increase in the absolute value of the magnetic field) is observed in addition to the increase effect of the coercive force; and, moreover, an increase in resistance after molding can be observed when the coating ratio is 50 to 100%. Herein, the coating ratio is the area covering the coated material relative to the surface area of the particles.

After green molding in a magnetic field by using particles having a coating ratio of 1 to 10%, a sintered magnet is obtained by hot molding at a temperature of 800° C. or more. The fluorine compound for coating was a fluorine compound, which includes at least one or more rare earth elements. Since a fluorine compound solution was used, the fluorine compound could be coated along the interface of the crystal grain boundaries in a layer state or a plate state, so that it is coated in a layer state along the shape of the surface thereof even if there is roughness. When particles with a coating ratio of 1 to 10% are used, rare earth elements, which are a part of the layer-form fluorine compound diffuse along the crystal grain boundaries by performing the heat-treatment after green molding in a magnetic field.

When the fluorine compound is coated over Fe system particles, a part of the particle surface where there is no coating material is fluorinated. Therefore, even in particles with a coating ratio of 1 to 10% and even if the area where the fluorine compound is formed is 1 to 10%, it is fluorinated, though 90% of the particle surface depends on the composition and surface morphology of the particles, resulting in the magnetic properties of the interface being changed and the resistance of the particle surface being increased. Since rare earth elements are easy to fluorize, the higher the rare earth concentration at the particle surface, the higher the resistance of the particle surface because a part of the particle surface is fluorinated when it is coated with a gel state or a sol state fluorine compound.

When such high resistance particles are sintered, rare earth elements within grains are coupled with fluorine at the particle surface and a structure is created where rare earth elements are segregated in the vicinity of grain boundaries, resulting in the coercive force being increased. Specifically, fluorine exerts a trapping effect of the rare earth atoms and the rare earth elements are segregated at the grain boundaries by suppressing the intra-grain diffusion of the rare earth elements, resulting in the coercive force being increased, the concentration of intra-grain rare earth elements being decreased, and a high remanent flux density being obtained.

### Ninth Embodiment

Particles containing at least one or more rare earth elements with a particle size from 10 to 10000 nm are added to a fluorine compound solution having the permeability of visible light. As an example of a particle, particles which include a Nd₂Fe₁₄B structure as a main phase, fine magnets, or powder which become fine magnets after heat-treatment, are used; a fluorine compound is in contact with the surface of the aforementioned particles or powder; and the fluorine compound coating solution sticking to the surface is removed by using a solvent. Congregated fluorine compound is made so as not to remain over the particle surface as much as possible, and the residue of the coating material is made 10% or less of the average coating ratio. Therefore, although 90% or more of particle area on average becomes the area where the coating material is not formed (coated clear fluorine compound is not observed even if it is enlarged 10,000 times by using a scanning electron microscope), apart of the rare earth elements included in the particles is fluorinated in a part of this area, resulting in a layer containing a lot of fluorine. Accordingly, the reason why a part of the particle surface is fluorinated is due to the fact that rare earth elements combine easily with fluorine atoms, and the surface is hardly fluorinated when there are no rare earth elements.

When a part of the rare earth elements is fluorinated, they are easily combined with oxygen atoms, so that there is a case where it becomes an oxyfluorine compound. However, a phase including rare earth elements combining with fluorine is formed at the particle surface. Such compression molding is performed in a magnetic field by using fluorinated particles, and, after that, an anisotropic sintered magnet is manufactured by sintering. After the compression molding in a magnetic field, it is possible that the particle surface and the surface of the cracked part of the particles are partially covered with the fluorine compound precursor by impregnating the aforementioned fluorine compound solution into the green molded body with a density in the range from 50 to 90%, and, according to such an impregnation treatment, from 1 to 100 nm of the fluorine compound can cover the particle surface including a part of the cracks, thereby, contributing to an any effect of an increase in the coercive force, improvement of the square-loop characteristics, increase in the resistance, decrease in the remanent flux density, decrease in the amount of usage of a rare earth element, improvement of the mechanical strength, and added anisotropy of the magnetic particles, etc.

Diffusion of fluorine and rare earth elements is also performed while sintering. Compared with the case where there is no fluorizing, an increase in the coercive force due to fluorizing becomes noticeable with an increase in the addition of the heavy rare earth element. The concentration of heavy rare earths in order to obtain a sintered magnet having the same coercive force can be made smaller by fluorizing. Since a structure where the heavy rare earth elements are segregated in the vicinity of the grain boundaries is created because the heavy rare earth elements become easy to segregate in the vicinity of the fluorinated phase due to fluorizing, it is considered that a high coercive force will result. The width where such heavy rare earth elements are segregated is about 1 to 100 nm from the grain boundaries.

### Tenth Embodiment

A fluorine compound having the permeability of visible light is coated over oxide particles with a particle size from 1 to 10000 nm which includes at least one or more rare earth elements, and it is heat treated in a temperature range from 800° C. to 1200° C. or heated by using millimeter waves. Oxyfluorine compound is partially formed by heating.

By using a solution which includes at least one or more rare earth elements as a fluorine compound solution, the magnetic properties of barium ferrite or strontium ferrite particles, which are the oxide, are improved by formation of an oxyfluorine compound or a fluorine compound, resulting in improvement of the coercive force, improvement of the square-loop characteristics of the demagnetization curve, and improvement of the remanent flux density being observed. Especially, an increase effect of the remanent flux density is great when a fluorine compound solution including 1% of iron is used. The aforementioned oxide particles of the oxyfluorine compound may be manufactured by using a sol-gel process.

### Eleventh Embodiment

Co or Ni of 1 atomic % or more is added to a fluorine compound solution having optical transparency and a gel or sol state Co or Ni-fluorine compound solution is made, in which Co or Ni ions or Co or Ni clusters are mixed. At this time, a part of the Co or Ni atoms is chemically coupled with one or more elements either of fluorine in the fluorine compound, alkali, alkaline earth, or a rare earth element included in the fluorine compound.

By irradiating millimeter waves or microwaves to such a fluorine compound or fluorine compound precursor having optical transparency and drying it, the number of atoms which contribute to the chemical coupling between fluorine atoms, Co or Ni atoms, and one or more of the aforementioned elements included in the fluorine compound becomes greater, thereby, a ternary or greater compound system of fluorine compounds which includes Co or Ni fluorine and one or more elements contained in the aforementioned fluorine compound is formed, and a fluorine compound having a coercive force of 10 kOe or more can be synthesized by irradiating millimeter waves.

Other transition metal element ions may be added as a part of the Co or Ni ions or instead of them. According to such a means, a magnetic material can be obtained without a melting and grinding process for obtaining magnetic particles as in the prior art, and it can be applied to various magnetic circuits. If the alkali, alkaline earth, or rare earth element contained in the aforementioned fluorine compound is assumed to be M, an Fe-M-F system, a Co-M-F system, and a Ni-M-F system magnet can be obtained by using a fluorine compound solution with optical transparency to make a magnet with high coercive force or magnet particles. And, they can be manufactured by coating and irradiating millimeter waves over a variety of substrates which are difficult to be dissolved by irradiation of millimeter waves, so that it can be applied to a magnetic component having a shape which is difficult to machine.

If atoms such as oxygen, carbon, and nitrogen are mixed in the fluorine compound magnet, effects on the magnetic properties are small.

### Twelfth Embodiment

Fine particles including Fe of 1 atomic % or more with a particle size from 1 to 100 nm are added to a fluorine compound system solution having the permeability of visible light, and a Fe-fluorine compound in which Fe system fine particles are mixed. At this time, a part of the Fe atoms at the surface of the fine particles is chemically coupled with one or more elements either of fluorine in the fluorine compound, alkali, alkaline earth, or a rare earth element included in the fluorine compound.

By irradiating millimeter waves or microwaves to such a fluorine compound or fluorine compound precursor having low viscosity and optical transparency which includes fine particles or clusters, the number of atoms which contribute to the chemical coupling between fluorine atoms, Fe atoms, and one or more aforementioned elements included in the fluorine compound becomes greater, thereby, a part of the magnetization between Fe atoms becomes ferromagnetic due to any one of coupling between Fe atoms and rare earth elements using fluorine atoms, coupling between fluorine atoms and oxygen atoms and between Fe and rare earth elements, and coupling where rare earth elements are coupled with fluorine atoms, oxygen atoms, and Fe atoms.

Moreover, the magnetization of a part of the Fe atoms has an antiferromagnetic coupling. A structure is created, which has an advantage for the ferromagnetic coupling by irradiating millimeter waves or microwaves, resulting in a fluorine compound including Fe with a coercive force of 10 kOe being synthesized. Fine particles of other transition metal element may be added instead of Fe system fine particles. Specifically, even for a transition metal element, such as Cr, Mn, and V, etc. except for Co and Ni, a permanent magnetic material can be obtained without a melting and grinding process for obtaining magnetic particles as in the prior art by using such a means, and it can be applied to various magnetic circuits.

### Thirteenth Embodiment

Fine particles including Fe of 1 atomic % or more with a particle size from 1 to 100 nm are added to a fluorine compound solution having optical transparency, and a Fe-fluorine compound in which Fe system fine particles are mixed is manufactured. At this time, apart of the Fe atoms at the surface of the fine particles is chemically coupled with one or more elements either of fluorine in the fluorine compound, alkali, alkaline earth, or a rare earth element included in the fluorine compound. By irradiating millimeter waves or microwaves to such a fluorine compound or fluorine compound precursor having low viscosity which includes fine particles or clusters, the number of atoms which contribute to the chemical coupling between fluorine atoms, Fe atoms, and one or more of the aforementioned elements included in the fluorine compound becomes greater, thereby, a part of the magnetization between Fe atoms becomes ferromagnetic and magnetic anisotropy appears due to any one of coupling between Fe atoms and rare earth elements using fluorine atoms, coupling between fluorine atoms and oxygen atoms and between Fe and rare earth elements, and coupling where rare earth elements are coupled with fluorine atoms, oxygen atoms, and Fe atoms.

A phase including a lot of Fe carries magnetization by forming a phase including a lot of fluorine (fluorine of 10 to 50%), a phase including a lot of Fe (Fe of 50 to 85%), and a phase including a lot of rare earth element (rare earth element of 20 to 75%) in the fine particles, and the phase including a lot of fluorine or the phase including a lot of rare earth element contributes to high coercive force. Moreover, the magnetization of a part of the Fe atoms has an antiferromagnetic coupling. A structure is created, which has an advantage for the ferromagnetic coupling by irradiating millimeter waves or microwaves, resulting in a fluorine compound with a coercive force of 10 kOe being synthesized. Fine particles of other transition metal elements may be added instead of Fe system fine particles.

According to such a means, a permanent magnetic material can be obtained without a melting and grinding process for obtaining magnetic particles as in the prior art and making a high energy product is possible due to the surface fluorine compound solution treatment for the ferrite magnetic particle and the heat-treatment, so that it can be applied to various magnetic circuits.

### Fourteenth Embodiment

A rare earth fluorine compound having optical transparency is coated over the surface of a NdFeB system sintered magnet which includes Nd₂Fe₁₄B as a main phase. As an example of a particle, particles which include a Nd₂Fe₁₄B structure as a main phase are used and a fluorine compound is coated over the surface of the aforementioned particles. The average film thickness of the rare earth fluorine compound after coating is 1 to 10000 nm. The NdFeB system sintered magnet is a magnet where the crystal grain size is 1 to 20 μm on average and has Nd₂Fe₁₄B as a main phase, and deterioration of the magnetic properties in the demagnetization curve due to processing or polishing is observed at the surface of the sintered magnet.

With the objective of mitigating the deterioration of the magnetic properties, increasing the coercive force due to segregation of rare earth elements in the vicinity of grain boundaries, improving the square-loop characteristics of the demagnetization curve, increasing the resistance at the surface of the magnet and in the vicinity of grain boundaries, increasing the Curie point due to the fluorine compound, increasing mechanical strength, improving the corrosion resistance, decreasing the amount of the rare earth element used, and decreasing the magnetization field, after the rare earth fluorine compound solution is coated over the surface of the sintered magnet and dried, the heat treatment is performed at a temperature of 500° C. or more and at the sintering temperature or lower.

The clusters grown from the rare earth fluorine compound solution become a particle size of 100 nm or less and 1 nm or more right after coating and drying, and, by further heat-treatment, reaction and diffusion occur between the grain boundaries and the surface of the sintered magnet. Since the fluorine compound clusters after coating and drying have not passed the grinding process, they have not grown having a surface with protrusions and acute angles.

According to observation of the particles using a transmission electron microscope, they appear to be rounded oval or round shapes and no cracks are observed. These particles diffuse along grain boundaries of the sintered magnet or diffuse mutually with the element included in the sintered magnet by heating while they are segregated and grown at the surface of the sintered magnet.

Moreover, since the cluster-shaped rare earth fluorine compound is coated over the surface of the sintered magnet, the fluorine compound is formed on almost the entire surface of the sintered magnet, and a part of the area having a high rare earth element concentration is fluorinated at a part of the surface of the crystal grains of the sintered magnet after coating and drying and before heating at a temperature of 200° C. or more and at the sintering temperature or lower. This fluoride phase and the fluoride phase including oxygen grow partially maintaining conformity with the parent phase; the fluorine compound phase or oxyfluorine compound phase grows conformally outside of such a fluoride phase or oxyfluoride phase as seen from the parent phase; and the heavy rare earth elements are segregated in the vicinity of the fluoride phase, the fluorine compound phase, or the oxyfluorine compound phase, resulting in the coercive force being increased.

The width of the ribbon-shaped part where the heavy rare earth elements are concentrated along the grain boundaries is preferably in the range from 1 to 500 nm, and a high remanent flux density and a high coercive force can be sufficiently obtained if it is in this range.

When Dy is concentrated along the grain boundary by using such a means, the magnetic properties of the sintered magnet obtained is a remanent flux density of 1.0 to 1.6 T and a coercive force of 20 to 50 kOe, where the concentration of the heavy rare earth elements included in the rare earth sintered magnet which has the same magnetic properties can be made 10% to 80% lower than the case where conventional heavy rare earth added NdFeB system magnetic particles are utilized. The Fe concentration in the fluorine compound at the surface of the aforementioned sintered magnet depends on the heat-treatment temperature and Fe of 10 ppm or more and 5% or less diffuses in the fluorine compound when it is heated-up at a temperature of 1000° C. or more. The Fe concentration in the vicinity of grain boundaries of the fluorine compound becomes 50%. However, if the average concentration is 1% or more and 5% or less, there is no effect on the magnetic properties of the whole sintered magnet.

### Fifteenth Embodiment

Fine particles including Fe of 1 atomic % or more with a particle size from 1 to 100 nm are added to a gel-state or sol-state fluorine compound solution and a gel or sol-state Fe fluorine compound is manufactured in which Fe system fine particles are mixed. At this time, a part of the Fe atoms at the surface of the fine particles is chemically coupled with one or more elements either of fluorine in the fluorine compound, alkaline, alkaline earth, or rare earth elements included in the fluorine compound.

By irradiating millimeter waves or microwaves in an atmosphere including nitrogen to such a gel or sol-state fluorine compound or fluorine compound precursor which include fine particles or clusters, the number of atoms which contributes to the chemical coupling between fluorine atoms, nitrogen atoms, Fe atoms, and one or more aforementioned elements included in the fluorine compound becomes greater, thereby, a part of the magnetization between Fe atoms becomes ferromagnetic and magnetic anisotropy appears due to any one of coupling between Fe atoms and the rare earth elements using fluorine atoms and nitrogen atoms, coupling between fluorine atoms and oxygen atoms and between Fe and the rare earth elements, and coupling where the rare earth elements are coupled with fluorine atoms, oxygen atoms, nitrogen atoms, and Fe atoms.

The phase including a lot of Fe carries magnetization by forming a phase including a lot of fluorine (fluorine of 10 to 50%), a phase including a lot of nitrogen (nitrogen of 3 to 20%), a phase including a lot of Fe (Fe of 50 to 85%), and a phase including a lot of rare earth elements (rare earth element of 10 to 75%) in the fine particles, and the phase including a lot of fluorine and nitrogen or the phase including a lot of rare earth element contributes to a high coercive force. A magnet having the magnetic properties where the coercive force is 10 kOe or more can be obtained in such a Fe-M-F—N quaternary system (herein, M is a rare earth element, an alkaline, or an alkaline earth element). The same effects can be obtained by using a solution where fine particles including rare earth elements are partially mixed with the aforementioned rare earth fluorine compound solution.

### Sixteenth Embodiment

Fine particles including 1 atomic % or more of Fe with a grain size of 1 to 100 nm is added to a fluorine compound solution where visible light permeates to form Fe-fluorine compound clusters where Fe—B fine particles are mixed. When the fine particle size exceeds 100 nm, the nature of Fe, which is a soft magnetic element remains interior thereof through the process afterwards and, when it becomes smaller than 1 nm, improvement of the magnetic properties becomes difficult because the concentration of oxygen becomes higher relative to Fe. Therefore, the grain size from 1 to 100 nm is preferable. At this time, a part of the Fe atoms over the surf ace of the Fe—B fine particles is chemically coupled with one or more elements either of fluorine in the fluorine compound, alkaline, alkaline earth, or a rare earth element included in the fluorine compound.

By irradiating millimeter waves or microwaves to such a gel or sol-state Fe—B containing fluorine compound or fluorine compound precursor which includes fine particles or clusters, the number of atoms which contributes to the chemical coupling between fluorine atoms, boron atoms (B), Fe atoms, and one or more of the aforementioned elements included in the fluorine compound becomes greater, a part of the magnetization between Fe atoms becomes ferromagnetic and magnetic anisotropy appears due to any one of coupling between Fe atoms and the rare earth element using fluorine atoms, coupling between fluorine atoms and boron atoms and between Fe and the rare earth elements, or coupling where the rare earth elements are coupled with fluorine atoms, oxygen atoms, boron atoms, and Fe atoms.

The phase containing a lot of Fe carries magnetization by forming a phase including a lot of fluorine (fluorine of 10 to 50%), a phase containing a lot of boron (boron of 5 to 20%), a phase including a lot of Fe (Fe of 50 to 85%), and a phase including a lot of rare earth element (rare earth element of 10 to 75%) in the fine particles, and the phase including a lot of fluorine and boron or the phase containing a lot of rare earth element contributes to high coercive force. A magnet having the magnetic properties where the coercive force is 10 kOe or more can be obtained in such an Fe-M-B—F quaternary system (herein, M is a rare earth element, an alkaline, and an alkaline earth element), and the Curie point can be made from 400 to 600° C. when M is a heavy rare earth element.

### Seventeenth Embodiment

A fluorine compound cluster solution which can grow up to a rare earth fluorine compound at a temperature of 100° C. or more is coated over the surface of a NdFeB system sintered magnet which includes Nd₂Fe₁₄B as a main phase. The average film thickness of the fluorine compound cluster solution after coating is from 1 to 10000 nm. Such a cluster does not have a crystal structure of a bulk fluorine compound, and fluorine and the rare earth element are coupled having a periodic structure. The NdFeB system sintered magnet is a magnet where the crystal grain size is 1 to 20 μm on average and has Nd₂Fe₁₄B as a main phase, and deterioration of the magnetic properties in the demagnetization curve due to processing or polishing is observed at the surface of the sintered magnet.

With the objective of mitigating the deterioration of the magnetic properties, increasing the coercive force due to segregation of rare earth elements in the vicinity of grain boundaries, improving the square-loop characteristics of the demagnetization curve, increasing the resistance at the surface of the magnet and in the vicinity of grain boundaries, increasing the Curie point due to the fluorine compound, increasing mechanical strength, improving the corrosion resistance, decreasing the amount of the rare earth element used, and decreasing the magnetization field, after the gel or sol-state rare earth fluorine compound precursor is coated over the surface of the sintered magnet and dried, the heat treatment is performed at a temperature of 300° C. or more and at the sintering temperature or lower. The rare earth fluorine compound clusters grow to a particle state of 100 nm or less and 1 nm or more in the coating and drying process and, by further heat-treatment, reaction and diffusion occur between the precursor or a part of fluorine compound clusters and grain boundaries and the surface of the sintered magnet.

Since the fluorine compound particles after coating and drying have not passed the grinding process even if it is in the temperature range where particles are not congregated, they have not grown having a surface with protrusions and acute angles. According to observation of the particles using a transmission electron microscope, they look like rounded ovals or round shapes, no cracks are observed in the grains or at the surface of the particles, and no discontinuous roughness is observed in the appearance. These particles diffuse along grain boundaries of the sintered magnet or diffuse mutually with the elements included in the sintered magnet by heating while they are segregated and grown at the surface of the sintered magnet. Moreover, since the cluster-shaped rare earth fluorine compound is coated over the surface of the sintered magnet, the fluorine compound covers almost the entire surface of the sintered magnet, and a part of the area having a high rare earth element concentration is fluorinated at a part of the surface of the crystal grains of the sintered magnet after coating and drying. This fluoride phase or the fluoride phase including oxygen grow partially maintaining conformity with the parent phase; the fluorine compound phase or oxyfluorine compound phase grows conformally outside of such a fluoride phase or oxyfluoride phase as seen from the parent phase; and the heavy rare earth elements are segregated at the fluoride phase, the fluorine compound phase, or the oxyfluorine compound phase, resulting in the coercive force being increased.

The width of the ribbon-shaped part where the heavy rare earth elements are concentrated along the grain boundaries is preferably in the range from 0.1 to 100 nm, and a high remanent flux density and a high coercive force can be sufficiently obtained if it is in this range. When Dy is concentrated along the grain boundaries by using the precursor of DyF₂₋₃ and using such a means, the magnetic properties of the sintered magnet obtained is a remanent flux density of 1.0 to 1.6 T and a coercive force of 20 to 50 kOe, where the concentration of the heavy rare earth elements included in the rare earth sintered magnet which has the same magnetic properties can be made lower than the case where conventional heavy rare earth added NdFeB system magnetic particles are utilized. Fluorine compounds and oxyfluorine compounds which include Nd grow at triple points of the grain boundaries and the fluorine compound and oxyfluorine compound grow at a part of the triple points of the grain boundaries even at the center of the sintered magnet with a thickness of 1 mm to 10 mm.

By applying a magnetic field of 10 kOe or more while growing such a fluorine compound and oxyfluorine compound, the magnetization direction of the heavy rare earth element, the fluorine compound, or the oxyfluorine compound is changed and the magnetic coupling is increased, thereby, it is possible to increase the coercive force. The Fe concentration in the fluorine compound at the surface of the aforementioned sintered magnet depends on the heat-treatment temperature, and Fe of 1 ppm or more and 5% or less diffuses in the fluorine compound when it is heated-up at a temperature of 1000° C. or more. The Fe concentration in the vicinity of grain boundaries of the fluorine compound becomes 50%. However, if the average concentration is 5% or less, there is no effect on the magnetic properties of the whole sintered magnet.

### Eighteenth Embodiment

An SmCo alloy was melted by a high frequency melting technique and ground in an inert gas. The ground particle size is from 1 to 10 μm. A fluorine compound precursor (SmF₃ precursor) is coated over the surface of the ground particles and dried. The coated particles are oriented in a magnetic field and using a press machine formed into a green compact. Many cracks are introduced into the green compact and a part of the cracked part is covered with a fluorine compound precursor by coating a fluorine compound precursor from the outside of the green compact. It was sintered and quenched.

The sintered body included two phases, and SmCo₅ and Sm₂Co₁₇ phases were formed. The fluorine compound starts decomposing while sintering and distributes to both of the two phases. However, more fluorine atoms existed in SmCo₅ and the coercive force thereof increases compared with the case where a fluorine compound precursor is not added. Moreover, as to the effects of coating the fluorine compound precursor, any one of an increase in the resistance, improvement of the square-loop characteristics, improvement of the demagnetization resistance, and improvement of the mechanical strength can be observed.

The green compact as mentioned above is an Fe system structure and formed to a high density, and the loss of the structure can be alleviated by coating the solution which includes fluorine on this high density green compact and performing a heat-treatment. Therefore, in a product consisting of a sintered magnet and a green molded body, fluorine or other metallic elements included in the solution diffuse by being heated together at a temperature of 200° C. or more after solution processing, resulting in an improvement of the magnetic properties of the sintered magnet and a decrease in the loss of the green molded body being achieved.

### Nineteenth Embodiment

Using particles with a particle size of 1 to 20 μm which includes a composition in the vicinity of Nd₂Fe₁₄B as a main phase, the green molded body pressed in a magnetic field is heated-up in an inert gas or in a vacuum at a temperature range from 200° C. to 1000° C. and a fluorine compound cluster solution is impregnated or coated. According to this treatment, the fluorine compound precursor solution penetrates along the magnetic particle interfaces interior of the molded body and a part of the interfaces is covered with the fluorine compound precursor solution.

Next, this impregnated or coated molded body is sintered at a temperature higher than the aforementioned heating temperature and it is heat-treated in order to improve the coercive force at a temperature lower than the sintering temperature to form a sintered body which includes fluorine and an element included in the precursor, a rare earth element, an alkali, or an alkaline earth element. The feature of this process is that the rare earth rich phase is formed at a part or all of the surface of the magnetic particles before sintering; it is not perfectly sintered and a gap of 1 nm or more is maintained except for a contact part between the magnetic particles; the fluorine compound precursor penetrates into the gap to cover by impregnating or coating; and a part of surface of the magnetic particles located interior of the molded body except for the outermost surface of the molded body is coated with the fluorine compound precursor.

According to this process, the fluorine compound clusters can be coated over the surface of the magnetic particles even at the center of a 100 mm sintered bulk and, by selecting a heavy rare earth element such as Dy, Tb, and Ho, etc. as an element included in the fluorine compound clusters, the heavy rare earth elements are segregated in the vicinity of the crystal grain boundaries of the sintered bulk. As a result, any of an increase in the coercive force, improvement of square-loop characteristics, an increase in the remanent flux density, a decreases in the temperature coefficient of the coercive force and the temperature coefficient of the remanent flux density, and decrease in the deterioration of the magnetic properties by work hardening. The width of segregation of the aforementioned rare earth element is 1 to 100 nm from the crystal grain boundaries and there is a tendency where it changes depending on the heat-treatment temperature and it expands at a significant point such as a grain boundary triple point.

In order to enhance the segregation of the heavy rare earth elements at the grain boundaries and to prevent the structural disturbance of the phase which includes fluorine at the grain boundaries, a transition metal element such as Cu, Zr, Ni, Mo, Sn, Al, Zn, Ti, Nb, and Co, etc. is added to be a concentration of 3 atomic % or less.

### Twentieth Embodiment

A cluster solution of an Fe fluoride compound is mixed with a precursor of the fluorine compound which includes at least one of an alkali, alkaline earth, or rare earth element and given a drying heat-treatment to form an Fe-M-F compound (herein, M is at least one element of an alkali, alkaline earth, or rare earth element).

Because the precursor is mixed, the particles grown in the drying heat-treatment are as small as 1 to 30 nm and the fluorine compound is grown in these nano-particles. The fluorine compound material having a high coercive force has a composition of Fe of 10 atomic % or more and fluorine of 1% or more and can be manufactured by making an M rich phase at the grain boundaries. Specifically, the Fe concentration is 50 atomic % or more, M 5 to 30%, and fluorine 1 to 20%; a fluorine rich phase, an Fe rich phase, and an M rich phase are grown; and the fluorine rich phase or the M rich phase is grown at the grain boundaries, resulting in powder having a coercive force of 10 kOe or more being obtained while having ferromagnetism.

In order to give anisotropy, the Fe rich phase is grown along the direction of the magnetic field by growing the fluorine compound in a magnetic field. In the growth process, there is especially no problem if the skeletal structure of the above-mentioned phase doesn't break even if hydrogen, oxygen, carbon, nitrogen, and boron are mixed. Moreover, a Fe-M-F (herein, the M atom is one or more of a transition metal element, such as Cr and Mn, etc.) including an M atom of 5 atomic % or more and an F atom of 5 atomic % or more is grown from a solution including the cluster-like fluorine compound, resulting in a high coercive force being obtained. Since fluorine atoms in these compounds have an anisotropic arrangement, high anisotropy can be obtained. Since the magnets of ternary system were formed by using the aforementioned solution, a polishing process was not necessary. Therefore, magnets having a complicated shape can be easily formed and the direction of anisotropy can be changed continuously in one magnet, so that it can be utilized for various rotating machines, magnetic sensors, magnetic components for hard disk drives, and magnetic media.

Moreover, if the concentration of M atom is controlled to be 5 atomic % or less, the Fe-M-F ternary alloy becomes a soft magnetic material with a high saturation flux density and it can be applied to a core material for various magnetic circuits. Moreover, the magnetic properties, thermal properties, and high frequency characteristics, etc. of the ferrite can be improved by forming an oxyfluorine compound where the reaction between the ferrite particles and the fluorine system processing liquid is utilized. Furthermore, the magneto-optic effect of the various magnetic materials can be improved by using a fluorine system processing liquid, and it can be applied to products with magneto-optic applications, such as isolator circuits and optically guided wave paths, etc.

### Twenty-First Embodiment

When a NdFeB system sintered magnet which contained a Nd₂Fe₁₄B structure as a main phase was polished and bonded to stacked electrical steel, a stacked amorphous (material), or pressed iron to make a rotor, the stacked electrical steel or the pressed iron is previously processed by using a die at the position where the magnet is inserted. When a sintered magnet is inserted in the position for the magnet, a gap of 0.01 to 0.5 mm is created between the sintered magnet and the stacked electrical steel or the pressed iron.

Various sintered magnets which have a rectangular shape, a ring shape, and a curved shape such as semicylindrical shape are inserted in the magnet position which includes such a gap; a gel or sol-state or cluster state fluorine compound solution is injected into the gap and heated at a temperature of 100° C. or more; and the sintered magnet and the stacked electrical steel, the stacked amorphous (material), or pressed iron are bonded. At this time, the rare earth element or fluorine diffuses to the surface of the sintered magnet by performing the heat-treatment at a temperature of 200° C. or more, and the elements included in the fluorine compound diffuse to the surface of the stacked electrical steel or pressed iron, so that the magnetic properties of the sintered magnet are improved (increase in the coercive force, improvement of the square-loop characteristics, improvement of the demagnetization resistance, and increase in the Curie point, etc.) and the adhesion can be made stronger.

Improvement of the magnetic properties of the curved work hardened surface layer of the sintered magnet is possible and light elements, such as oxygen and carbon, may be observed in the diffusion layer which includes fluorine or a rare earth element as a main component at the surface and at the grain boundaries of each magnetic material. Fluorine and oxygen exist in the vicinity of the grain boundaries and the coercive force is increased by segregating the heavy rare earth element in the range from two to a thousand times greater than the grain boundary width of 0.1 to 10 nm on average.

The grain boundary width including fluorine becomes wider in the vicinity of the grain boundary triple point and fluorine and heavy rare earth elements diffuse from the grain boundary triple point though the grain boundaries. The Nd concentration of the parent phase is controlled to be a rare earth element concentration from 0 to 10 atomic % smaller than the composition of Nd2Fe14B, thereby, the heavy rare earth element is captured by the fluorine compound treatment. As a result, a high remanent flux density of 1.5 T or more can be obtained. When the grain boundary width where fluorine exists is 1 nm or more and the covering ratio of the layer shaped grain boundary phase including fluorine is 10% or more of all grain boundaries, the specific resistance of the sintered magnet becomes 0.2 mΩcm or more.

A part of the fluorine atoms, which exists at the grain boundaries was coupled with Nd and oxygen atoms and influences the spin interaction between the atoms at the grain boundaries and the spin interaction between the atomic spins in the parent phase at the grain boundary surface.

By increasing the magnetic anisotropic energy due to segregation of the heavy rare earth element, the spin in the atoms of the grain boundary phase such as fluorine, oxygen, and Nd atoms influences the spin and orbit of the parent phase lattice which contacts the grain boundary surface. In addition, a grain boundary phase such as fluorine, oxygen, and Nd, etc. decreases the roughness of the grain boundary face on the atomic level and the coercive force or the square-loop characteristics are increased by preventing the generation of reverse magnetization.

Although a rare earth element is included in the aforementioned fluorine compound in order to improve the magnetic properties of the sintered magnet, a fluorine compound which includes a rare earth element, an alkaline, or an alkaline earth element may be used for adhesion effect, strain release of the soft magnetism, or loss reduction in addition to an improvement of the magnetic properties of the magnet.

### Twenty-Second Embodiment

A gel or sol-state rare earth fluorine compound solution having optical transparency is coated over the surface of the NdFeB system sintered magnet. The film thickness of the rare earth fluorine compound after coating is 1 to 10000 nm. The NdFeB system sintered magnet is a sintered magnet, which contained Nd₂Fe₁₄B as a main phase and, at the surface of the sintered magnet, deterioration of the magnetic properties is observed due to polishing or oxidation. In order to mitigate the deterioration of magnetic properties, after the surface of the sintered magnet is treated by an acid and cleaned, the rare earth fluorine compound solution which has the permeability of visible light is coated over the surface of the sintered magnet and dried, and heat-treatment is performed at a temperature of 200° C. or more and at the sintering temperature or lower.

For a cleaning process before coating the solution, various solutions and techniques, such as sputtering, reactive etching and ultrasonic cleaning, etc., may be utilized in addition to an acid treatment, and it is preferable that a thick oxide layer be removed beforehand. If local heating is utilized by using high frequency waves such as millimeter waves, etc. the heat-treatment temperature can be made 100° C. or more lower than a typical heat-treatment and the heat-treatment time can be also shortened. Right after coating and drying, particles of 50 nm or less and 1 nm or more grow from the gel or sol-state rare earth fluorine compound solution, structural changes in the vicinity of the fluorine atoms are observed, and reaction and diffusion to the grain boundaries and the surface occurs on further heating.

Since a solution, and not particles or powder, is utilized it is possible to control the coating film thickness and film thickness distribution uniformly; the aforementioned solution can be utilized in a process or a material where cleanliness is required, and it is easy to coat only the part where coating is required by masking before and after coating the solution. Such a coating process is an advantage for a magnet, which is utilized for precision electronic equipment such as voice coil motors, etc. because it uses a solution. There may be a case where a variety of CH bases and OH bases are involved in the solution, and the state of the solution or right after coating has a main structure different from the crystal structure after heating. Namely, the main structure of the solution is a totally different structure from the crystal structure of the fluorine compound particles; it can be detected as a clear difference in the electron and X-ray diffraction patterns; and broad diffraction patterns are obtained. It means that a periodic structure is partially disordered compared with a perfect fluorine compound.

After the aforementioned solution was coated, the solvent was removed by heating and the fluorine compound was formed over almost the entire surface of the sintered magnet, and a part of the area which has a high rare earth element concentration is fluorinated at a part of the crystal grain surface of the sintered magnet after coating and drying before heating at a temperature of 500° C. or more.

In a Dy fluorine compound or Tb and Ho fluorine compounds or oxyfluorine compounds thereof in the aforementioned rare earth fluorine compounds, Dy, Tb, and Ho, etc. which are element constituting them diffuse along the crystal grain boundaries, resulting in deterioration of the deterioration of the magnetic properties being mitigated.

When the heat-treatment temperature becomes 800° C. or more, the mutual diffusion between the fluorine compound and the sintered magnet proceeds further, thereby, there is a case where Fe is observed in the fluorine compound layer with a concentration of 1 ppm or more. With increasing heat-treatment temperature, there is a tendency for the concentration of elements in the parent phase diffusing into the fluorine compound layer to increase.

When sintered magnets are stacked and bonded to each other, the same fluorine compound which is diffused to improve the magnetic properties or another fluoride compound or oxyfluorine compound, which becomes the adhesive layer, is coated after the aforementioned heat-treatment and stacked on each other, and only the vicinity of the adhesion layer is heated-up by irradiating millimeter waves, resulting in the sintered magnets being bonded to each other. The fluorine compound for the adhesion layer is a Nd fluorine compound, etc. (NdF₂₋₃, Nd(OF)₁₋₃) and it is possible to selectively heat-up only the vicinity of the adhesion layer while suppressing the temperature rise at the center of the sintered magnet by selecting the irradiation conditions of the millimeter waves, and it is possible to suppress deterioration of the magnetic properties and dimensional changes of the sintered magnet during adhesion.

Moreover, the heat-treatment time of the differential heating can be made half or less that of a conventional heat-treatment time by using millimeter waves, so that it is preferable for mass-production where improvement of the magnetic properties is possible during the adhesion process. Millimeter waves can be utilized not only for the adhesion of the sintered magnet but also for improvement of the magnetic properties by diffusion of the coating material, and the function of the adhesion layer can be achieved by using, in addition to a fluorine compound, a material, such as an oxide, a nitride compound, and a carbide, etc. where the dielectric loss is different from the NdFeB of the parent phase.

Although it can be diffused by heating, even if millimeter waves are not used, the fluorine compound is selectively heated by using millimeter waves and utilized for adhering and joining the magnetic material, various metallic materials, and oxide materials. As for the conditions of the millimeter waves, irradiation is performed under the conditions of 28 GHz and 1 to 10 kW in Ar atmosphere, in vacuum, or in another inert gas atmosphere for 1 to 30 minutes. Since the fluorine compound or oxyfluorine compound including oxygen is selectively heated-up by using millimeter waves, it is possible to diffuse only the fluorine compound along the grain boundaries without changing the structure of the sintered bulk; diffusion of the elements constituting the fluorine compound to interior of the crystal grains can be prevented; superior magnetic properties (any of a high remanent flux density, improvement of the square-loop characteristics, high coercive force, high Curie-point, low thermal demagnetization, high corrosion resistance, and high resistance, etc.) can be obtained than in the case where it is simply heated-up.

In addition, by selecting the conditions of the millimeter waves and fluorine compound, it is possible to diffuse the elements constituting the fluorine compound into an area deeper from the surface of the sintered magnet than when performing a conventional heat-treatment, so that it is possible to diffuse them into the center of a magnet having the dimensions of 10×10×10 cm. The magnetic properties of a sintered magnet which is obtained by using these technique are a remanent flux density of 1.0 to 1.6 T and coercive force of 20 to 50 kOe, and the concentration of heavy rare earth element contained in the rare earth sintered magnet which has the same magnetic properties can be made smaller than the case of using conventional heavy rare earth added NdFeB system magnetic particles.

Moreover, if 1 to 100 nm fluorine compound or oxyfluorine compound, which includes at least one of an alkaline, alkaline earth or rare earth element remains at the surface of the sintered magnet, the resistance of the surface of the sintered magnet becomes higher and eddy current loss can be decreased even if it is adhered, resulting in a loss reduction being achieved in a high frequency magnetic field.

Since heat generation in the magnet can be decreased due to such a loss reduction, the amount of the heavy rare earth element used can be reduced. Since the aforementioned rare earth fluorine compound is not powder and has a low viscosity, it is possible to coat even inside a fine hole of 1 nm to 100 nm, so that it can be applied to a fine magnet component for improving the magnetic properties. And, this magnet can be applied to a commutator type or brushless type permanent magnet motor, a disk type armature DC mortar, a flat mortar, a voice coil mortar, a stepper mortar, a magnet sensor, an actuator, a magnetic shaft bearing, magnetic resolution imaging equipment, an electric discharge tube, and a speaker, etc. Moreover, the processing liquid used for the fluorine compound treatment can be applied to a coating medium or a coating magnet having an arbitrary shape by mixing magnetic particles, and it can also be applied to a variety of magnetic fluids and magnetic shielding materials.

### Twenty-Third Embodiment

Particles with a particle size of 1 to 10000 nm, which includes RE (rare earth element), iron, and fluorine, such as RE₂Fe₁₄₋₁₈(B,F)₁₋₃, RE₂Fe₁₄₋₁₉F₁₋₃, and RE₂Fe₁₄₋₁₉(F,N)₁₋₃, RE₂Fe₁₄₋₁₉(F,C)_{0.1-2}, etc. and which is formed by irradiating millimeter waves (output of 1 kW and a temperature of 200 to 1000° C.) using a solution including fluorine, are magnetic materials having magnetic anisotropy and can be applied to a variety of magnetic circuits. These particles have a concentration gradient of fluorine; a difference in the anisotropic energy is observed in the particles; the phase having high anisotropic energy makes the magnetic domain stable; it is formed by reaction with the phase which includes fluorine and a rare earth element and has a partial random structure such as a sol and a gel, etc.; and a magnetic material where the content of the rare earth is decreased can be obtained. Such a magnetic material including fluorine is related to the interatomic distance between the rare earth and fluorine and the concentration gradient of the fluorine; a plurality of diffraction peaks can be observed between 1.0 and 4.0 angstroms in X-ray diffraction; a broad peak having a full width at half maximum of 1 degree or more in the X-ray diffraction pattern before reaction; this peak is changed by the heat-treatment; and it is formed in the process where the full width at half maximum becomes smaller.

Using a reaction of such a sol, gel, or colloidal solution, various magnetic materials such as a RE-Fe—F system, a RE-Fe—F—B system, a RE-Co—F system, a M-Fe—F system, a M-Co—F system, a RE-M-F system, a RE-V—F system, a RE-Cr—F system, and a material where these materials and an oxide ferrite material are reacted (M is a transition metal element) can be formed. As a base structure which does not include a metallic element, nano-tubes where the combination angle between fluorine-fluorine, fluorine-carbon, and fluorine-oxide, etc. is changed can be formed by irradiating millimeter waves to the aforementioned solution including fluorine, and it is possible to obtain the characteristics that are equal to or better than those of carbon nano-tubes. A magnetic material manufactured by using the aforementioned solution as a part of the raw material has a freedom to be shaped from a thin film to a bulk and does not need a manufacturing process, so that it is suitable for mass-production of various products for magnetic material applications.

The process for forming a magnetic material using such a solution can be applied, in addition to a fluorine compound, to a RE-M system including a halogen element; it can be grown over a substrate and it is possible to change the magnetic properties by a heat-treatment such as local-heating. Moreover, in the magnetic material formed by using such a solution, there is a material system which has magneto-optical characteristics, a magnetoresistance effect, a piezoelectric effect, thermo-electromotive force, an optical magnetoresistance effect, fluorescence properties, magnetostriction effect, magnetic field depending fluorescence properties, and an magnetic refrigeration effect, and it can be applied to an element utilizing each feature and can be used for magneto-optical recording, magnetic heads, magnetic media, energy conversion components, optical elements, optical fibers, coloring agents, and glass materials, etc.

### Twenty-Fourth Embodiment

A solution containing iron, fluorine and a RE compound (rare earth element compound) such as such as RE₂Fe₁₄₋₁₈(B,F)₁₋₃, RE₂Fe₁₄₋₁₉F₁₋₃, and RE₂Fe₁₄₋₁₉(F,N)₁₋₃, RE₂Fe₁₄₋₁₉(F,C)_{0.1-2}, etc was used. The solution was uniformly coated over a substrate using a spinner. The film thickness was 1 to 10000 nm. A stacked body having periodicity is formed by coating and drying a solution including a rare earth element and a solution including fluorine alternately; the particles with a particle size of 1 to 10000 nm formed by irradiating this stacked body with millimeter waves (output of 1 kW and a temperature of 200 to 1000° C.) and by creating a reaction at the interface are a magnetic material having magnetic anisotropy; and they can be used for various magnetic circuits.

These particles have a concentration gradient of fluorine; a difference in the anisotropic energy is observed in the particles; the phase having high anisotropic energy makes the magnetic domain stable; it is formed by reaction with the phase which includes fluorine and a rare earth element and has a partial random structure such as a sol and a gel, etc.; and the content of the rare earth can be decreased. Such a magnetic material including fluorine is related to the interatomic distance between the rare earth and fluorine and the concentration gradient of the fluorine; a plurality of diffraction peaks can be observed in the range of spacing between 1.0 to 10 angstroms in X-ray diffraction; a broad peak having a full width at half maximum of 1 degree or more in the X-ray diffraction pattern before reaction; this peak is changed by the heat-treatment; and it is formed in the process where the full width at half maximum becomes smaller.

Using the stacking and a reaction of the stacked film of such a sol, gel, or colloidal solution, various magnetic materials can be manufactured, and a RE-Fe—F system, a RE-Co—F system, a M-Fe—F system, a M-Co—F system, a M-Ni—F system, a RE-Fe—(B, F) system, a RE-Mn—F system, a RE-V—F system, and a RE-Cr—F system, and a material where these materials and oxide ferrite system materials are reacted (M is a transition metal element) can be formed, so that it is possible to form a material by stacking with a plated film of another material system and performing the heat-treatment.

A magnetic material formed by using such a solution as a part of a raw material and using the change of the crystal structure due to the heat treatment or a material where a stacked body formed by the solution is reacted by using local heating from millimeter waves, an electric field effects, and magnetic field effects has superior freedom to be shaped from a thin film to a bulk and does not need a manufacturing process. Accordingly, it is suitable for mass-production of various products for magnetic material applications and the SN of magnetic recording can be improved by forming a layer including fluorine between the magnetic layers of the magnetic medium. Moreover, in a magnetic material formed by using such a solution, there is a material system which has magneto-optical characteristics, a magnetoresistance effect, a piezoelectric effect, thermo-electromotive force, an optical magnetoresistance effect, magnetic field dependent fluorescence properties, and a magnetic refrigeration effect, and it can be applied to an element utilizing each feature and used for magneto-optical recording, magnetic heads, magnetic media, energy conversion components, and optical elements, etc.

The same effect may be achieved by performing the heat treatment after a variety of particles are dispersed in the solution by using particles smaller than the film thickness of the stacking layer instead of the aforementioned stacking process.

In these materials, there is one where the size of the magnetic moment of the adjacent atoms due to the distance and the angle between adjacent atoms of fluorine and fluorine and changes in a magnetic coupling are demonstrated and reflect the aforementioned various properties, and these properties strongly depend on the structure of the interface between the partial random structure which is close to the structure of the solution and a perfect crystal structure. In a material having a M-F (herein, M is a metal and F is fluorine) coupling, a M-F—O coupling, a M-F—C coupling, or a M-F—B coupling which is created by using the aforementioned fluorine compound formation solution, a superconducting effect due to large electron affinity of the fluorine atoms can be obtained by selecting the periodicity of coupling, bonding angle, the M element, and a high temperature superconductor can be achieved and applied to a magnet for generating high magnetic fields.

### Twenty-Fifth Embodiment

A gel or sol state rare earth fluorine compound solution having optical transparency is coated over the surface of a NdFeB system magnet. The film thickness of the rare earth fluorine compound after coating is 0.1 to 10000 nm. The NdFeB system magnet is a sintered magnet, which has the basic crystal structure of Nd₂Fe₁₄B as a main phase and, at the surface of the sintered magnet, deterioration of the magnetic properties is observed due to polishing or oxidation. In order to mitigate such deterioration of magnetic properties, after the rare earth fluorine compound solution, which has the permeability of visible light, is coated over the surface of the sintered magnet and dried, a heat-treatment is performed at a temperature of 500° C. or more and at the sintering temperature or less.

Right after coating and drying, particles of 1 nm or more grow from the gel or sol-state rare earth compound solution or colloidal solution; reaction and diffusion occur between some of them and the grain boundaries and the surface of the sintered magnet at a temperature of 200° C. or less. Since a solution and not particles or powder is utilized, it is possible to control the coating film thickness and film thickness distribution uniformly; the aforementioned solution can be utilized in a process or material where cleanliness is required; and it is easy to coat only the part where a coating is required by masking before and after coating the solution. Such a coating process is an advantage for a magnet, which is utilized for precision electronic equipment such as voice coil motors, etc. because it uses a solution.

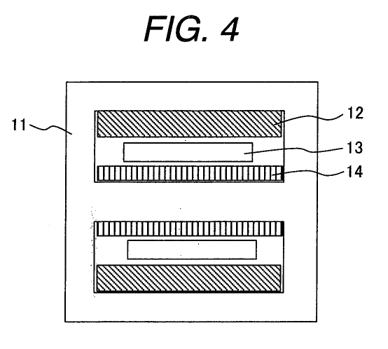

FIG. 4 shows a structure where it is applied to a voice coil motor. The flux of the sintered magnet 12 where the solution processing is applied and the magnetic properties are improved flows into the yoke 11. It consists of a moving-coil 13 and a copper tube 14. The two sintered magnets 12 let the flux flow into the center yoke 11 through the gap. High coercive force, high remanent flux density, and high square-loop characteristics are required in order to maintain the flux density. With regard to these properties, at the same time as segregation of fluorine and segregation of the metallic element in the vicinity of the crystal grain boundaries in the sintered magnet results from the fluorine solution coating and the heat-treatment, a drastic improvement of the magnetic properties is observed due to the reduction at the magnet surface compared with a sintered magnet where the solution is not used, so that improvement of the positioning accuracy or positioning speed can be achieved and a hard disk with high frequency, high speed, and high recording density can be achieved by using it to the sintered magnet 12 of the voice coil motor.

### Twenty-Sixth Embodiment

A solution containing iron, fluorine and a RE compound (rare earth element) such as RE₂Fe₁₄₋₁₈(B,F,O)₁₋₃, RE₂Fe₁₄₋₁₉(F,O)₁₋₃, and RE₂Fe₁₄₋₁₉(F,N,O)₁₋₃, RE₂Fe₁₄₋₁₉(F,C,O)_{0.1-2}, etc was used. The solution was uniformly coated over a substrate using a spinner. The film thickness is 1 to 10000 nm.

A stacked body having periodicity is formed by coating and drying a solution including a rare earth element and a solution including fluorine; the particles with a particle size of 1 to 10000 nm formed by irradiating this stacked body with microwaves or millimeter waves (output of 1 kW and a temperature of 200 to 1000° C.) and by creating a reaction at the interface are a magnetic material having ferromagnetism or a mixture of ferromagnetism and antiferromagnetism; and it can be used for various magnetic circuits. These particles have concentration gradients of fluorine, oxygen, or carbon; a difference of the anisotropic energy or magnetization is observed in the particles; the phase having high anisotropic energy makes the magnetic domain stable; it is formed by reaction with the phase which includes fluorine and a rare earth element and has a partial random structure such as a sol and a gel, etc.

Such a magnetic material including fluorine is related to the interatomic distance between the rare earth and fluorine and the concentration gradient of the fluorine; a plurality of diffraction peaks can be observed in the range of spacing between 1.0 to 10 angstroms in X-ray diffraction; a broad peak having a full width at half maximum of 1 degree or more in the X-ray diffraction pattern before reaction; this peak is changed by the heat-treatment; and it is formed in the process where the full width at half maximum becomes smaller.

Using the stacking and a reaction of the stacked film of such a sol, gel, or colloidal solution, various magnetic materials can be manufactured, and a RE-Fe—F—O system, a RE-Co—F—O system, a M-Fe—F—O system, a M-Co—F—O system, a M-Ni—F—O system, a RE-Fe—(B,F,O) system, a RE-Mn—F—O system, a RE-V—F—O system, and a RE-Cr—F—O system, and a material where these materials and oxide ferrite system materials are reacted (M is a transition metal element) can be formed, so that it is possible to form a material by stacking with a plated film of another material system and performing the heat-treatment. Moreover, it is possible to increase the coercive force and to decrease the ordering temperature by adding fluorine atoms using a surface treatment technique, etc. to the ordering alloy including Pt.

A magnetic material formed by using such a solution as part of a raw material and using the change of the crystal structure due to the heat treatment or a material where a stacked body formed by the solution is reacted by using local heating from millimeter waves, electric field effects, and magnetic field effects has superior freedom to be shaped from a thin film to a bulk and does not need a manufacturing process, so that it is suitable for mass-production of various products for magnetic material applications.

Moreover, in a magnetic material formed by using such a solution, there is a material system which has magneto-optical characteristics, a magnetoresistance effect, a piezoelectric effect, thermo-electromotive force, an optical magnetoresistance effect, magnetic field dependent fluorescence properties, and a magnetic refrigeration effect, and it can be applied to an element utilizing each feature and used for magneto-optical recording, magnetic heads, magnetic media, energy conversion components, and optical elements, etc. The same effect may be achieved by performing the heat treatment after a variety of particles are dispersed in the solution by using particles smaller than the film thickness of the stacked layer instead of the aforementioned stacking process.

In these materials, there is one where the size of the magnetic moment of the adjacent atoms due to the distance and the angle between adjacent atoms of fluorine and fluorine and changes in the magnetic coupling are shown and reflect the aforementioned various properties, and these properties strongly depend on the structure of the interface between the partial random structure which is close to the structure of the solution and a perfect crystal structure.

In a material having a RE-F (herein, RE is a rare earth element and F is fluorine) coupling, a RE-F—O coupling, a RE-F—C coupling, or a RE-B—F coupling which is formed by using the aforementioned fluorine compound formation solution, a superconducting effect due to large electron affinity of the fluorine atoms can be obtained by selecting the periodicity, bonding angle, the RE element, and a high temperature superconductor can be achieved and applied to a magnet for generating high magnetic fields. Moreover, since distribution of the electronic density of states in the vicinity of fluorine atoms is changed by using the large electron affinity of the fluorine atoms, the increase in the magnetic moment of adjacent elements, change of the exchange coupling, improvement of the magnetic properties and change of each characteristic (optical constant, electric resistance, thermal expansion, magneto-optical effect, magnetic refrigeration effect, semiconductor properties, and fluorescence properties, etc.) due to these can be observed.

Through the use that the optical properties of the aforementioned material such as the fluorescence property depends on the magnetic field, it is possible to judge the magnetization state by using the optical properties and to detect the kind and the position of the magnetic pole by using the optical properties or the electric properties, so that it can be applied to the detection of the magnetic pole position and the control circuit in the magnetic circuit such as a rotating machine.

### Twenty-Seventh Embodiment

A fluorine compound processing liquid, which contained Mn from 1 to 50% was coated over the surface of a powder containing at least one kind of rare earth elements. The crystal structure of the film containing Mn and fluorine after coating does not have a periodic structure such as a bulk manganese fluorine compound; the interatomic distance has a certain range; and the full width at half maximum of the X-ray diffraction peak is 0.5 degree or more and 10 degrees or less. The mean diameter of the particles is 10 nm to 100 μm. The layer including Mn generates heat by irradiating millimeter waves to the powder where a surface treatment is applied and is partially reacted with the powder.

Powder, Mn fluorine compound, and a reactive layer are formed, and a compound including Mn is formed. The compound including Mn has antiferromagnetism or ferromagnetism, and it is possible to change the magnetic properties of the powder by magnetically coupling with the powder. In M-Mn—F (M is a metallic element except for Mn), a material, which has ferromagnetism, a remanent flux density of 1.0 T or more, a Curie point of 100° C. or more can be obtained by changing the contents of Mn and F and the crystal structure. Ferromagnetism or antiferromagnetism appear by changing the density of states of Mn due to F atoms, and specifically when it is M_{0.01-80}Mn₁₋₁₀F₁₋₂₀ (atomic ratio), a property suitable for a soft magnetic material can be obtained.

It is possible to make ferromagnetism and antiferromagnetism coexist in the same alloy system and an increase in the coercive force is made possible by suppressing creation of reverse magnetic domains in the vicinity of the grain boundaries. The concentrations of Mn and F can easily be made higher in the vicinity of the periphery of the particle rather than interior of the particle by adopting a surface treatment; a layer having antiferromagnetic properties is formed at the periphery thereof; and the coercive force can be increased by magnetically coupling with the internal magnetization.

The fluorine compound has reduction effects where oxygen at the partially oxidized surface is removed, and reduction may be possible by forming a film including fluorine at the surfaces of various surface oxidized particles, bulk, and films and performing the heat-treatment. Since local heating of only the film including fluorine is possible by using millimeter waves at this time, it can be reduced while minimizing the thermal effect interior of the particles, bulk, and film, so that it can be applied to various reduction process and various characteristics of the material can be drastically improved.

### Twenty-Eighth Embodiment

NdFeB system alloy particles with a mean particle size of 0.5 to 20 μm are green molded in a magnetic field in order to add anisotropy. The magnetic field is 5 kOe or more and the pressure is 0.5 to 3 Ton/cm². The press direction may be either parallel or perpendicular to the magnetic field direction. The green molded body is taken out from the mold and the solution including fluorine and a rare earth element, where the diffraction pattern has an X-ray peak width of 1 degree or more and 20 degrees or less, is allowed to impregnate from the periphery side of the green molded body.

According to this impregnation treatment, a part of the surface of the magnetic particles in the green molded body is coated with the aforementioned solution. The solvent of the solution covering them is evaporated, resulting in nuclei of the fluorine compound or oxyfluorine compound being formed. These nuclei partially react with the NdFeB system alloy while they are grown by being heated. Such a reaction already progresses at 200 to 300° C. with migration of the rare earth elements.

There is a case where the reaction progresses in the vicinity of the grain boundaries when the solution contacts the NdFeB system particles. Such a reaction with the migration of the rare earth atoms proceeds with a decrease in the oxide layer at the surface of the NdFeB particles. The thickness of the fluorine compound layer or the oxyfluorine compound layer grown from the solution is 0.1 nm to 100 nm, and the most preferable layer thickness is 1 to 20 nm in thickness. According to this impregnation treatment, the fluorine compound layer can be formed at the center of the green molded body without recourse to the size of the green molded body.

After removing elements such as solvent, etc. in the green molded body, it is heated and sintered in a vacuum furnace in a temperature range from 900 to 1200° C. In order to increase the degree of sintering, the pressure is increased after removing the solvent of the green molded body, thereby, a part of the particles is moved and the face, which is not coated with the fluorine compound appears, resulting in progression of the sintering. When the layer thickness of the fluorine compound becomes greater than 20 nm on average, the degree of sintering becomes lower and it contributes to a decrease in the mechanical strength of the sintered magnet.

When a heavy rare earth element is used, segregation of the heavy rare earth elements is observed and the coercive force is increased by reacting the NdFeB system particles with the fluorine compound or oxyfluorine compound and by allowing the diffusion of the rare earth element to proceed while sintering. Any one of segregation of the heavy rare earth element to the neighborhood of grain boundaries, segregation of the fluorine to the grain boundaries, segregation of oxygen to the fluorine compound, segregation of the transition metal element to the position of the segregation of fluorine, segregation of carbon to the position of the segregation of fluorine, and segregation of the heavy rare earth element, oxygen, and carbon which originally exists in the particles to the neighborhood of the grain boundaries can be observed.

Accordingly, in addition to an increase in the coercive force, an effect can be obtained selected from any one of a decrease in the temperature coefficient of the coercive force and remanent flux density, improvement of the square-loop characteristics of the demagnetization curve, decrease in the magnet loss, increase in the remanent flux density, increase in the energy product, decrease in the thermal demagnetization rate, decrease in the magnetization field, improvement of the orientation ratio to the easy axis, decrease in the irreversible thermal demagnetization rate, increase in the Curie point, recovery of the magnetic properties of the processing deterioration layer, improvement of the corrosion resistance, and improvement of the mechanical strength. A sintered magnet with a size of 10×10×10 cm manufactured in this embodiment is hard to deteriorate by cutting and processing, and if it is deteriorated, the magnetic properties are easily recovered by a heat-treatment at 200 to 1000° C.

In order to secure the reliability, a protection film such as metallic plating or resin coating may be formed over the surface of the sintered magnet. The aforementioned impregnation treatment can be applied to an alloy system powder such as an Fe system, an Fe—Si system, a SmCo system, an Fe—Si—B system, an FeCoNi system, an FeMn system, a CrMn system, etc. and improvement of the magnetic properties and a decrease in the loss can be achieved.

### Twenty-Ninth Embodiment

NdFeB alloy particles with a mean particle size of 0.5 to 20 μm and an oxygen content of 2000 ppm or less are green molded in a magnetic field in order to add anisotropy. The magnetic field is 3 to 15 kOe and the pressure is 0.5 to 3 Ton/cm². The applied press direction may be either parallel or perpendicular to the magnetic field direction. The green molded body is taken out of the mold and the solution including fluorine and a rare earth element, which has optical transparency, is allowed to be impregnated from the periphery side of the green molded body. According to this impregnation treatment, a part of the surface of the magnetic particles in the green molded body is coated with the aforementioned solution.

The solvent of the solution covering them was evaporated, resulting in nuclei of the fluorine compound or oxyfluorine compound being formed. These nuclei partially react with the NdFeB system alloy and a fluorine compound or oxyfluorine compound was grown while they were grown by heating. Such a reaction already progresses at 200 to 300° C. with migration (diffusion) of the rare earth elements.

There is a case where the reaction progresses in the vicinity of the grain boundaries when the solution contacts the NdFeB particles. Such a reaction with the migration of the rare earth atoms proceeds with a decrease in the oxide layer at the surface of the NdFeB particles. The thickness of the fluorine compound layer or the oxyfluorine compound layer grown from the solution is 0.1 nm to 100 nm, and the most preferable layer thickness is 1 to 20 nm in thickness.

According to this impregnation treatment, the fluorine compound layer can be easily formed at the center of the green molded body without recourse to the size of the green molded body. After removing elements such as solvent, etc. in the green molded body, it is heated and sintered in a vacuum furnace at a temperature range from 900 to 1200° C. In order to increase the degree of sintering, the pressure is increased after removing the solvent of the green molded body, thereby, a part of the powder is moved and the face, which is not coated with the fluorine compound appears, resulting in progression of the sintering. When the layer thickness of the fluorine compound becomes greater than 20 nm on average, the degree of sintering becomes lower and it contributes to a decrease in the mechanical strength of the sintered magnet.

By reacting the NdFeB system particles with the fluorine compound or oxyfluorine compound and by allowing the diffusion of the rare earth element to progress, specifically, heavy rare earth elements such as Dy, Ho, and Tb, etc., thereby, the coercive force is increased by segregating the heavy rare earth element in the vicinity of the grain boundaries and changing the crystal structure. Segregation of the heavy rare earth element is generated by the fluorine compound and oxyfluorine compound layer formed from the solution including fluorine or heavy rare earth element which are coated over the surface of the NdFeB particles by impregnation, and diffusion of the rare earth element between these layers including fluorine and the NdFeB particles partially occurs, resulting in the heavy rare earth element or fluorine diffusing in the particles.

Some of the heavy rare earth elements and fluorine atoms diffuse interior of the NdFeB grains and form particles like intracrystalline precipitates. Grain boundaries where fluorine is segregated have a width of 0.1 to 10 nm and the roughness of the grain boundaries is smaller than the grain boundaries where fluorine is not included, and there is a tendency that the oxygen content at the grain boundaries is higher than the oxygen content within the grains.

Moreover, fluorine is segregated at the center of the grain boundaries in grain boundaries having a width of 1 nm to 5 nm, and the phase having a structure similar to the rare earth fluorine compound or rare earth oxyfluorine compound is partially grown. The boundary between the grain boundary and the interior of the grain has less roughness and, according to observations made using a transmission electron microscope, a certain orientation relationship can be observed in which the intra-granular lattice and the lattice of grain boundaries are partially matched, so that it is considered that such a grain boundary structure contributes to an increase in the coercive force.

Specifically, any one of segregation of the heavy rare earth element to the neighborhood of grain boundaries, segregation of fluorine to the grain boundaries, segregation of oxygen to the fluorine compound, segregation of the transition metal element to the position of the segregation of fluorine, segregation of carbon to the position of the segregation of fluorine, segregation of the heavy rare earth element, oxygen, and carbon which originally exist in the particles to the neighborhood of the grain boundaries, segregation of fluorine and the transition metal element to the grain boundaries, segregation of the light rare earth element to the center of the grain boundaries, decrease in the roughness of the grain boundaries, distribution of the heavy rare earth concentration formed by the reaction between the grain boundary phase including fluorine and intra-granular phase, lattice matching or an orientation relationship between the grain boundary phase including fluorine and intra-grain phase, formation of a layer including intra-granular fluorine, formation of the phase including fluorine at the triple point of the grain boundaries, and lattice matching or an orientation relationship between the phase including fluorine at the triple point of grain boundaries and an intra-granular phase can be observed.

Accordingly, in addition to an increase in the coercive force, an effect can be obtained from any one of a decrease in the temperature coefficient of the coercive force and remanent flux density, improvement of the square-loop characteristics of the demagnetization curve, decrease in the magnet loss, increase in the remanent flux density, increase in the energy product, decrease in the thermal demagnetization rate, decrease in the magnetization field, improvement of the orientation ratio to the easy axis, decrease in the irreversible thermal demagnetization rate, increase in the Curie point, recovery of the magnetic properties of the processing deterioration layer, improvement of the corrosion resistance, improvement of the mechanical strength, decrease in the recoil permeability, improvement of the crystalline orientation, increase in the exchange coupling, and control of the creation of reverse magnetic domains.

### Thirtieth Embodiment

NdFeB alloy particles with a mean particle size of 0.5 to 20 μm and an oxygen content of 2000 ppm or less are green molded in a magnetic field in order to add anisotropy in the sintering process. The magnetic field is 3 to 15 kOe and the pressure is 0.5 to 3 Ton/cm². The applied press direction may be either parallel or perpendicular to the magnetic field direction. The green molded body is taken out of the mold and the solution including fluorine and a rare earth element, which has optical transparency, is allowed to be impregnated from the periphery side of the green molded body. According to this impregnation treatment, a part of the surface of the magnetic particles in the green molded body is coated with the aforementioned solution.

By irradiating millimeter waves to this green molded body, the coated film generates heat. This is due to the difference of the dielectric loss between the layer including fluorine and the NdFeB system material, and only the layer including fluorine can be heated while suppressing the heating-up of the NdFeB itself. Therefore, structural changes can be created only in the layer including fluorine while suppressing the deterioration of NdFeB. The solvent of the solution covering them is evaporated by irradiation, resulting in nuclei of the fluorine compound or oxyfluorine compound being formed. When irradiation continues further, the growth of nuclei is observed while it partially reacts with the NdFeB system alloy to form the fluorine compound and the oxyfluorine compound. Such a reaction already progresses at 50 to 300° C. with migration (diffusion) of the rare earth elements.

There is a case where the reaction progresses in the vicinity of the grain boundaries when the solution including an ionic element contacts the NdFeB particles. Such a reaction with the migration of the rare earth proceeds with a decrease in the oxide layer at the surface of the NdFeB particles even under electromagnetic wave irradiation. The thickness of the fluorine compound layer or the oxyfluorine compound layer grown from the solution is 0.1 nm to 100 nm, and the most preferable layer thickness is 1 to 20 nm in order to obtain a high remanent flux density of 1.0 to 1.6 T. According to this impregnation treatment, the fluorine compound layer can be easily formed at the center of the green molded body without recourse to the size of the green molded body.

After removing the element such as solvent, etc. in the green molded body, it is heated and sintered in a vacuum furnace or by performing electromagnetic wave irradiation at the temperature range from 900 to 1200° C. In order to increase the degree of sintering, the pressure is increased after removing the solvent of the green molded body, thereby, a part of the powder is moved and the face, which is not coated with the fluorine compound appears, resulting in progression of the sintering. When the layer thickness of the fluorine compound becomes greater than 50 nm on average, the degree of sintering becomes lower and it contributes to a decrease in the mechanical strength of the sintered magnet.

By reacting the NdFeB system particles with the fluorine compound or oxyfluorine compound and by allowing the diffusion of the rare earth element to progress, specifically, heavy rare earth elements such as Dy, Ho, and Tb, etc., thereby, the coercive force is increased by segregating the heavy rare earth element in the vicinity of the grain boundaries and changing the crystal structure. Segregation of the heavy rare earth element is generated by the fluorine compound or oxyfluorine compound layer formed from the solution including fluorine and the heavy rare earth element which are coated over the surface of the NdFeB particles by impregnation, and diffusion of the rare earth element between these layers including fluorine and the NdFeB particles partially occurs, resulting in the heavy rare earth element or fluorine diffusing in the particles.

Some of the heavy rare earth elements and fluorine atoms diffuse interior of the NdFeB grains and form particles like intracrystalline precipitates. Grain boundaries where fluorine is segregated with a concentration of 10 ppm or more have a width of 0.1 to 10 nm and the roughness of grain boundaries is smaller than the grain boundaries where the concentration of fluorine atoms is less than 10 ppm, and there is a tendency that the oxygen content at the grain boundaries is higher than the oxygen content within the grains. Moreover, in the grain boundaries having a width of 1 nm to 5 nm, fluorine atoms are segregated at the center of the grain boundaries with a concentration which is twice greater than that interior the grain, and the phase having a structure similar to the rare earth fluorine compound or oxyfluorine compound including carbon is partially grown.

The boundary between the grain boundary and the interior of the grain has less roughness at the part where segregation of fluorine atoms is observed and, according to observations made using a transmission electron microscope, a certain orientation relationship can be observed in which the intra-granular lattice and the lattice of the grain boundary are partially matched, so that it is considered that such a grain boundary structure contributes to an increase in the coercive force. Specifically, any one of a segregation of the heavy rare earth element to the neighborhood of grain boundaries, segregation of fluorine to the grain boundaries, segregation of oxygen to the fluorine compound, segregation of the transition metal element to the position of the segregation of fluorine, segregation of carbon to the position of the segregation of fluorine, segregation of the heavy rare earth element, oxygen, and carbon which originally exists in the particles to the neighborhood of the grain boundaries, segregation of fluorine and the transition metal element to the grain boundaries, segregation of the light rare earth element to the center of the grain boundaries, decrease in the roughness of the grain boundaries, distribution of the heavy rare earth concentration formed by the reaction between the grain boundary phase including fluorine and the intra-granular phase, lattice matching or an orientation relationship between the grain boundary phase including fluorine and the intra-granular phase, formation of the layer including intra-granular fluorine, formation of the phase including fluorine at the triple point of the grain boundaries, lattice matching or an orientation relationship between the phase including fluorine at the triple point of grain boundaries and the intra-granular phase, and increase in the anisotropic energy of NdFeB due to substitution of fluorine atoms can be observed.

Accordingly, in addition to an increase in the coercive force an effect can be obtained from any one of a decrease in the temperature coefficient of the coercive force and remanent flux density, improvement of the square-loop characteristics of the demagnetization curve, decrease in the magnet loss, increase in the remanent flux density, increase in the energy product, decrease in the thermal demagnetization rate, decrease in the magnetization field, improvement of the orientation ratio to the easy axis, decrease in the irreversible thermal demagnetization rate, increase in the Curie point, recovery of the magnetic properties of the processing deterioration layer, improvement of the corrosion resistance, and improvement of the mechanical strength.

By using such a structural change related to fluorine atoms and the rare earth element, the surface treatment of a bulk sintered NdFeB system alloy and the high magnetic properties of the rare earth sintered magnet such as a bulk sintered SmCo system alloy can be achieved. In addition, improvement of magnetic properties due to diffusion between rare earth elements in the ferrite magnet and an increase in the resistance of the Fe system soft magnetic material can be achieved. Irradiation of electromagnetic waves such as millimeter waves having a frequency of 10 to 200 GHz can heat up only the surface of the NdFeB sintered body where a fluorine compound solution treatment is not performed, and by heating it is possible to recover the magnetic properties due to diffusion of the rare earth atoms in the vicinity of the grain boundaries and to adhere the bulk NdFeB by using a material, such as a fluorine compound, which has a different dielectric loss, as an adhesion layer doubling as the repairing effect of the magnetic properties of the deteriorated layer by processing.

### Thirty-First Embodiment

A compound including fluorine is grown at the crystal grain boundaries of CO₂MSi (a transition metal element except for Co, such as M=Fe, Mn, and Cr, etc.) by coating and heat-treating a fluorine compound solution and a high resistance layer is formed at the grain boundaries. The thickness of the high resistance layer is from 0.1 to 10 nm and a reaction layer including a part of the elements of Co, M, or Si may be formed in the vicinity of the grain boundaries. By forming a high resistance layer which includes fluorine at such grain boundaries through solution processing and heat-treatment, a magnetoresistive effect appears and a resistance change depending on the magnetic field could be detected by flowing current from an electrode.

In order to form such a fluorine compound at the grain boundaries and to make a magnetoresistive effect appear, it is important not to deteriorate the magnetic properties of an Fe system, a Ni or NiFe system, a PtMn system, and an FePt system material in addition to a Co system material which becomes the parent phase. Therefore, the fluorine compound and the reaction product layer thereof are the most preferable; the high resistance layer can be easily formed at the grain boundaries by utilizing grain boundary diffusion; and the magnetoresistive effect can be confirmed. The formed layer, which includes fluorine is MxFy (M is an alkaline, alkaline earth, rare earth, and transition metal element, F is fluorine, and x and y are integers) or NxFyOZ (M is an alkaline, alkaline earth, rare earth, and transition metal element, F is fluorine, O is oxygen, and x, y, and z are integers).

These compounds, which include fluorine can be formed by processing and heat-treating using a solution such as a sol, gel, and colloidal solution, etc. If it is necessary, powder, which includes fluorine may be mixed. However, mixing powder having almost the same crystal structure as the bulk makes it difficult to control the distribution of the film thickness to be 10 to 50% in the range of the film thickness from 0.1 to 100 nm even over a smooth surface. On the other hand, in the case of solution processing, it is possible to easily control the film thickness distribution by using a spinner because it does not have the same crystal structure as the bulk and has a low viscosity, so that it is possible to use a variety of patterning processes and lithography processes.

In addition to grain boundaries, a high resistance layer can be formed at the boundaries of the stacked materials, just like the grain boundaries, by using a fluorine compound solution process, and a ferromagnetic tunneling junction can be formed. Since the electrical properties of the fluorine compound are changed by photo-irradiation, an element having magneto-optical properties can be manufactured in addition to a magnetic field. Specifically, an element having a different tunneling current can be manufactured by photo-irradiation with a specific wavelength except for the magnetic field and it can be applied to magnetic recording equipment, a head of magneto-optical recording equipment, or a medium.

Using the high dielectric loss of the fluorine compound, a Co system, an Fe system, a Ni system, a NiFe system, a PtMn system, or an FePt system material and the neighborhood of the interface where a layer including the fluorine compound or the oxyfluorine compound is formed at the interface can be selectively heated by heat due to electromagnetic radiation. Therefore, enhancement of the growth of an ordering phase, magnetic domain control and bias field control by thermal magnetization, local change of the magnetic properties due to selective phase transformation, and local magnetic anisotropy control due to selective diffusion layer formation can be achieved. Such a local change can be confirmed in an area of 0.5×0.5 nm and the required layer thickness of the fluorine-containing layer is 0.1 nm or more.

The local heating process using the dielectric loss of such a fluorine-containing layer can be applied to a magnetic recording medium, a magnetic head, a magneto-optical recording, an optical device, and an X-ray detector, in addition to a heating process including a diffusion process for semiconductors, processes for liquid crystals and plasma displays, junction processes including battery materials, light wavelength sensing elements, and nano-particles, patterning processes, and polishing processes.

### Thirty-Third Embodiment

A processing liquid for forming the rare earth fluoride or alkaline earth metal fluoride coating film is formed by dissolving rare earth acetate or alkaline earth metal acetate into water and adding diluted hydrofluoric acid gradually. After the gel-state precipitation of fluorine compound or oxyfluorine compound or the solution where oxyfluorine carbide is formed is stirred by using an ultrasonic stirrer and centrifuged, methanol is added and a gel-state methanol solution is stirred to remove anions and made transparent.

The anions are removed until the permeability is 10% or more in visible light. This solution is coated over the particles and the solvent is removed. As an NdFeB system powder, a quenched powder including Nd₂Fe₁₄B as a main structure is formed and a Dy fluorine compound is formed at the surface thereof by using the aforementioned solution. After a solution with optical transparency is mixed with the aforementioned NdFeB powder, the solvent of the mixture is evaporated.

A transition metal element and a light element may be included in the NdFeB particles. In a heat-treatment at 200 to 700° C. and by quenching after the heat-treatment, the crystal structure of the fluorine compound becomes an NdF₃ structure, NdF₂ structure, or oxyfluorine compound etc. The crystal grain size of the parent phase is 10 to 1000 nm and many major axes of the plate-like crystals are larger than those of the crystal grains of the parent phase, and the length of the minor axes thereof is the same or smaller than those of the crystal grains of the parent phase.

Moreover, the plate-like crystals are grown contacting a plurality of crystal grains of the parent phase; the major axis has anisotropy; and the plate-like crystals include a rare earth element and fluorine. The anisotropy of the plate-like crystals can be added by growing in the magnetic field direction while cooling in a magnetic field, forming the plate-like crystals by applying stress in the specific direction while heating, or by irradiating millimeter waves in the specific direction. In the heat-treatment process after the surface treatment, the fluorine compound outside of the magnetic particles react with the magnetic particles, the peripheral fluorine atoms migrate with the rare earth atoms, resulting in the formation of plate-like crystals with anisotropy. Concentration distributions of the rare earth element, oxygen, and fluorine in the plate-like crystals or along the diffusion path thereof contribute to an increase in the coercive force and anisotropy is added, resulting in an anisotropic magnet being manufactured.

Fluorine compounds where anisotropy is added and which give any effect of an improvement of the coercive force, improvement of the square-loop characteristics, increase in the resistively after formation, decrease in the temperature dependence of the coercive force, decrease in the temperature dependence of the remanent flux density, improvement of the corrosion resistance, increase in the mechanical properties, improvement of thermal conductivity, and improvement of adhesion performance are LiF, MgF₂, CaF₂, ScF₃, VF₂, VF₃, CrF₂, CrF₃, MnF₂, MnF₃, FeF₂, FeF₃, CoF₂, CoF₃, CuF₂, CuF₃, NiF₂, ZnF₂, AlF₃, GaF₃, SrF₂, YF₃, ZrF₃, NbF₅, AgF, InF₃, SnF₂, SnF₄, BaF₂, LaF₂, LaF₃, CeF₂, CeF₃, PrF₂, PrF₃, NdF₂, SmF₂, SmF₃, EuF₂, EuF₃, GdF₃, TbF₃, TbF₄, DyF₂, NdF₃, HoF₂, HoF₃, ErF₂, ErF₃, TmF₂, TmF₃, YbF₃, YbF₂, LuF₂, LuF₃, PbF₂, BiF₃, or an oxyfluorine compound where oxygen and carbon are included in a fluorine compound thereof or a fluorine carbide compound, in addition to DyF₃ or DyF₂. They can be formed by surface treatment where a solution having the permeability of visible light or a solution where a CH base is combined with a part of the fluorine. Using such magnetic particles having anisotropy, a bonded magnet or a compression molded inorganic binder magnet where the remanent flux density is 1.0 to 1.5 T and the coercive force is 10 to 35 kOe can be manufactured and it can be utilized at environmental temperatures from 20 to 200° C.

### Thirty-Third Embodiment

A layer including fluorine is formed over a part of the surface of the particles using a solution where one or more transition metal elements are included in an FeSiB, FeCuSiB, or FeCuNbSiB system quenched powder and fluorine is included. The solvent in the layer including fluorine is removed by heat-treatment. Before removing the solvent, the solution has a full width at half maximum in X-ray diffraction of 0.5 degrees or more and 20 degrees or less and the diffraction peak width or the full width at half maximum becomes smaller with the heat-treatment. At a heat-treatment temperature of 300° C. or more, a part of the fluorine atoms over the surface of the particles diffuses into the interior of the particles.

According to the diffusion of fluorine, it is possible to control the crystal growth by heat-treatment compared with the case where diffusion of fluorine does not occur and to make the mean crystal grains to be 1 to 100 nm. Therefore, any one of the effects such as an increase in the permeability, decrease in the coercive force, increase in the resistance, improvement of anisotropy where anisotropy is added to the shape of the crystal grains by giving anisotropy to the segregation of fluorine during heat-treatment in a magnetic field, and increase in the saturation magnetic flux density due to the reduction effect by fluorine can be obtained. These soft magnetic materials have an initial permeability of 10000 to 300000; the loss in 10 kHz (0.1 T) is 0.1 to 5 W/kg; and it can be applied to a transformer, a rotating machine, and a reactor, etc.

### Thirty-Fourth Embodiment

A gel or sol state rare earth fluorine compound solution having optical transparency is coated over the surface of a bulk NdFeB system sintered magnet. The film thickness of the rare earth fluorine compound after coating is 10 to 10000 nm. The NdFeB system sintered magnet is a magnet which includes the Nd₂Fe₁₄B structure as a main phase and deterioration of the magnetic properties is observed at a part of the surface of the sintered magnet by polishing or oxidation.

In order to mitigate such a deterioration of magnetic properties, after the rare earth fluorine compound solution, which has the permeability of visible light is coated over the surface of the sintered magnet and dried, heat-treatment is performed at a temperature of 200° C. or more and at the sintering temperature or lower. If local heating is utilized by using millimeter waves, the neighborhood of the fluorine compound is selectively heated-up, and the heat-treatment temperature can be made 100° C. or more lower than a typical heat-treatment temperature and the heat-treatment time can be shortened. Right after coating and drying, particles of 100 nm or less and 1 nm or more grow from the gel or sol-state rare earth compound solution, structure changes in the vicinity of fluorine atoms are observed, and reaction and diffusion to the grain boundaries and the surface of the sintered magnet occurs with the structure changing by further heating.

Since a solution is utilized, and not particles or powder, it is possible to control the coating film thickness and film thickness distribution uniformly, the aforementioned solution can be utilized in a process or material where cleanliness is required, and it is easy to coat only the part where coating is required by masking before and after coating the solution. Such a coating process is an advantage for a magnet, which is utilized for precision electronic equipments such as voice coil motors, etc. because it uses a solution. There may be a case where a variety of CH bases and OH bases are involved in the solution, and the state of the solution or right after coating has a main structure different from the crystal structure after heating. Namely, the main structure of the solution is a totally different structure from the crystal structure of the fluorine compound particles; it can be detected as a clear difference in the electron and X-ray diffraction patterns; and broad diffraction patterns are obtained. It means that a periodic structure is partially disordered compared with a perfect fluorine compound.

After the aforementioned solution is coated, the solvent is removed by heating and the fluorine compound is formed over almost the entire surface of the sintered magnet, and a part of the area which has a high rare earth element concentration is fluorinated at a part of the crystal grain surface of the sintered magnet after coating and drying and before heating at a temperature of 300° C. or more. In a Dy fluorine compound or Tb and Ho fluorine compounds or oxyfluorine compounds thereof in the aforementioned rare earth fluorine compound, Dy, Tb, and Ho, etc. which are elements constituting them diffuse along the crystal grain boundaries, resulting in the deterioration of the magnetic properties being improved.

When the heat-treatment temperature becomes 800° C. or more, the mutual diffusion between the fluorine compound and the sintered magnet proceeds further, thereby, there is a case where Fe is observed in the fluorine compound layer with a concentration of 1 ppm or more. With increasing the heat-treatment temperature, there is a tendency for the concentration of elements in the parent phase diffusing in the fluorine compound layer to increase. The magnetic properties of a sintered magnet are a remanent flux density of 1.4 to 1.6 T and a coercive force of 20 to 50 kOe, and the concentration of heavy rare earth elements contained in the rare earth sintered magnet which has the same magnetic properties can be made smaller than the case of using conventional heavy rare earth added NdFeB system magnetic particles.

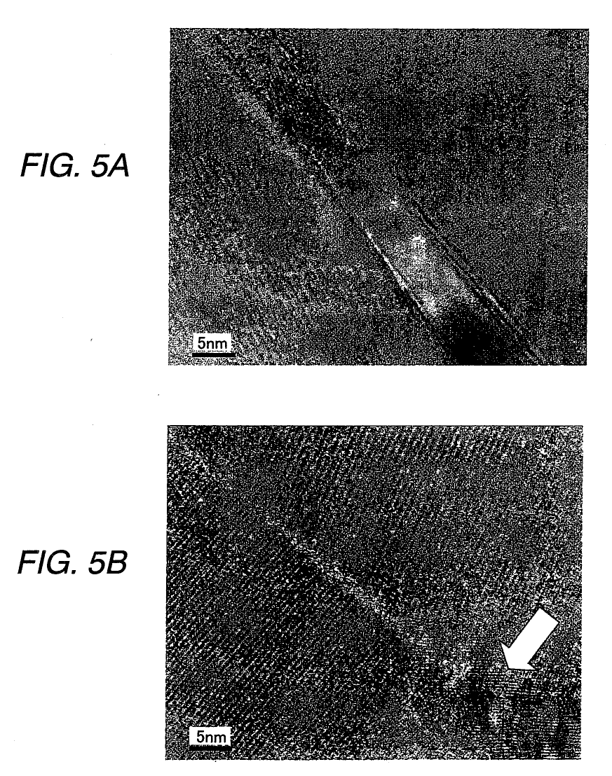

FIG. 5 is a transmission electron microscopic (TEM) image of the neighborhood of typical grain boundaries. The image in the vicinity of the grain boundaries shown in FIG. 5A illustrates a cross-sectional part of a sintered body where a TbF system solution is used for a fluorine compound solution and it is coated over the surface of the sintered NdFeB magnet with a size of 10×10×5 mm and heat-treated. As a comparison, FIG. 5B is a cross-sectional part of a sintered NdFeB magnet which is not processed with the fluorine solution. Both FIGS. 5A and 5B are images of the grain boundary triple point and the right lower side is the grain boundary triple point. The grain boundary in FIG. 5A is wider than that in FIG. 5B and fluorine, neodymium, and oxygen are detected at the grain boundaries.

The grain boundary width in FIG. 5B is small and neodymium and oxygen are detected at the grain boundaries. Although the interface between the grain boundaries and the Nd₂Fe₁₄B parent phase is sharp in FIG. 5A, the interface with the grain boundaries is not as sharp as FIG. 5A in the vicinity of the grain boundary triple point in FIG. 5B and the disorder of grain boundaries is obviously observed at the part shown by the arrow. Such a sharpness of the grain boundary is clear at other positions in a magnet where fluorine compound processing is performed and disordering of the grain boundaries is small.

As in the case of the grain boundary triple point, the interface between the parent phase and the oxyfluorine compound or fluorine compound is sharper than the interface between the parent phase and neodymium oxide. It is considered that fluorine traps the rare earth element and oxygen at the grain boundaries and it relates to the effect of reducing the parent phase. The fluorine processing which decreases such disorder of the grain boundaries can prevent the reverse magnetic domain created from the grain boundaries, so that any effect can be observed from an improvement of the coercive force, improvement of the square-loop characteristics, improvement of the energy product, improvement of the demagnetization, improvement of the degradation of the magnetic properties due to the deteriorated layer by processing, decrease in the amount of heavy rare earth element used, and a decrease in the loss.

### Thirty-Fifth Embodiment

A processing liquid for forming a coating film of a rare earth fluoride or alkaline earth metal fluoride was prepared as follows.

(1) A salt having a high degree of solubility in water, for instance, in the case of La, 4 grams of La acetate or La nitrate was put in 100 ml of water and completely dissolved by using a shaker or an ultrasonic stirrer.

(2) The hydrofluoric acid diluted to 10% was gradually added to be equivalent to the chemical reaction where LaFx (x=1 to 3) is created.

(3) The solution in which the gel-state precipitate LaFx (x=1 to 3) was created was stirred for 1 hour or more by using an ultrasonic stirrer.

(4) After it was centrifuged at a rotational speed of 4000-6000 r.p.m., the supernatant liquid was removed and an equal amount of methanol was added.

(5) After the methanol solution including the gel-state LaF clusters was stirred to completely make it a suspension, it was stirred for 1 hour or more by using an ultrasonic stirrer.

(6) The operations of (4) and (5) were repeated 3 to 10 times until anions such as acetate ions or nitrate ions, etc. were not detected.

(7) In the case of the LaF system, it became an almost clear sol-state LaFx. A methanol solution including 1 g/5 mL of LaFx was used as the processing liquid.

(8) An organic metal compound, which excludes carbon and is shown in Table 2 was added to the aforementioned solution.

Other processing liquids used for forming a coating film of a rare earth fluoride or alkaline earth metal fluorine can be made with the same processes as described above, and even if various elements are added to Dy, Nd, La, and Mg fluoride processing liquids as shown in Table 2, the diffraction patterns of all solutions do not match the fluorine compound, oxyfluorine compound, or a compound with added elements described as REnFm (RE is a rare earth or an alkaline earth element, and n and m are positive numbers).

The structure of the solution does not appreciably change if it is in the range of the concentrations of the added elements from Table 2. The diffraction pattern of the solution or a film formed by drying the solution had a plurality of peaks which include diffraction peaks with a full width at half maximum of 1 degree or more.

It indicates that the interatomic distance between the added element and fluorine or between the metallic elements is different from REnFm and the crystal structure is also different from REnFm. Since the full width at half maximum is 1 degree or more, the aforementioned interatomic distance does not have a definite value like a typical metal crystal but rather a certain distribution. The reason why it has such a distribution is due to other atoms being arranged around the aforementioned metallic element or fluorine atom, and the atom includes hydrogen, carbon, and oxygen as a main component and these atoms such as hydrogen, carbon, and oxygen easily migrate by applying external energy, such as heat, and the structure is changed and the flowability is also changed.

Although the sol and gel-state X-ray diffraction pattern includes a peak having a full width at half maximum of 1 degree or more, a structural change is observed by heat-treatment, resulting in a part of the diffraction pattern of the aforementioned REnFm or REn(F, O)m being observed. It is considered that the added elements shown in Table 2 do not have a long-period structure in the solution. The diffraction peaks of REnFm have a smaller full width at half maximum than that in the diffraction peaks of the aforementioned sol or gel. In order to increase the flowability of the solution and make the thickness of the coating film uniform, it is important to include at least one peak which has a full width at half maximum of 1 degree or more in the aforementioned diffraction pattern of the aforementioned solution. Such a peak having a full width at half maximum of 1 degree or more and a diffraction pattern of REnFm or peaks of oxyfluorine compound may be included together.

When only the diffraction pattern of REnFm or oxyfluorine compound or the diffraction pattern including a peak with a full width at half maximum of 1 degree or less is mainly observed in the diffraction pattern of the solution, it has poor flowability because a solid phase which is not a sol or a gel is contained in the solution, resulting in it being difficult to coat uniformly.

(9) A block of the NdFeB sintered body (10×10×10 mm³) is dipped in (the solution) during the process for forming the LaF system coating film and the solvent, methanol, is removed from the block under a reduced-pressure of 2 to 5 Torr.

(10) The operation described in (9) is repeated 1 to 5 times and it is heat-treated for 0.5 to 5 hours in a temperature range from 400° C. to 1100° C.

(11) A pulsed magnetic field of 30 kOe or more is applied in the anisotropic direction of the anisotropic magnet where the surface coating film is formed in (10).

This magnetized molded body was placed between the magnetic poles in a DC M-H loop measuring instrument so that the magnetization direction agreed with the direction of the magnetic field application, and the demagnetization curve was measured by applying a magnetic field between the magnetic poles. An FeCo alloy is used for the pole piece of the magnetic pole for applying a magnetic field to the magnetized molded body and the value of magnetization was calibrated by using a pure Ni sample and a pure Fe sample which have the same shape.

As a result, the coercive force of the NdFeB sintered body block on which a rare earth fluoride coating film is formed increases, and, when there are no additives, the coercive forces of the sintered magnets where Dy, Nd, La and Mg fluoride or oxyfluorine are segregated increased 30%, 25%, 15%, and 10%, respectively. In order to further increase the coercive force which was increased by coating and heat treating the solution without additives, the added elements shown in Table 2 are added to each fluoride solution by using an organic acid salt. It is understood that the coercive force of the sintered magnet is increased due to the added elements in the solution shown in Table 2 and these added elements contribute to an increase in the coercive force with reference to the coercive force of the solution without additives.

The results of the rates of increase in the coercive force are shown in Table 2. A short range structure is observed in the vicinity of the elements added to the solution by removing the solvent and, when it is further heat-treated, it diffuses along the grain boundaries of the sintered magnet with the element included in the solution. There is a tendency for these added elements to segregate in the vicinity of the grain boundaries with a part of the elements contained in the solution. Therefore, the added elements shown in Table 2 diffuse into the sintered magnet with at least one element from fluorine, oxygen, and carbon and remain in the vicinity of the grain boundaries.

The composition of the sintered magnet having a high coercive force has a tendency for the concentration of the elements contained in the fluoride solution to be high at the periphery of the magnet and low at the center of the magnet. This is due to the fluorine compound solution containing the added elements being coated outside of the sintered magnet block and dried and, while a fluoride or oxyfluoride is grown which includes the added elements and has short range structure, the diffusion progresses along the neighborhood of the grain boundaries. Specifically, a concentration gradient of at least one element from fluorine and the added elements shown in Table 2 is observed from the outside to the inside of the sintered magnet.

At the outermost surface of the sintered magnet block, oxyfluorine including an element shown in Table 2, oxyfluorine including an element shown in Table 2 and carbon, or oxyfluorine including at least one element shown in Table 2 and at least one of the elements included in the sintered magnet is formed. Such an outermost layer is necessary for improving the magnetic properties of the sintered magnet in addition to maintaining the corrosion resistance, and the electrical resistance thereof is higher than the main phase of the sintered magnet. The concentrations of the added elements shown in Table 2 in the solution agree with the range for maintaining the optical transparency; it is possible to manufacture the solution even if the concentrations thereof are increased; and it is possible to increase the coercive force.

Additionally, improvement of the magnetic properties could be observed compared with the case where there are no additives so that a higher coercive force could be obtained even if an element shown in Table 2 is added to any of a fluoride, oxide, or oxyfluoride including at least one or more rare earth elements in a slurry state. When the concentration of the added element is made to be 100 times or more (the value shown) in Table 2, the structure of fluoride included in the solution is changed and the distribution of the added element becomes non-uniform, and it is observed that there is a tendency for the diffusion of other elements to be hindered. As a result, an increase in the coercive force is partially observed although it becomes difficult to force the added elements to diffuse along the grain boundaries to inside of the magnet block. The role of the added elements shown in Table 2 is any of the following.

1) To decrease the interfacial energy by segregating in the vicinity of the grain boundaries.

2) To improve lattice matching at the grain boundaries.

3) To decrease defects at the grain boundaries.

4) To enhance diffusion of the rare earth elements, etc. at the grain boundaries.

5) To increase magnetic anisotropic energy in the vicinity of the grain boundaries.

6) To planarize the interface with the fluoride or oxyfluoride.

As a result, according to coating the solution using the added elements shown in Table 2 and heat-treating for diffusion, any effect can be observed from an increase in the coercive force, improvement of the square-loop characteristics, increase in the remanent flux density, increase in the energy product, increase in the Curie point, decrease in the magnetization field, decrease in the temperature dependence of the coercive force and the remanent flux density, improvement of the corrosion resistance, increase in the specific resistance, and a decrease in the thermal demagnetization rate. Moreover, the concentration distribution of the added elements shown in Table 2 has a tendency for the concentration to decrease in a balanced way from the outside to the inside of the sintered magnet and for the concentration to become higher at the grain boundaries.

The width of the grain boundary has a different tendency between the grain boundary triple point and a place away from the grain boundary triple point, and there is a tendency for the width of the grain boundary triple point to be wider. The added elements shown in Table 2 segregate easily at either the edge of the grain boundary phase or grain boundaries or the periphery of the grain interior from the grain boundaries to the grain interior (grain boundary side). The additions to the solution which affected the improvement of the magnetic properties of the aforementioned magnet are Mg, Al, Si, Ca, Ti, V, Cr, Mn, Fe, Co, Ni, Cu, Zn, Ga, Ge, Sr, Zr, Nb, Mo, Pd, Ag, In, Sn, Hf, Ta, W, Ir, Pt, Au, Pb, Bi, and an element selected from an element having an atomic number of 18 to 86 including all transition metal elements, and a concentration gradient of at least one element selected from these elements and fluorine is observed in the sintered magnet.

After these added elements were processed by using the solution, they were diffused by heating, so that they have different composition distributions from that previously added to the sintered magnet and the concentration becomes higher in the vicinity of the grain boundaries where fluorine is segregated. On the other hand, segregation of elements previously added was observed in the vicinity of the grain boundaries (a distance within about 1000 nm from the center of a grain) where segregation of fluorine is small and it appears as an average concentration gradient from the surface to the interior of the magnet block. When the concentration of the added element is small in the solution, it can be confirmed as a concentration gradient or concentration fluctuation. Thus, when the added element is added to the solution and the characteristics of the sintered magnet are improved by heat-treatment after coating the magnet block, the features of the sintered magnet are as follows.

1) The concentration gradient or the average concentration fluctuation of elements from an atomic number of 18 to 86 including the elements shown in Table 2 or transition metal elements is observed from the surface to the interior of the sintered magnet.

2) Segregation of elements from an atomic number of 18 to 86 including the elements shown in Table 2 or transition metal elements is observed with fluorine in the vicinity of grain boundaries.

3) The concentration of fluorine is high at the grain boundary phase and the concentration of fluorine is low outside of the grain boundary phase; segregation of the elements shown in Table 2 or elements from an atomic number of 18 to 86 is observed in the vicinity of the position where the concentration fluctuation of fluorine is observed; and an average concentration gradient and concentration fluctuation are observed from the surface to the inside of the magnet block.

4) The concentration of fluorine and added elements is highest at the outermost area of the sintered magnet block, magnetic particles, or ferromagnetic particles coated by the solution; concentration gradients and concentration fluctuations of the added elements are observed from the outside to the interior of the magnet block.

5) At least one element of the solution including the added elements shown in Table 2 or elements from an atomic number of 18 to 86 has a concentration gradient from the surface to the interior, the fluorine concentration is maximum at the outside as seen from the magnet rather than the neighborhood of the interface or the interface between the magnet and film including fluorine grown from the solution; fluoride in the vicinity of the interface includes oxygen or carbon, and it contributes to any of a high corrosion resistance, high electric resistance, or high magnetic properties.

One or two or more elements selected from the added elements shown in Table 2 and elements from an atomic number of 18 to 86 are detected in the film including fluorine; the aforementioned added elements are included to a great extent in the vicinity of the diffusion path of the fluorine inside of the magnet, and any effect can be observed from an increase in the coercive force, improvement of the square-loop characteristics of the demagnetization curve, increase in the remanent flux density, increase in the energy product, increase in the Curie point, decrease in the magnetization field, decrease in the temperature dependence of the coercive force and the remanent flux density, improvement of the corrosion resistance, increase in the specific resistance, and decrease in the thermal demagnetization rate. The concentration fluctuations of the aforementioned added elements can be confirmed by analyzing a sample, where the sintered block is cut from the surface side to the interior, using an EDX (energy dispersive X-ray) profile of a transmission electron microscope, EPMA analysis, and ICP analysis.

By using an EDX and EELS of a transmission electron microscope, the elements added into the solution, which are selected from the elements from an atomic number of 18 to 86, are segregated in the vicinity of the fluorine atoms (2000 nm or less from the segregation point of the fluorine atoms, more preferably, 1000 nm or less). The ratio of the added element segregating in the vicinity of fluorine atoms and the added element 2000 nm or more away from the segregation point of fluorine atoms is 1.1 to 1000 at the point which is 100 μm or more inside from the surface of the magnet, and, more preferably, it is 2 or more. The aforementioned ratio at the surface of the magnet is 2 or more. Both states exist, which are the part where the aforementioned added elements are continuously segregated along the grain boundaries and the part where they are segregated discontinuously.

It is not necessary that they segregate to all the grain boundaries and they easily become discontinuous at the center of the magnet. Moreover, a part of the added elements is not segregated and is mixed into the parent phase uniformly. There is a tendency that the concentration of the added element selected from an atomic number of 18 to 86, which is segregated in the vicinity of the position of fluorine segregation, decreases from the surface to the inside of the sintered magnet. Because of the concentration distribution, there is a tendency for the coercive force to be high at a position close to the surface compared with inside of the magnet.

With regard to the improvement effects of the aforementioned magnetic properties, similar effects can be obtained by performing a diffusion heat-treatment not only in a sintered magnet block but also when a film including fluorine and the added elements is formed by using the solution shown in Table 2 over the surface of the NdFeB system magnetic particles. Therefore, it is possible to manufacture a sintered magnet by sintering the green molded body, which is previously formed of NdFeB particles in a magnetic field, after the solution shown in Table 2 is impregnated into the green molded body and by molding and sintering the NdFeB system particles, where a surface treatment is performed by using the solution shown in Table 2, mixed with the untreated NdFeB system particles in a magnetic field.

Although such a sintered magnet has a balanced uniform concentration distribution of the elements included in the solution, such as fluorine and the added elements in the solution, the magnetic properties are improved because the concentration of the added elements shown in Table 2 is in a balanced way high in the vicinity of the diffusion path of the fluorine atoms.

TABLE 2

| | Dy Fluoride Segregating | | Nd Fluoride Segregating | | La Fluoride Segregating | | Mg Fluoride Segregating | |
|---|---|---|---|---|---|---|---|---|
| | Sintered Magnet | | Sintered Magnet | | Sintered Magnet | | Sintered Magnet | |
| | Concentration in DyF | Increase Rate | Concentration in | Increase Rate | Concentration | Increase Rate | Concentration in | Increase Rate |
| | System Solution | of Coercive | NdF System | of Coercive | in LaF System | of Coercive | MgF System | of Coercive |
| | (ratio to Dy) | Force (%) | Solution (at %) | Force (%) | Solution (at %) | Force (%) | Solution (at %) | Force (%) |
| C | 10-5000 | 5 | 10-5000 | 6 | 10-5000 | 10-5000 | 0.1-30 | 8 |
| | (solvent) | | (solvent) | | (solvent) | (solvent) | | |
| Mg | 0.0001-0.1 | 7 | 0.001-10.5 | 5 | 0.0001-3.5 | 7 | — | — |
| Al | 0.0001-0.2 | 12 | 0.0001-15.0 | 9 | 0.0001-5.0 | 12 | 0.0001-5.0 | 11 |
| Si | 0.0001-0.05 | 10 | 0.0001-10.5 | 5 | 0.0001-5.5 | 5 | 0.0001-5.5 | 6 |
| Ca | 0.0001-1.0 | 8 | 0.0001-5.5 | 7 | 0.0001-1.0 | 13 | 0.0001-1.0 | 5 |
| Ti | 0.0001-1.0 | 12 | 0.0001-7.0 | 9 | 0.0001-2.5 | 12 | 0.0001-2.5 | 7 |
| V | 0.0001-1.0 | 14 | 0.0001-3.5 | 11 | 0.0001-1.5 | 8 | 0.0001-1.5 | 4 |
| Cr | 0.0001-1.0 | 11 | 0.0001-5.5 | 13 | 0.0001-2.0 | 9 | 0.0001-2.0 | 6 |
| Mn | 0.0001-1.0 | 17 | 0.0001-10.5 | 18 | 0.0001-5.0 | 15 | 0.0001-5.0 | 8 |
| Fe | 0.0001-1.0 | 5 | 0.0001-7.0 | 6 | 0.0001-7.0 | 11 | 0.0001-7.0 | 7 |
| Co | 0.0001-1.0 | 21 | 0.0001-20.5 | 29 | 0.0001-10.0 | 22 | 0.0001-10.0 | 13 |
| Ni | 0.0001-1.0 | 15 | 0.0001-15.5 | 17 | 0.0001-10.0 | 17 | 0.0001-10.0 | 9 |
| Cu | 0.0001-1.0 | 35 | 0.0001-10.0 | 33 | 0.0001-10.0 | 15 | 0.0001-10.0 | 17 |
| Zn | 0.0001-1.0 | 14 | 0.0001-10.0 | 17 | 0.0001-7.0 | 18 | 0.0001-7.0 | 18 |
| Ga | 0.0001-1.0 | 27 | 0.0001-15.0 | 25 | 0.0001-15.0 | 22 | 0.0001-15.0 | 27 |
| Ge | 0.0001-1.0 | 24 | 0.0001-13.5 | 21 | 0.0001-12.0 | 20 | 0.0001-12.0 | 15 |
| Sr | 0.0001-1.0 | 14 | 0.0001-3.5 | 14 | 0.0001-5.0 | 11 | 0.0001-5.0 | 9 |
| Zr | 0.0001-1.0 | 25 | 0.0001-17.5 | 21 | 0.0001-12.0 | 9 | 0.0001-12.0 | 7 |
| Nb | 0.0001-1.0 | 23 | 0.0001-15.0 | 25 | 0.0001-10.0 | 6 | 0.0001-10.0 | 4 |
| Mo | 0.0001-1.0 | 19 | 0.0001-10.8 | 10 | 0.0001-5.5 | 14 | 0.0001-5.5 | 11 |
| Pd | 0.0001-1.0 | 28 | 0.0001-25.5 | 27 | 0.0001-15.0 | 18 | 0.0001-15.0 | 13 |
| Ag | 0.0001-1.0 | 33 | 0.0001-15.5 | 25 | 0.0001-15.5 | 21 | 0.0001-15.5 | 17 |
| In | 0.0001-1.0 | 27 | 0.0001-15.5 | 17 | 0.0001-10.2 | 23 | 0.0001-10.2 | 16 |
| Sn | 0.0001-1.0 | 28 | 0.0001-4.4 | 15 | 0.0001-5.0 | 26 | 0.0001-5.0 | 18 |
| Hf | 0.0001-1.0 | 15 | 0.0001-7.5 | 12 | 0.0001-5.2 | 12 | 0.0001-5.2 | 5 |
| Ta | 0.0001-1.0 | 19 | 0.0001-8.5 | 5 | 0.0001-5.5 | 8 | 0.0001-5.5 | 3 |
| W | 0.0001-1.0 | 11 | 0.0001-12.5 | 8 | 0.0001-2.0 | 4 | 0.0001-2.0 | 2 |
| Ir | 0.0001-1.0 | 17 | 0.0001-15.5 | 12 | 0.0001-1.5 | 15 | 0.0001-1.5 | 6 |
| Pt | 0.0001-1.0 | 41 | 0.0001-25.5 | 32 | 0.0001-10.0 | 27 | 0.0001-10.0 | 14 |
| Au | 0.0001-1.0 | 31 | 0.0001-4.8 | 24 | 0.0001-8.0 | 22 | 0.0001-8.0 | 3 |
| Pb | 0.0001-1.0 | 12 | 0.0001-1.5 | 15 | 0.0001-5.0 | 10 | 0.0001-5.0 | 5 |
| Bi | 0.0001-1.0 | 28 | 0.0001-20.5 | 21 | 0.0001-10.8 | 9 | 0.0001-10.6 | 8 |

### Thirty-Sixth Embodiment

It is a sintered magnet obtained by diffusing a G element (G is at least one or more elements independently selected from transition metal elements and rare earth elements, or at least one or more elements independently selected from transition metal elements and alkaline earth metal elements) and fluorine atoms into the R-Fe—B system (R is a rare earth element) sintered magnet.

And it has the following compositions, formulas (1) and (2),

RₐG_{b}T_{c}A_{d}FₑO_{f}M_{g} (1)

(R.G)_{a+b}T_{c}A_{d}FₑO_{f}M_{g} (2)

(Herein, R is one or two or more selected from the rare earth elements; M is an element selected from group 2, except for a rare earth element, to group 116, except for C and B, existing in the sintered magnet before coating the solution including fluorine; G is one or more element independently selected from transition metal elements and rare earth elements or one or more elements selected from transition metal elements and alkaline earth metal elements; wherein R and G may include the same element; when R and G do not include the same element, it is shown as formula (1); and when R and G include the same element, it is shown as formula (2).

T is one or two elements selected from Fe and Co; A is one or two elements selected from B (boron) and C (carbon); a-g is a atomic % of an alloy; a and B are 10≦a≦15 and 0.005≦b≦2 in the case of formula (1) and 10.005≦a+b≦17 in the case of formula (2); 3≦d≦15, 0.01≦e≦4, 0.04≦f≦4, 0.01≦g≦11, and the remaining part is c.) F and at least one element from transition metal elements which are the constituent elements are distributed so that the concentration increases on average from the center of the magnet to the surface of the magnet; and in the crystal grain boundaries surrounding the main phase crystal grains of (R,G)₂T₁₄A tetragonal in the sintered magnet, the concentration of G/(R+G) included in the crystal grain boundaries is on average greater than the concentration of G/(R+G) included in the crystal grains of the main phase.

Moreover, R and G oxyfluoride, fluoride, or carbon fluoride exists at the crystal grain boundaries at least at a depth of 10 μm from the magnet surface; the rare earth permanent magnet characterized by a coercive force in the vicinity of the magnet surface layer higher than that inside has a character where a concentration gradient of the transition metal element is observed from the surface of the sintered magnet to the center thereof; and it can be manufactured by using an example of a means as follows.

The processing liquid for forming a coating film of a rare earth fluoride or alkaline earth metal fluoride in which a transition metal element is added is manufactured as follows.

(1) A salt having a high degree of solubility in water, for instance, in the case of Dy, 4 grams of Dy acetate or Dy nitrate was put in 100 ml of the water and completely dissolved by using a shaker or an ultrasonic stirrer.

(2) The hydrofluoric acid diluted to be 10% was gradually added to be equivalent to the chemical reaction where DyFx (x=1 to 3) is created.

(3) The solution in which the gel-state precipitate DyFx (x=1 to 3) was created was stirred for 1 hour or more by using an ultrasonic stirrer.

(4) After it was centrifuged at a rotational speed of 4000-6000 r.p.m., the supernatant liquid was removed and an equal amount methanol was added.

(5) After the methanol solution including the gel-state DyF clusters was stirred to completely make it a suspension, it was stirred for 1 hour or more by using an ultrasonic stirrer.

(6) The operations of (4) and (5) were repeated 3 to 10 times until anions such as acetate ions or nitrate ions, etc. were not detected.

(7) In the case of the DyF system, it becomes an almost clear sol-state DyFx. A methanol solution including 1 g/5 mL of DyFx was used as the processing liquid.

(8) An organic metal compound which excludes carbon and is shown in table 2 was added to the aforementioned solution.

Other processing liquids used for forming a coating film of a rare earth fluoride or alkaline earth metal fluorine can be made with the same processes as described above, and even if various elements are added to Dy, Nd, La, and Mg fluoride processing liquids as shown in Table 2, the diffraction patterns of all solutions do not match the fluorine compound, oxyfluorine compound, or a compound with the additive shown as REnFm (RE is a rare earth or an alkaline earth element, and n and m are positive numbers) or REnFmOpCr (RE is a rare earth or an alkaline earth element, O is oxygen, C is carbon, F is fluorine, and n, m, p, and r are positive numbers.

The chemical formula of the components in the solution was not appreciably changed if it is in the range of the concentrations of the added elements in Table 2. The diffraction pattern of the solution or a film formed by drying the solution had a plurality of peaks having a full width at half maximum of 1 degree or more.

It indicated that the interatomic distance between the added element and fluorine or between the metallic elements is different from REnFm and the crystal structure is also different from REnFm. Since the full width at half maximum is 1 degree or more, the aforementioned interatomic distance does not have a definite value like a typical metal crystal but rather a certain distribution. The reason why it has such a distribution is due to other atoms being arranged around the aforementioned metallic element or fluorine atom in a different way from the aforementioned compound, and the atom includes hydrogen, carbon, and oxygen as a main component and these atoms such as hydrogen, carbon, and oxygen easily migrate by applying external energy, such as heat, and the structure is changed and the flowability is also changed.

Although the sol and gel-state X-ray diffraction patterns include peaks having a full width at half maximum of 1 degree or more, a structural change is observed by heat-treatment, resulting in a part of the diffraction pattern of the aforementioned REnFm or REn(F,O)m being observed. The added elements shown in Table 2 do not have a long-period structure in the solution. The diffraction peaks of REnFm have a smaller full width at half maximum than that in the diffraction peaks of the aforementioned sol or gel.

In order to increase the flowability of the solution and make the thickness of the coating film uniform, it is important to include at least one peak, which has a full width at half maximum of 1 degree or more in the aforementioned diffraction pattern of the aforementioned solution. Such a peak having a full width at half maximum of 1 degree or more and a diffraction pattern of REnFm or peaks of oxyfluorine compound may be included together.

When only the diffraction pattern of REnFm or oxyfluorine compound or the diffraction pattern including a peak with a full width at half maximum of 1 degree or less is mainly observed in the diffraction pattern of the solution, it has poor flowability because solid phases which are not a sol or a gel is contained in the solution. However, improvement of the coercive effect is observed.

(9) A block of the NdFeB sintered body (10×10×10 mm³) is dipped in the solution in the process for forming the DyF system coating film, and the solvent, methanol, is removed from the block under a reduced-pressure of 2 to 5 Torr.

(10) The operation described in (9) is repeated 1 to 5 times and it is heat-treated for 0.5 to 5 hours in a temperature range from 400° C. to 1100° C.

(11) A pulsed magnetic field of 30 kOe or more is applied in the anisotropic direction of the anisotropic magnet where the surface coating film is formed in (10).

This magnetized molded body was placed between the magnetic poles in a DC M-H loop measuring instrument so that the magnetization direction agreed with the direction of the magnetic field application, and the demagnetization curve was measured by applying a magnetic field between the magnetic poles. An FeCo alloy was used for the pole piece of the magnetic pole for applying a magnetic field to the magnetized molded body and the value of magnetization was calibrated by using a pure Ni sample and a pure Fe sample which have the same shape.

As a result, the coercive force of the NdFeB sintered body block on which a rare earth fluoride coating film is formed is increased, and the coercive force is further increased by using a processing liquid in which a transition metal element is added compared to a sintered magnet without any additives. Accordingly, a further increase in the coercive force which is increased by coating and heat-treatment of a solution without additives means that these added elements contribute to an increase in the coercive force.

A short range structure is observed in the vicinity of the element added to the solution by removing the solvent and, when it is further heat-treated, it diffuses along the grain boundaries of the sintered magnet with the element included in the solution. There is a tendency for these added elements to segregate in the vicinity of the grain boundaries with a part of the elements contained in the solution. The composition of the sintered magnet having a high coercive force has a tendency for the concentration of the elements included in the fluoride solution to be high at the periphery of the magnet and low at the center of the magnet.

This is due to the fluorine compound solution containing the added elements being coated outside of the sintered magnet block and dried and, while fluoride or oxyfluoride is grown which includes the added elements and has short range structure, the diffusion progresses along the neighborhood of the grain boundaries. Specifically, concentration gradient of at least one element from fluorine and the added elements shown in Table 2 is observed from the outside to the inside of the sintered magnet block.

The concentrations of the added elements shown in Table 2 in the solution agree with the range for maintaining the optical transparency, and it is possible to manufacture the solution even if the concentration thereof is increased. Even if an element selected from an atomic number from 18 to 86 is added to any of fluorine, oxide, or oxyfluorine including at least one or more rare earth elements in a slurry state, improvement of the magnetic properties could be observed compared with the case of no additives so that a higher coercive force could be obtained. The role of the added element is any of the following.

1) To decrease the interfacial energy by segregating in the vicinity of the grain boundaries.

2) To improve lattice matching at the grain boundaries.

3) To decrease defects at the grain boundaries.

4) To enhance diffusion of the rare earth element, etc. at the grain boundaries.

5) To increase magnetic anisotropic energy in the vicinity of the grain boundaries.

6) To planarize the interface with fluoride, oxyfluoride, or carbon fluoride.

7) To increase anisotropy of the rare earth element.

8) To remove oxygen from the parent phase.

9) To increase the Curie point of the parent phase.

As a result, any effect can be observed from an increase in the coercive force, improvement of the square-loop characteristics, increase in the remanent flux density, increase in the energy product, increase in the Curie point, decrease in the magnetization field, decrease in the temperature dependence of the coercive force and the remanent flux density, improvement of the corrosion resistance, increase in the specific resistance, and decrease in the thermal demagnetization rate.

Moreover, the concentration distributions of the transition metal elements including the added elements have a tendency for the concentration to decrease in a balanced way from the outside to the inside of the sintered magnet and for the concentration to become higher at the grain boundaries. The width of the grain boundary has a different tendency between the grain boundary triple point and a place away from the grain boundary triple point, and there is a tendency for the width of the grain boundary triple point to be wider and the concentration thereof becomes higher.

The transition metal elements segregate easily at either the edge of the grain boundary phase or grain boundaries or the periphery of the grain interior from the grain boundaries to the grain interior (grain boundary side). After these added elements are processed by using the solution, they are diffused by heating, so that they have different composition distributions from that previously added to the sintered magnet and the concentration becomes higher in the vicinity of the grain boundaries where fluorine or the rare earth element segregates. On the other hand, segregation of elements previously added is observed at the grain boundaries where segregation of fluorine is small and it appears as an average concentration gradient from the surface to the interior of the magnet block.

When the concentration of the added element is small in the solution, it can be confirmed as a concentration gradient or a concentration fluctuation. Thus, when the added element is added to the solution and the characteristics of the sintered magnet are improved by heat-treatment after coating the magnet block, the features of the sintered magnet are as follows.

1) The concentration gradient or the average concentration fluctuation of a transition metal element is observed from the surface to the inside of the sintered magnet.

2) Segregation of a transition metal element in the vicinity of grain boundaries is observed with fluorine.

3) The concentration of fluorine is high at the grain boundary phase and the concentration of fluorine is low outside of the grain boundary phase, segregation of the transition metal element is observed in the vicinity of the position where the concentration fluctuation of fluorine is observed, and an average concentration gradient and concentration fluctuation are observed from the surface to the interior of the magnet block.

4) A fluoride layer or oxyfluoride layer including a transition metal element, fluorine, and carbon is grown at the surface of the sintered magnet.

### Thirty-Seventh Embodiment

It is a sintered magnet obtained by diffusing a G element (G is one or more elements independently selected from transition metal elements and rare earth elements, or one or more elements independently selected from transition metal elements and alkaline earth metal elements) and fluorine atoms into the R—Fe—B system (R is a rare earth element) sintered magnet.

And it has the following compositions, formulas (1) and (2),

RₐG_{b}T_{c}A_{d}FₑO_{f}M_{g} (1)

(R.G)_{a+b}T_{c}A_{d}FₑO_{f}M_{g} (2)

(Herein, R is one or two or more selected from the rare earth elements; M is an element selected from group 2 except for rare earth elements to group 116 except for C and B existing in the sintered magnet before coating the solution including fluorine; G is one or more elements independently selected from transition metal elements and rare earth elements or one or more element selected from transition metal elements and alkaline earth metal elements; wherein R and G may include the same element; when R and G do not include the same element, it is shown as formula (1); and when R and G include the same element, it is shown as formula (2).

T is one or two elements selected from Fe and Co; A is one or two elements selected from B (boron) and C (carbon); a-g is a atomic % of an alloy; a and B are 10≦a≦15 and 0.005≦b≦2 in the case of formula (1) and 10.0055≦a+b≦17 in the case of formula (2); 3≦d≦15, 0.01≦e≦10, 0.04≦f≦4, 0.01≦g ≦11, and the remaining part is c.) F and at least one element of semi metal elements and transition metal elements, which are the constituent elements, are distributed so that the concentration increases on average from the center of the magnet to the surface of the magnet; and in the crystal grain boundaries surrounding the main phase crystal grains of (R,G)₂T₁₄A tetragonal in the sintered magnet or the surface of the sintered magnet, the concentration of G/(R+G) included in the crystal grain boundaries is on average greater than the concentration of G/(R+G) included in the crystal grains of the main phase.

Moreover, R and G oxyfluoride, fluoride, or carbon fluoride exists at the crystal grain boundaries at least at a depth of 1 μm from the magnet surface; the rare earth permanent magnet characterized by a coercive force in the vicinity of the magnet surface layer higher than the interior thereof has a character where a concentration gradient of the transition metal element is observed from the surface of the sintered magnet to the center thereof; and it can be manufactured by using an example of a means as follows.

The processing liquid for forming a coating film of a rare earth fluoride or alkaline earth metal fluoride in which a transition metal element is added is manufactured as follows.

(1) A salt having a high degree of solubility in water, for instance, in the case of Dy, 4 grams of Dy acetate or Dy nitrate was put in 100 ml of water and completely dissolved by using a shaker or an ultrasonic stirrer.

(2) The hydrofluoric acid diluted to be 10% was gradually added to be equivalent to the chemical reaction where DyFx (x=1 to 3) is created.

(3) The solution in which the gel-state precipitate DyFx (x=1 to 3) is created was stirred for 1 hour or more by using an ultrasonic stirrer.

(4) After it was centrifuged at a rotational speed of 4000-6000 r.p.m., the supernatant liquid was removed and an equal amount methanol was added.

(5) After the methanol solution including the gel-state DyF system, DyFC system, or DyFO system clusters was stirred to completely make it a suspension, it was stirred for 1 hour or more by using an ultrasonic stirrer.

(6) The operations of (4) and (5) were repeated 3 to 10 times until anions such as acetate ions or nitrate ions, etc. were not detected.

(7) In the case of a DyF system, it becomes an almost clear sol-state DyFx including C and O. A methanol solution including 1 g/5 mL of DyFx was used as the processing liquid.

(8) An organic metal compound which excludes for carbon and is shown in Table 2 was added to the aforementioned solution.

Other processing liquids used for forming a coating film of a rare earth fluoride or alkaline earth metal fluorine can be made in the same processes as described above, and even if various elements are added to Dy, Nd, La, and Mg fluoride processing liquids including a rare earth element or an alkaline earth element, the diffraction patterns of all solutions do not match the fluorine compound, oxyfluorine compound, or a compound with the additives shown as REnFm (RE is a rare earth or an alkaline earth element, and n and m are positive numbers) or REnFmOpCr (RE is a rare earth or an alkaline earth element, O is oxygen, C is carbon, F is fluorine, and n, m, p, and r are positive numbers).

The diffraction pattern of these solutions and films formed by drying the solution had X-ray diffraction pattern where a plurality of peaks having a full width at half maximum of 1 degree or more are main peaks. It indicates that the interatomic distance between the added element and fluorine or between the metallic elements is different from REnFm and the crystal structure is also different from REnFm. Since the full width at half maximum is 1 degree or more, the aforementioned interatomic distance does not have a definite value like a typical metal crystal but rather a certain distribution. The reason why it has such a distribution is due to other atoms being arranged around the aforementioned metallic element or a fluorine atom in a different way from the aforementioned compound, and the atom includes hydrogen, carbon, and oxygen as a main component and these atoms such as hydrogen, carbon, and oxygen easily migrate by applying external energy, such as heat, and the structure is changed and the flowability is also changed.

Although the sol and gel-state X-ray diffraction pattern consists of a diffraction pattern which includes a peak having a full width at half maximum of 1 degree or more, structural change is observed by heat-treatment, resulting in a part of diffraction pattern of the aforementioned REnFm, REn(F,C,O)m (the ratio of F, C, and O is arbitrary) or REn(F,O)m (the ratio of F and O is arbitrary) being observed. The diffraction peaks have a smaller full width at half maximum than that in the diffraction peaks of the aforementioned sol or gel.

In order to increase the flowability of the solution and make the thickness of the coating film uniform, it is important to include at least one peak, which has a full width at half maximum of 1 degree or more in the aforementioned diffraction pattern of the aforementioned solution.

(9) A block of the NdFeB sintered body (10×10×10 mm³), a NdFeB green molded body, or NdFeB magnetic particles is dipped in the solution during the process for forming the DyF system coating film, and the solvent, methanol, is removed from the block under a reduced pressure of 2 to 5 Torr.

(10) The operation described in (9) is repeated 1 to 5 times and it is heat-treated for 0.5 to 5 hours in a temperature range from 400° C. to 1100° C.

(11) A pulsed magnetic field of 30 kOe or more is applied in the anisotropic direction of the sintered magnet or NdFeB system magnetic particles where the surface coating film is formed in (10).

This magnetized sample was placed between the magnetic poles in a DC M-H loop measuring instrument so that the magnetization direction agreed with the direction of the magnetic field application, and the demagnetization curve was measured by applying a magnetic field between the magnetic poles. An FeCo alloy was used for the pole piece of the magnetic pole for applying a magnetic field to the magnetized sample and the value of magnetization was calibrated by using a pure Ni sample and a pure Fe sample which have the same shape.

As a result, the coercive force of the NdFeB sintered body block on which a rare earth fluoride coating film is formed is increased and the coercive force or the square-loop characteristics of the demagnetization curve is further increased by using a processing liquid in which a transition metal element is added compared to a sintered magnet without any additives. Accordingly, a further increase in the coercive force and the square-loop characteristics, which are increased by coating and heat-treatment of a solution without additives means that these added elements contribute to an increase in the coercive force.

A short range structure is observed in the vicinity of the atomic position added to the solution by removing the solvent and, when it is further heat-treated, it diffuses along the grain boundaries of the sintered magnet with the element included in the solution. There is a tendency for these added elements to segregate in the vicinity of the grain boundaries with a part of the elements contained in the solution.

The composition of the sintered magnet having a high coercive force has a tendency for the concentration of the elements included in the fluoride solution to be high at the periphery of the magnet and low at the center of the magnet. This is due to the fluorine compound solution containing the added element being coated outside of the sintered magnet block and dried and, while a fluoride or oxyfluoride is grown which includes the added element and has short range structure, the diffusion progresses along the neighborhood of the grain boundaries. Specifically, a concentration gradient or concentration fluctuation of at least one element from fluorine and the added elements shown in Table 2, such as transition metal elements or semimetal elements, is observed from the outside to the interior of the sintered magnet block.

Even if a transition metal element is added to any of fluorine, oxide, or oxyfluoride including at least one or more of rare earth elements in a slurry state, improvement of the magnetic properties could be observed compared with the case of no additives so that a high coercive force could be obtained. However, a more remarkable improvement of the magnetic properties, such as a coercive force increase effect, is obtained when the transition metal element and the semimetal element are added to the transparent solution. Even when the rare earth element and the alkaline earth element are not used, an improvement of the magnetic properties can be observed by forming the fluoride solution including the added element as shown in Table 2 and coating (it) over the magnetic body.

The role of the added element is any of the following.

1) To decrease the interfacial energy by segregating in the vicinity of the grain boundaries.

2) To improve lattice matching at the grain boundaries.

3) To decrease defects at the grain boundaries.

4) To enhance diffusion of the rare earth element, etc. at the grain boundaries.

5) To increase magnetic anisotropic energy in the vicinity of the grain boundaries.

6) To planarize the interface with fluoride, oxyfluoride, or carbon fluoride.

7) To increase anisotropy of the rare earth element.

8) To remove oxygen from the parent phase.

9) To increase the Curie point of the parent phase.

10) To change the electron structure of grain boundaries by coupling with other elements which segregate at the grain boundaries. As a result, any effect can be observed from an increase in the coercive force, improvement of the square-loop characteristics, increase in the remanent flux density, increase in the energy product, increase in the Curie point, decrease in the magnetization field, decrease in the temperature dependence of the coercive force and the remanent flux density, improvement of the corrosion resistance, increase in the specific resistance, and decrease in the thermal demagnetization rate.

The transition metal element or the semimetal element, which is added to the solution and diffused, is easily segregated at either the edge of the grain boundary phase or grain boundaries or the periphery of the grain interior from the grain boundary to the grain interior (grain boundary side). After these added elements are processed by using the solution, they are diffused by heating, so that they have a different composition distribution from that previously added to the sintered magnet, and there is a tendency for the concentration to become higher in the vicinity of the grain boundaries where fluorine or the main component of the fluoride solution is segregated.

On the other hand, segregation of elements previously added is observed at the grain boundaries where segregation of fluorine is small and it appears as an average concentration gradient from the surface to the interior of the magnet block. However, even if the added elements are segregated regardless of the place where fluorine is segregated, the magnetic properties thereof can be improved.

When the concentration of the added element is small in the solution, it can be confirmed as a concentration gradient or a concentration fluctuation by analyzing and comparing the samples cut from the magnet block. Thus, when the added element is added to the solution and the characteristics of the sintered magnet are improved by heat-treatment after coating the magnet block, the features of the sintered magnet are as follows.

1) At least one element selected from elements having an atomic number from 18 to 86, such as transition metal elements or semimetal elements, is added to a solution containing fluorine as a main component. The concentration gradient or average concentration fluctuation is observed from the surface to the interior and there is a tendency for the concentration to decrease from the surface of the magnet to the interior thereof.

2) Segregation of the transition metal elements or the semimetal elements which are added in the solution in the vicinity of grain boundaries of the magnet is observed with fluorine and there are cases where the distribution of fluorine concentration is similar to the concentration profile of the added element and where the added element is segregated without fluorine. Some of the added elements do not segregate but contaminate the parent phase.

3) The concentration of fluorine is high at the grain boundary phase and the concentration of fluorine is low outside of the grain boundary phase; there is a case where segregation of the added element, such as the transition metal element, etc., is observed in the vicinity of the position where the concentration fluctuation of fluorine is observed; and an average concentration gradient and concentration fluctuation are observed from the surface to the interior of the magnet block.

4) A layer including a transition metal element, fluorine, and carbon or an oxyfluoride and fluoride which contain elements selected from elements having an atomic number of 18 to 86 is grown at the surface of the sintered magnet to be a thickness of 1 to 10000 nm. The element having an atomic number from 18 to 86 has a concentration fluctuation of 10 ppm or more in the depth direction from the surface to the interior. The layer including fluorine has a part of the constituent elements of the sintered magnet and such a surface layer may be removed by polishing, etc. in the final product. However, it may be allowed to remain as is as a protection film for corrosion resistance.

5) The concentration gradient of the added element previously added before the solution processing is different from the concentration gradient of the element added during solution processing, and the former does not depend on the average concentration gradient of the main component of the fluoride solution such as fluorine.

On the other hand, the latter concentration profile has a dependence on the concentration profile of at least one element of the constituent elements of the fluoride solution.

### Thirty-Eighth Embodiment

As an NdFeB system powder, a quenched powder, which includes Nd₂Fe₁₄B as a main structure is formed and a fluorine compound is formed at the surface thereof. When DyF₃ is formed at the surface of the quenched powder, Dy(CH₃COO)₃ is dissolved in H₂O as a raw material and HF is added to it.

By adding HF, a gelatinous DyF₃.XH₂O is formed. It is centrifuged to remove the solvent. When the concentration of the sol-state rare earth fluorine compound is 10 g/dm³ or more, the permeability of an optical path length of 1 cm in the processing liquid is 5% or more at a wavelength of 700 nm. A compound or solution including at least one element selected from transition metal elements and semimetal elements is added to such a solution with optical transparency. After adding it, the solution has a broad X-ray diffraction peak, a full width at half maximum of the diffraction peak is from 1 to 10 degrees and it has flowability. The aforementioned NdFeB is mixed with this solution. The solvent of the mixture is evaporated, and the hydrated water was evaporated by heating. In a heat-treatment at 500 to 800° C., it is understood that the crystal structure of the fluorine compound film includes a NdF₃ structure, a NdF₂ structure, or oxyfluoride, etc. containing the added element.

Segregation of the added element is observed in addition to segregation of Dy and Nd along the diffusion path in the magnetic particles and segregation of the plate-like Nd, Dy, and fluorine, and the magnetic properties are improved due to an increase in the anisotropic energy, improvement of lattice matching at the grain boundaries, reduction of the parent phase by fluorine, and improvement of the ferromagnetic coupling by diffusion of iron into the fluoride.

In order to decrease the amount of the heavy rare earth element used, at least one element selected from semimetal elements and transition metal elements segregates by surface treatment using the fluoride solution in which the semimetal elements and transition metal elements and by subsequent diffusion, thereby, any effect of an increase in the coercive force, increase in the square-loop characteristics of the demagnetization curve, increase in the remanent flux density, increase in the energy product, increase in the Curie point, decrease in the magnetization field, decrease in the temperature dependence of the coercive force and the remanent flux density, improvement of the corrosion resistance, increase in the specific resistance, and decrease in the thermal demagnetization is observed in the NdFeB system magnetic particles, resulting in it being made possible to improve the aforementioned magnetic properties of the magnetic particles used for bonded magnets, hot forming anisotropic magnetic particles, and hot forming anisotropic sintered magnets.

### Thirty-Ninth Embodiment

It is a sintered magnet obtained by diffusing a G element (G is a metallic element (at least one element selected from metallic elements from group 3 to group 11 except for rare earth elements or elements from group 2 and from group 12 to group 16 except for C and B) and fluorine atoms into the R—Fe—B system (R is a rare earth element) sintered magnet.

And it has the following compositions, formulas (1) and (2),

RₐG_{b}T_{c}A_{d}FeO_{f}Mg (1)

(R.G)_{a+b}T_{c}A_{d}FeO_{f}M_{g} (2)

(Herein, R is one or two or more selected from rare earth elements; M is an element selected from group 2 except for rare earth elements to group 116 except for C and B existing in the sintered magnet before coating the solution including fluorine; G is one or more elements selected from metallic elements (metallic elements from group 3 except for rare earth elements to group 11 or elements from group 12 to group 16 except for C and B) and rare earth elements or one or more selected from metallic elements (metallic elements from group 3 except for rare earth elements to group 11 or elements of group 2 and from 12 to group 16 except for C and B) and alkaline earth metal elements; wherein R and G may include the same element; when R and G do not include the same element, it is shown as formula (1); and when R and G include the same element, it is shown as formula (2).

T is one or two elements selected from Fe and Co; A is one or two elements selected from B (boron) and C (carbon); a-g is a atomic % of an alloy; a and B are 10≦a≦15 and 0.005≦b≦2 in the case of formula (1) and 10.005≦a+b≦17 in the case of formula (2); 3≦d≦17, 0.01≦e≦10, 0.04≦f≦4, 0.01≦g≦11, and the remaining part is c.) F and at least one metallic element (elements from group 2 except for rare earth elements to group 116, except for C and B) which are the constituent elements thereof are distributed so that the concentration increases on average from the center of the magnet to the surface of the magnet; and in the crystal grain boundaries surrounding the main phase crystal grains of (R,G)₂T₁₄A tetragonal in the sintered magnet, the concentration of G/(R+G) included in the crystal grain boundaries is on average greater than the concentration of G/(R+G) included in the crystal grains of the main phase.

Moreover, R and G oxyfluoride, fluoride, or carbon fluoride exists at the crystal grain boundaries at least at a depth of 1 μm from the magnet surface; the rare earth permanent magnet characterized by a coercive force in the vicinity of the magnet surface layer higher than that inside thereof has a character where the concentration gradient and concentration fluctuation of the metallic element (elements from group 2 except for rare earth elements to group 116, except for C and B) is observed from the surface of the sintered magnet to the center thereof; and it can be manufactured by using an example of a means as follows.

The processing liquid for forming a coating film of a rare earth fluoride or alkaline earth metal fluoride, in which metallic elements (metallic elements from group 3 except for rare earth elements to group 11 or elements from group 2 and group 12 to group 116 except for C and B) is added, is manufactured as follows.

(1) A salt having a high degree of solubility in water, for instance, in the case of Dy, 1 to 10 grams of Dy acetate or Dy nitrate was put in 100 ml of water and completely dissolved by using a shaker or an ultrasonic stirrer.

(2) The hydrofluoric acid diluted to be 10% was gradually added to be equivalent to the chemical reaction where DyFx (x=1 to 3) is created.

(3) The solution in which the gel-state precipitation of DyFx (x=1 to 3) was created was stirred for 1 hour or more by using an ultrasonic stirrer.

(4) After it was centrifuged at a rotational speed of 4000-10000 r.p.m., the supernatant liquid was removed and an equal amount methanol was added.

(5) After the methanol solution including the gel-state DyF system, DyFC system, or DyFO system clusters was stirred to make it completely a suspension, it was stirred for 1 hour or more by using an ultrasonic stirrer.

(6) The operations of (4) and (5) were repeated 3 to 10 times until anions such as acetate ions or nitrate ions, etc. were not detected.

(7) In the case of a DyF system, it becomes an almost clear sol-state DyFx including C and O. A methanol solution including 1 g/5 mL of DyFx was used as the processing liquid.

(8) An organic metal compound including at least one element selected from metallic elements (metallic elements from group 3 except for rare earth elements to group 11 or an element of group 2 and from group 12 and group 16 except for C and B) was added to the aforementioned solution.

Other processing liquids used for forming a coating film of a rare earth fluoride, alkaline earth metal fluoride, or group 2 metallic fluoride can be made in the same processes as described above, and even if various elements are added to a fluorine system processing liquids which include a rare earth element, alkaline earth elements, or group 2 metal elements, such as Dy, Nd, La, and Mg, etc., the diffraction patterns of all solutions do not match the fluorine compound, oxyfluorine compound, or a compound with the additives shown as REnFm (RE is a rare earth element, a group 2 metallic element, or an alkaline earth element, and n and m are positive numbers) or REnFmOpCr (RE is a rare earth element, a group 2 metallic element, or an alkaline earth element, O is oxygen, C is carbon, F is fluorine, and n, m, p, and r are positive numbers.

The diffraction pattern of these solutions and films formed by drying the solution had X-ray diffraction patterns where peaks having a full width at half maximum of 1 degree or more are main peaks. It indicates that the interatomic distance between the added element and fluorine or between the metallic elements is different from REnFm and the crystal structure is also different from REnFm.

Since the full width at half maximum is 1 degree or more, the aforementioned interatomic distance does not have a definite value like a typical metal crystal but rather a certain distribution. The reason why it has such a distribution is due to other atoms being arranged around the aforementioned metallic element or a fluorine atom in a different way from the aforementioned compound, and the atom includes hydrogen, carbon, and oxygen as a main component and these atoms such as hydrogen, carbon, and oxygen easily migrate by applying external energy, such as heat, and the structure is changed and the flowability is also changed.

Although the sol and gel-state X-ray diffraction patterns consist of peaks which include a peak having a full width at half maximum of 1 degree or more, structural changes are observed by heat-treatment, resulting in a part of the diffraction pattern of the aforementioned REnFm, REn(F,C,O)m, or REn(F,O)m being observed. These diffraction peaks have a smaller full width at half maximum than the diffraction peaks of the aforementioned sol or gel. In order to increase the flowability of the solution and make the thickness of the coating film uniform, it is important to include at least one peak, which has a full width at half maximum of 0.5 degree or more in the aforementioned diffraction pattern of the aforementioned solution.

(9) A block of a NdFeB sintered body (100×100×100 mm³), a NdFeB tentative molded body, or NdFeB magnetic particles are dipped in the solution during processing for forming the DyF system coating film, and the solvent, methanol, is removed from the block under a reduced-pressure of 2 to 5 Torr.

(10) The operation described in (9) is repeated 1 to 5 times and it is heat-treated for 0.5 to 5 hours in a temperature range from 400° C. to 1100° C.

(11) A pulsed magnetic field of 30 kOe or more is applied in the anisotropic direction to the sintered magnet or NdFeB system magnetic particles coated with the surface coating film formed in (10).

This magnetized sample was placed between the magnetic poles in a DC M-H loop measuring instrument so that the magnetization direction agreed with the direction of the magnetic field application, and the demagnetization curve was measured by applying a magnetic field between the magnetic poles. An FeCo alloy is used for the pole piece of the magnetic pole for applying a magnetic field to the magnetized sample and the value of magnetization was calibrated by using a pure Ni sample and a pure Fe sample which have the same shape.

As a result, the coercive force of the NdFeB sintered body block on which a rare earth fluoride coating film is formed is increased, and the coercive forces or the square-loop characteristics of the demagnetization curve are further increased by using a processing liquid in which a metallic element (a metallic element from group 3 except for rare earth elements to group 11 or an element of group 2 and from group 12 to group 16 except for C and B) is added compared with the sintered magnet after coating and diffusing only a heavy rare metal fluoride processing liquid where any additive is not used. Accordingly, a further increase in the coercive force and the square-loop characteristics which were increased by coating and heat-treating a solution without additives means that these added elements contribute to an increase in the coercive force. A short range structure is observed in the vicinity of the elements added to the solution by removing the solvent and, when it is further heat-treated, it diffuses along the grain boundaries of the sintered magnet with the element included in the solution.

There is a tendency for a part of these metallic elements (metallic elements from group 3 except for rare earth elements to group 11 or elements of group 2 and from group 12 to group 16 except for C and B) to segregate in the vicinity of the grain boundaries with a part of the elements included in the solution. The composition of the sintered magnet having high coercive force has a tendency for the concentration of the elements included in the fluoride solution to be high at the periphery of the magnet and low at the center of the magnet. This is due to the fluorine compound solution which includes the added element being coated outside of the sintered magnet block and dried and, while a fluoride or oxyfluoride is grown which includes the added element and has short range structure, the diffusion progresses along the vicinity of the grain boundaries. Specifically, a concentration gradient or concentration fluctuation of at least one element from fluorine and the metallic elements (metallic elements from group 3 except for rare earth elements to group 11 or elements of group 2 and from group 12 to group 16 except for C and B) is observed from the outside to the interior of the sintered magnet block.

Even if a transition metal element is added to any of fluorine, an oxide, or oxyfluoride which includes at least one or more of slurry-state rare earth elements including a ground powder of fluoride, improvement of the magnetic properties could be observed compared with the case of no additives so that a higher coercive force could be obtained. However, a more remarkable improvement of the magnetic properties, such as a coercive force increase effect, is obtained when a transition metal element and a semimetal element are added to the transparent solution.

Moreover, when a film including a heavy rare earth element such as Dy, etc. is formed by using a evaporation technique and a sputtering technique, the magnetic properties thereof can be improved by evaporating or sputtering an evaporation source in which transition metal elements, metallic elements from group 3 except for rare earth elements to group 11 or elements of group 2 and from group 12 to group 16 except for C and B are mixed, compared with using one including only a heavy rare earth element. This is due to the transition metal element and the semimetal element being uniformly dispersed on an atomic level in the fluoride solution, the transition metal element and the semimetal element are uniformly dispersed having a short range structure in the fluoride film, and these elements diffuse along the grain boundaries at a low temperature with diffusion of elements included in the solution.

The role of the added metallic elements (elements selected from group 2 except for rare earth elements to group 116 except for C and B) is any of the flowing.

1) To decrease the interfacial energy by segregating in the vicinity of the grain boundaries.

2) To improve lattice matching at the grain boundaries.

3) To decrease defects at the grain boundaries.

4) To enhance diffusion of the rare earth element, etc. at the grain boundaries.

5) To increase magnetic anisotropic energy in the vicinity of the grain boundaries.

6) To planarize the interface with fluoride, oxyfluoride, or carbon fluoride.

7) To improve the anisotropy of the rare earth element.

8) To improve oxygen from the parent phase.

9) To increase the Curie point of the parent phase.

10) To decrease the amount of the rare earth element used. Specifically, the amount of the rare earth element used can be decreased from 1 to 50% by using the added element compared with the amount to obtain the same coercive force.

11) To form, oxyfluoride or fluoride including the added element at the surface of the sintered magnet block in a thickness from 1 to 10000 nm and to contribute to improvement of the corrosion resistance and an increase in the resistance.

12) To enhance segregation of the elements previously added to the sintered magnet.

13) To perform reduction effects by diffusing oxygen of the parent phase into the grain boundaries or to reduce the parent phase by coupling the added elements with oxygen.

14) To enhance the ordering the grain boundary phase. A part of the added element remains in the grain boundary phase.

15) To suppress growth of the phase including fluorine at the grain boundary triple point.

16) To make the concentration distribution of the heavy rare earth element or fluorine steep ay the grain boundaries and interface of the parent phase.

17) To decrease the liquid phase formation temperature by diffusing fluorine and carbon, or oxygen and the added element.

18) To increase the magnetic moment of the parent phase by grain boundary segregation of fluorine and the added element.

19) To enhance low temperature grain boundary diffusion of the heavy rare earth element and to suppress growth of the phases, which decrease the remanent flux density, such as a high rare earth content phase and boride, etc., except for the parent phase.

As a result, any effect can be observed from an increase in the coercive force, improvement of the square-loop characteristics, increase in the remanent flux density, increase in the energy product, increase in the Curie point, decrease in the magnetization field, decrease in the temperature dependence of the coercive force and the remanent flux density, improvement of the corrosion resistance, increase in the specific resistance, and a decrease in the thermal demagnetization rate. The metallic elements (an element from group 2 except for rare earth elements to group 116, except for C and B), which are added to the solution and diffused, segregate easily at either the edge of the grain boundary phase or grain boundaries, or at the periphery of the grain interior from the grain boundaries to the grain interior (grain boundary side), or the neighborhood of the interface between the magnet surface and the fluoride.

After these added elements were processed by using the solution, they are diffused by heating, so that they have different composition distributions from that previously added to the sintered magnet and there is a tendency for the concentration to become higher in the vicinity of the grain boundaries where fluorine or the main component of the fluoride solution segregate.

On the other hand, segregation of elements previously added is observed at the grain boundaries where segregation of fluorine is small and it appears as an average concentration gradient or concentration fluctuation from the surface to the interior of the magnet block. Thus, when the added element is added to the solution and the characteristics of the sintered magnet are improved by heat-treatment after coating the magnet block, the features of the added element diffusion sintered magnet are as follows.

1) There is a tendency for the concentration gradation or average concentration fluctuation of the metallic elements (elements from group 2 except for rare earth elements to group 116, except for C and B) to be observed from the surface to the interior and for the concentration to decrease from the surface of the magnet to the interior.

2) Segregation of the metallic elements (elements from group 2 except for rare earth elements to group 116, except for C and B) which is added to the solution is observed in the vicinity of grain boundaries of the magnet with fluorine, and a relationship or correlation is observed in the concentration distribution of the fluorine concentration and the concentration distribution of the added element.

3) The concentration of fluorine is high at the grain boundary phase and the concentration of fluorine is low outside of the grain boundary phase, segregation of the metallic elements (elements from group 2 except for rare earth elements to group 116, except for C and B) is observed in the vicinity of the position where the concentration fluctuation of fluorine is observed, and an average concentration gradient and concentration fluctuation are observed from the surface to the interior of the magnet block.

4) A layer including the metallic elements (elements from group 2 except for rare earth elements to group 116, except for C and B), fluorine, and carbon is grown at the surface of the sintered magnet.

5) The concentration gradient of the added element previously added before the solution processing is different from the concentration gradient of the element added during solution processing and the former does not depend on the average concentration gradient of a main component of the fluoride solution such as fluorine. On the other hand, the latter has a strong relationship or correlation with the concentration profile of at least one element of the constituent elements of the fluoride solution.

### Fortieth Embodiment

The processing liquid for forming a coating film of a rare earth fluoride or an alkaline earth metal fluoride is manufactured as follows.

(1) A salt having a high degree of solubility in water, for instance, in the case of Nd, 4 grams of Nd acetate or Nd nitrate was put into 100 ml of water and completely dissolved by using a shaker or an ultrasonic stirrer.

(2) The hydrofluoric acid diluted to be 10% was gradually added to be equivalent to the chemical reaction where NdFxCy (x and y are positive numbers) is created.

(3) The solution in which a gel-state precipitate NdFxCy (x and y are positive numbers) was created was stirred for 1 hour or more by using an ultrasonic stirrer.

(4) After it was centrifuged at a rotational speed of 4000-6000 r.p.m., the supernatant liquid was removed and an equal amount methanol was added.

(5) After the methanol solution including the gel-state NdFC system clusters was stirred to completely make it a suspension, it was stirred for 1 hour or more by using an ultrasonic stirrer.

(6) The operations of (4) and (5) were repeated 3 to 10 times until anions such as acetate ions or nitrate ions, etc. were not detected.

(7) In the case of the NdFC system, it became an almost clear sol-state NdFxCy (x and y are positive numbers). A methanol solution including 1 g/5 mL of NdFxCy (x and y are positive numbers) was used as the processing liquid.

(8) An organic metal compound which excludes carbon and is shown in Table 2 was added to the aforementioned solution.

Other processing liquids used for forming a coating film including a rare earth fluoride or alkaline earth metal fluoride as a main component can be made in the same processes as described above, and even if various elements are added to Dy, Nd, La, and Mg fluoride processing liquids, alkaline earth elements, or group 2 elements as shown in Table 2, the diffraction patterns of all solutions do not match the fluorine compound, oxyfluorine compound, or a compound with the additives shown as REnFm (RE is a rare earth or an alkaline earth element, and n and m are positive numbers).

The composition of the solution does not appreciably change if it is in the range of the concentrations of the added elements from Table 2. The diffraction pattern of the solution or the film formed by drying the solution had a plurality of peaks with a full width at half maximum of 1 degree or more. It indicates that the interatomic distance between the added element and fluorine or between the metallic elements is different from REnFmCp, and the crystal structure is also different from REnFmCp.

Since the full width at half maximum is 1 degree or more, the aforementioned interatomic distance does not have a definite value like a typical metal crystal but rather a certain distribution. The reason why it has such a distribution is due to other atoms being arranged around the aforementioned metallic element or fluorine atom, and the atom includes hydrogen, carbon, and oxygen as a main component and these atoms such as hydrogen, carbon, and oxygen easily migrate by applying external energy, such as heat, and the structure is changed and the flowability is also changed.

Although the sol and gel-state X-ray diffraction patterns consist of peaks which include a peak having a full width at half maximum of 1 degree or more, structural changes are observed by heat-treatment, resulting in apart of the diffraction pattern of the aforementioned REnFmCp or REn(F,C,O)m (herein, the ratio of F,O,C is arbitrary) being observed. It is considered that a major part of the added elements shown in Table 2 do not have a long-period structure in the solution.

The diffraction peak of REFmCp has a smaller full width at half maximum than the diffraction peaks of the aforementioned sol or gel. In order to increase the flowability of the solution and make the thickness of the coating film uniform, it is important to include at least one peak, which has a full width at half maximum of 1 degree or more in the aforementioned diffraction pattern of the aforementioned solution. Such a peak having a full width at half maximum of 1 degree or more and a diffraction pattern of REnFmCp or a peak of an oxyfluorine compound may be included.

When only a diffraction pattern of REnFmCp or oxyfluorine compound or a diffraction pattern having 1 degree or less is mainly observed as the diffraction pattern of the solution, a solid phase which is not a sol or a gel is contained in the solution, so that it is difficult to coat uniformly because of low flowability.

(9) A block of the NdFeB sintered body (10×10×10 mm³) is dipped in the solution during processing for forming the NdF system coating film and the solvent, methanol, is removed from the block under a reduced-pressure of 2 to 5 Torr.

(10) The operation described in (9) is repeated 1 to 5 times and it is heat-treated for 0.5 to 5 hours in a temperature range from 400° C. to 1100° C.

(11) A pulsed magnetic field of 30 kOe or more is applied in the anisotropic direction to the anisotropic magnet where the surface coating film is formed in (10).

This magnetized sample was placed between the magnetic poles in a DC M-H loop measuring instrument so that the magnetization direction agreed with the direction of the magnetic field application, and the demagnetization curve was measured by applying a magnetic field between the magnetic poles. An FeCo alloy was used for the pole piece of the magnetic pole for applying a magnetic field to the magnetized sample and the value of magnetization was calibrated by using a pure Ni sample and a pure Fe sample which have the same shape.

As a result, the coercive force of the NdFeB sintered body block on which a rare earth fluoride coating film is formed is increased, and, when it has no additives, the coercive forces of the sintered magnets where Dy, Nd, La and Mg carbon fluoride or carbon oxyfluoride are segregated increased 40%, 30%, 25%, and 20%, respectively. In order to further increase the coercive force which was increased by coating and heat-treating a solution without additives, the added elements shown in Table 2 are added to each fluoride solution by using an organic acid salt.

It is understood that the coercive force of the sintered magnet is increased and that these added elements contribute to an increase in the coercive force with reference to the coercive force of the solution without additives. A short range structure is observed in the vicinity of the elements added to the solution by removing the solvent and, when it is further heat-treated, it diffuses along the grain boundaries or various defects of the sintered magnet with the element included in the solution.

There is a tendency for these added elements to segregate in the vicinity of the grain boundaries with apart of the elements contained in the solution. The added elements shown in Table 2 diffuse into the sintered magnet with at least one element from fluorine, oxygen, and carbon and a part thereof remains in the vicinity of the grain boundaries. The composition of the sintered magnet having a high coercive force has a tendency for the concentration of the elements included in the fluoride solution to be high at the periphery of the magnet and low at the center of the magnet. This is due to the carbon fluoride solution including the added element being coated outside of the sintered magnet block and dried, and while fluoride, carbon fluoride, or oxyfluoride is grown which includes the added element and which has a short range structure, the diffusion progresses along the vicinity of the grain boundaries, cracks, or defects.

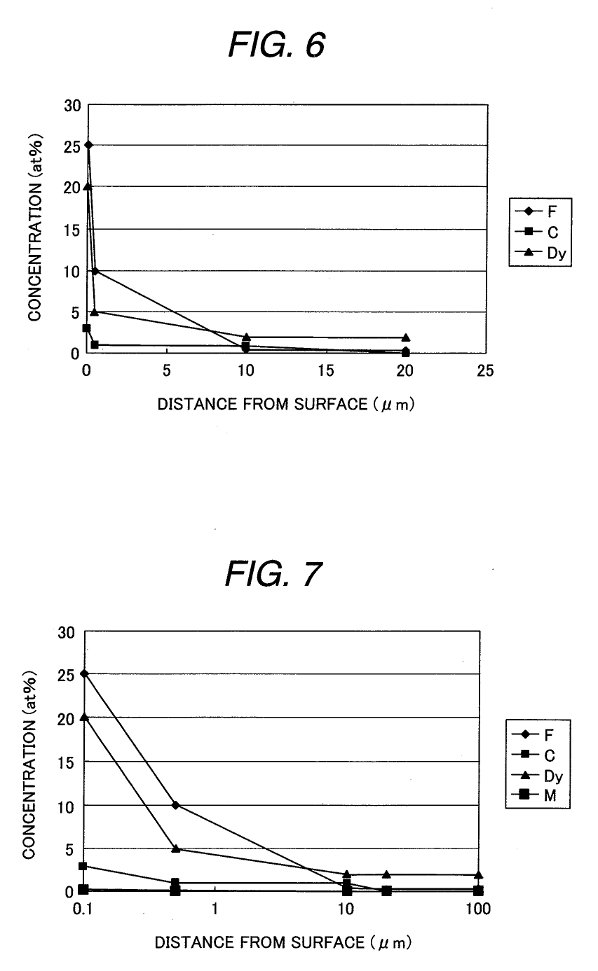

FIGS. 6 to 8 show concentration distributions from the surface to the interior of a sintered magnet. FIG. 6 is a case where a transition element is not included in the fluoride solution and the surface contains more fluoride than Dy and the content of fluoride becomes smaller than Dy in the interior of the sintered magnet. This is due to fluoride and oxyfluoride, which include Nd and Dy being grown in the vicinity of the surface. The concentration gradient of carbon is also observed, and carbon fluoride or carbon oxyfluoride is grown locally in the vicinity of the surface of the sintered magnet.

FIGS. 6 to 10 show the measurement results of concentration distribution when the transition metal element is assumed to be M.

There is a tendency for M, which is a transition material or an element, which is from group 2 to except for rare earth elements group 116, except for C and B to decrease from the surface of the sintered magnet toward the interior thereof, and it exhibits a tendency similar to carbon and fluorine. The inside and the surface have different ratios of the heavy rare earth element, Dy, and fluorine and there is a tendency for the surface to include more fluorine.

FIG. 7 shows concentration distributions of a sintered magnet where the concentration of fluorine and Dy are almost the same at the surface and where the concentration gradient of fluorine is greater than that of Dy in the interior of the sintered magnet. With respect to the concentration distributions of the transition metal element including carbon and elements shown in Table 2, decrease in the concentration is observed from the outside to the interior.

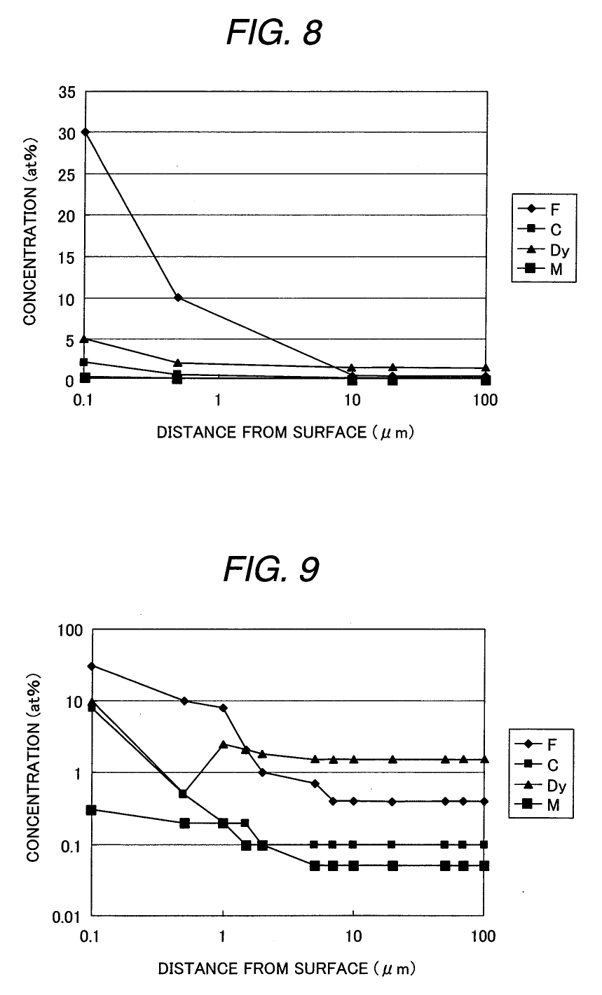

The concentration distribution shown in FIG. 8 is a case where the Dy concentration distribution has a minimum and the reaction layer is formed between a fluoride and the parent phase. More Nd is detected at the minimum part of the Dy concentration and the concentration distribution is obtained because an exchange reaction between Nd and Dy is created. Although the concentrations of fluorine, carbon, and the transition metal elements are decreased from outside to the interior, there is a case where the concentration distribution may take a maximum or minimum due to the effect of the reaction layer.

The tendency of the concentration distribution shown in FIGS. 6 to 8 can be observed in not only the sintered magnet but also NdFeB system magnetic particles and particles including a rare earth element, and an improvement of the magnetic properties can be observed. From the outside to the interior of the sintered magnet block, the concentration gradient or concentration fluctuation of at least one element selected from metallic elements from group 3 to group 11 including fluorine and elements shown in Table 2 or elements of group 2 and from group 12 to group 16 is observed.

The concentration of the these elements in the solution agrees with the range for maintaining the optical transparency; it is possible to manufacture the solution even if the concentration thereof is increased; and it is also possible to increase the coercive force. Therefore, improvement of the magnetic properties could be observed compared with the case of no additives so that a higher coercive force could be obtained even if a metallic element from group 3 to group 11 or an element of group 2 and from group 12 to group 16 except for B is added to any of fluorine, oxide, carbon fluoride, or oxyfluoride including at least one or more rare earth elements in a slurry state.

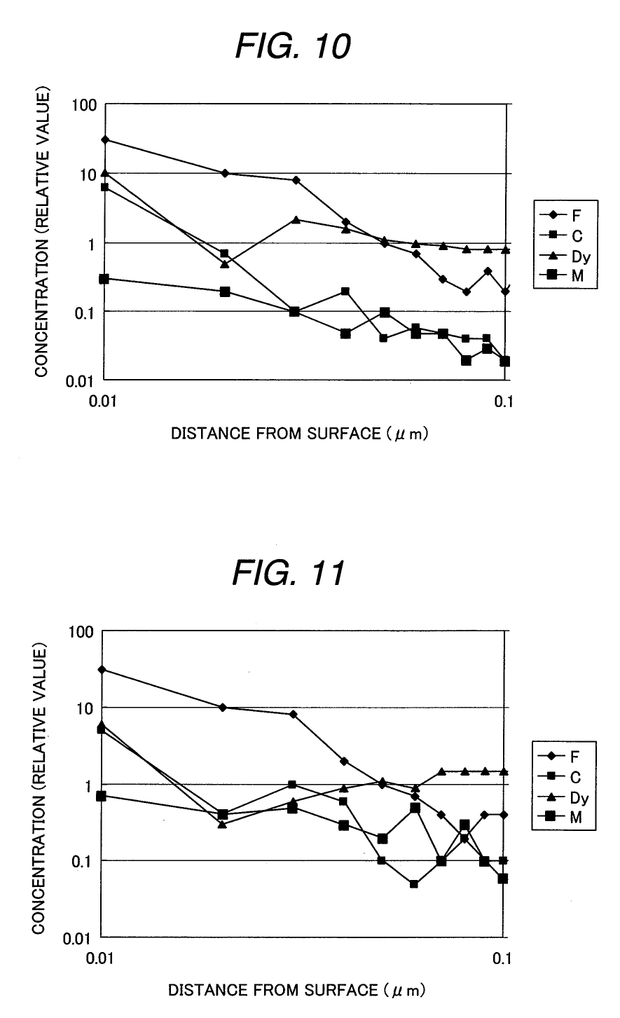

In FIGS. 9 and 10, although an area is observed where the concentration distribution of Dy increases toward the interior, it goes to a lower concentration at the center of the sintered magnet or it becomes constant at an area deeper than 0.1 μm.

In FIG. 11 a concentration of the transition elements in a direction from the surface to a depth does not decrease, but peaks are observed so that segregation of the transition elements were confirmed. In the segregated area a concentration of carbon was decreased, which may have some relation with bonding between carbon or Dy and transition elements. Segregation of transition elements was confirmed in the vicinity of an interface between fluoride or oxyfluoride and the mother phase, which may contribute to an increase in coercive force.

When the concentration of the added element is made to be 1000 times or more that of Table 2, the structure of the fluoride included in the solution is changed and the distribution of the added element becomes non-uniform, resulting in a tendency being observed whereby the diffusion of other elements is disturbed. As a result, an increase in the coercive force is partially observed although it becomes difficult to let the added element diffuse along the grain boundaries to the interior of the magnet block.

The role of the added elements, which are metallic elements selected from group 3 to group 11 or elements of group 2 and from group 12 to group 16 except for B is any of the following.

1) To decrease segregation in the vicinity of the grain boundaries and interface energy.

2) To improve lattice matching at the grain boundaries.

3) To decrease defects at the grain boundaries.

4) To enhance diffusion of the rare earth element at the grain boundaries.

5) To increase magnetic anisotropic energy in the vicinity of the grain boundaries.

6) To planarize the interface with fluoride or oxyfluoride.

7) To grow a phase, which includes the aforementioned additives having excellent corrosion resistance and having a fluorine concentration gradient, thereby, to improve the stability (adhesion) as a protection film by including iron and oxygen. Twins are observed at a part of the surface. As a result, according to coating the solution using the added elements and heat-treating for diffusion, any effect can be observed from an increase in the coercive force, improvement of the square-loop characteristics, increase in the remanent flux density, increase in the energy product, increase in the Curie point, decrease in the magnetization field, decrease in the temperature dependence of the coercive force and the remanent flux density, improvement of the corrosion resistance, increase in the specific resistance, and a decrease in the thermal demagnetization rate. Moreover, the concentration distributions of the added elements, which are metallic elements from group 3 to group 11 or elements of group 2 and from group 12 to group 16 except for B, have a tendency for the concentration to decrease in a balanced way from the outside to the interior of the sintered magnet and for the concentration to become higher at the grain boundaries or the surface.

The width of the grain boundary has a different tendency between the grain boundary triple point and a place away from the grain boundary triple point, and the width of the grain boundary triple point is wider. The average grain boundary width is 0.1 to 20 nm; a part of the added elements segregates in a distance from 1 to 1000 times of the grain boundary width; there is a tendency for the concentration of the segregated added elements to decrease in a balanced way from the surface of the magnet to the interior; and fluorine exists at a part of grain boundary phase.

The added elements segregate easily at either the edge of the grain boundary phase or grain boundaries or the periphery of the grain interior from the grain boundaries to the grain interior (grain boundary side). The additives in the solution which affected the improvement of the magnetic properties of the aforementioned magnet are Mg, Al, Si, Ca, Ti, V, Cr, Mn, Fe, Co, Ni, Cu, Zn, Ga, Ge, Sr, Zr, Nb, Mo, Pd, Ag, In, Sn, Hf, Ta, W, Ir, Pt, Au, Pb, Bi, and an element selected from an element having an atomic number from 18 to 86 including all transition metal elements, and a concentration gradient of at least one element selected from these elements and fluorine is observed in a balanced way from the outside to interior of the magnet or from the grain boundaries to the grain interiors in the sintered magnet.

The concentration gradient or the concentration fluctuation of metallic elements of group 3 to group 11 or added elements from group 2 and from group 12 to group 16 except for B have a tendency where it changes in a balanced way from the periphery to the center of the magnet and decreases as it approaches the center of the magnet. However, if the diffusion is sufficient, the concentration fluctuation of the added element is observed attendant with segregation of the added element in the vicinity of the grain boundaries, which contain fluorine.

After these added elements are processed by using the solution, they are diffused by heating, so that they have different composition distribution from that previously added to the sintered magnet, and there is a tendency for the concentration to become higher in the vicinity of the grain boundaries where fluorine is segregated.

On the other hand, segregation of elements previously added is observed in the vicinity of the grain boundaries where segregation of fluorine is small and it appears as an average concentration gradient from the surface to the interior of the magnet block. Even when the concentration of the added element is small in the solution, a concentration difference is observed between the surface of the magnet and the center of the magnet, and it can be confirmed as a concentration gradient or concentration fluctuation between the grain boundaries and grain interiors. Thus, when the added element is added to the solution and the characteristics of the sintered magnet are improved by heat-treatment after coating the magnet block, the features of the sintered magnet are as follows.

1) The concentration gradient or the average concentration fluctuation of elements from an atomic number of 18 to 86 including the elements shown in Table 2 or transition metal elements is observed from the surface which includes the reaction layer with the layer containing fluorine to the interior of the sintered magnet.

2) Segregation of elements from an atomic number of 18 to 86 including the elements shown in Table 2 or transition metal elements is observed with fluorine, carbon, or oxygen in the vicinity of grain boundaries.

3) The concentration of fluorine is high at the grain boundary phase and the concentration of fluorine is low outside of the grain boundary phase (the periphery of crystal grains), segregation of the elements shown in Table 2 or an element from an atomic number of 18 to 86 is observed at an area within a distance of 1000 times of the grain boundary width where the fluorine concentration fluctuation is observed, and an average concentration gradient and concentration fluctuation are observed from the surface to the interior of the magnet block.

4) The concentration of fluorine and added elements is highest at the outermost area of the sintered magnet block, magnetic particles, or ferromagnetic particles coated by the solution, a concentration gradient and concentration fluctuation of the added elements are observed from the outside to the interior of the magnet block.

5) A layer which includes fluorine, carbon, oxygen, iron, and an element in Table 2 or an element selected from an atomic number of 18 to 86 and which has a thickness from 1 to 10000 nm is formed to have a coverage rate of 10% or more, preferably 50%, and it contributes to an improvement of corrosion resistance and a recovery of the magnetic properties of the processing decomposition layer.

6) At least one element of the solution including the added elements shown in Table 2 and elements from an atomic number of 18 to 86 has a concentration gradient from the surface to the interior; the fluorine concentration is maximum at the outside seen from the magnet rather than the neighborhood of the interface or the interface between the magnet and the film which includes fluorine grown from the solution; fluoride in the vicinity of the interface includes oxygen, carbon, or elements from an atomic number of 18 to 86; and it contributes to any of high corrosion resistance, high electric resistance, or high magnetic properties. One or two or more elements selected from the added elements shown in Table 2 and an element from an atomic number of 18 to 86 are detected in the film including fluorine, the aforementioned added elements are included to a great extent in the vicinity of the diffusion path of the fluorine inside of the magnet, and any effect can be observed from an increase in the coercive force, improvement of the square-loop characteristics of the demagnetization curve, increase in the remanent flux density, increase in the energy product, increase in the Curie point, decrease in the magnetization field, decrease in the temperature dependence of the coercive force and the remanent flux density, improvement of the corrosion resistance, increase in the specific resistance, and a decrease in the thermal demagnetization rate, suppression of growth of the grain boundary width, and suppression of growth of the non-magnetic layer at the grain boundaries.

The concentration fluctuation of the aforementioned added elements can be confirmed by analyzing a sample, where the sintered block is cut from the surface side to the interior, using an EDX (energy dispersive X-ray) profile of a transmission electron microscope, EPMA analysis, and Auger analysis. By using an EDX and EELS of a transmission electron microscope, the added elements into the solution, which are selected from the elements from an atomic number of 18 to 86, segregate in the vicinity of the fluorine atoms (5000 nm or less from the segregation point of the fluorine atoms, more preferably, 1000 nm or less). The ratio of the added element segregating in the vicinity of fluorine atoms and the added element 2000 nm or more away from the segregation point of fluorine atoms is 1.01 to 1000 at the point which is 100 μm or more inside from the surface of the magnet, and, more preferably, it is 2 or more. The aforementioned ratio at the surface of the magnet is 2 or more. Both states exist, which are the part where the aforementioned added elements continuously segregate along the grain boundaries and the part where they segregate discontinuously.

It is not necessary that they segregate to all the grain boundaries and they easily become discontinuous at the center of the magnet. Moreover, a part of the added elements is not segregated and is mixed into the parent phase uniformly. The added element selected from an atomic number of 18 to 86 has a tendency for the ratio thereof to diffuse in the parent phase from the surface to the interior of the sintered magnet or the concentration of segregation in the vicinity of the segregation positions of fluorine to decrease, so that there is a tendency for the coercive force to be high at a position close to the surface compared with the interior of the magnet.

With regard to the improvement effects of the aforementioned magnetic properties, effects such as an improvement of the soft magnetic properties and an increase in the electric resistance of the magnetic particles can be obtained by performing diffusion heat-treatment not only in a sintered magnet block but also when a film including fluorine and the added elements is formed by using the solution shown in Table 2 over the surface of the NdFeB system magnetic particles, the SmCo system magnetic particles, or Fe system magnetic particles. Moreover, a sintered magnet can be manufactured by sintering after a film including an additive and fluorine is formed at a part of the surface of magnetic particles by impregnating a solution including a metallic element of group 3 to group 11 of an element of group 2 and from group 12 to group 16 except for C and B into a tentative molded body after tentatively molding NdFeB particles in a magnetic field, and by sintering after NdFeB particles are processed by using a solution including an metallic element from group 3 to group 11 or an element of group 2 and from group 12 to group 16 except for C and B is mixed with untreated NdFeB particles and they are tentatively molded in a magnetic field.

In such a sintered magnet, although the concentration distribution of the element included in the solution, such as fluorine and added elements in the solution is on average uniform, the magnetic properties are improved because the concentration of metallic elements of group 3 to group 11 or an element of group 2 and from group 12 to group 16 except for C and B is high on average in the vicinity of the diffusion path of fluorine atoms. The grain boundary phase including fluorine formed of such a metallic element of group 3 to group 11 or an element of group 2 and from group 12 to group 16 except for C and B includes 0.1 to 60 atomic % of fluorine on average, preferably, 1 to 20 atomic % in the segregation part; it can behave as non-magnetic, ferromagnetic, or antiferromagnetic depending on the concentration of the additives; and the magnetic properties can be controlled by increasing or decreasing the magnetic coupling between the ferromagnetic particles.

It is possible to form a soft magnetic material from a solution by using a fluorine solution in which an organic metal compound is added, thereby, a magnetic material having a coercive force of 0.5 MA/m at 20° C., which includes 1 to 20 atomic % of a rare earth element, 50 to 95 atomic % of at least one element selected from Fe, Co, Ni, Mn, and Cr, and 0.5 to 15 atomic % of fluorine as the composition. Eve if carbon, oxygen, and metallic elements from group 3 to group 11 or elements of group 2 and from group 12 to group 16 except C and B are partially included in a magnetic material with the aforementioned composition, 0.5 MA/m can be obtained, so that it can be applied to various kinds of magnetic circuits and the manufacturing process is not necessary because a solution is used.

In the present invention, plate-like phases including fluorine are formed at the grain boundaries or a part within the grains in an Fe system magnet material in order to improve the thermal resistance of the Fe system magnet including an R—Fe system (R is a rare earth element). The aforementioned phase including fluorine contributes to an improvement of the magnetic properties of the Fe system magnet. The magnet having a phase including fluorine is utilized in a magnet which has properties suitable for various kinds of magnetic circuits and a magnet motor using the aforementioned magnet. Motors for driving a hybrid automobile, for starters, and for electric power steering are included in such a magnet motor.

What is claimed is:

1. A magnet comprising a magnetic body containing iron and a rare earth element,
wherein a plurality of fluorine compound layers or oxyfluorine compound layers are formed interior of the magnetic body, and
wherein each of the fluorine compound layer or oxyfluorine compound layer has a major axis larger than the mean particle size of the crystal grains of the magnetic body.

2. The magnet according to claim 1,
wherein the mean particle size of the crystal grains of the magnetic body is 10 nm to 50 nm, and
wherein the major axis of the fluorine compound layer or oxyfluorine compound layer is 50 nm or more and 500 nm or less.

3. The magnet according to claim 1, wherein
the major axis of the fluorine compound layer or oxyfluorine compound layer has a size twice to twenty times the minor axis thereof.

4. The magnet according to claim 1, wherein
the fluorine compound layer or oxyfluorine compound layer contains at least one element selected from the group consisting of alkali elements, alkali earth elements and rare earth elements.

5. The magnet according to claim 1, wherein
the fluorine compound layer or oxyfluorine compound layer contains iron and a rare earth element constituting the magnetic body.

6. The magnet according to claim 1, wherein
the fluorine compound layer or oxyfluorine compound layer contains oxygen and carbon.

7. The magnet according to claim 1, wherein
the magnetic body contains NdFeB as a main component.

8. A sintered magnet comprising iron and a rare earth element,
wherein a plurality of fluorine compound layers or oxyfluorine compound layers are formed interior of the sintered magnet, and
wherein a major axis of the fluorine compound layer or oxyfluorine compound layer is 50 nm to 500 nm.

9. A magnet comprising a compression-molding of magnetic particles containing iron and a rare earth element,
wherein a plurality of fluorine compound layers and oxyfluorine compound layers are formed interior of the magnetic particles,
wherein each of the fluorine compound layer or oxyfluorine compound layer has a major axis larger than the mean particle size of the crystal grains of the magnetic particles.

10. The magnet according to claim 9,
wherein the mean particle size of the crystal grains of the magnetic particles is 10 nm to 50 nm, and
wherein the major axis of the fluorine compound layer or oxyfluorine compound layer is 50 nm to 500 nm.

11. The magnet according to claim 9, wherein
the major axis of the fluorine compound layer or oxyfluorine compound layer has a size twice to twenty times the minor axis thereof.

12. The magnet according to claim 9, wherein
the fluorine compound layer or oxyfluorine compound layer contains at least one element selected from the group consisting of alkali elements, alkali earth elements and rare earth elements.

13. The magnet according to claim 9, wherein
the fluorine compound layer or oxyfluorine compound layer contains iron and a rare earth element constituting the magnetic particles.

14. The magnet according to claim 9, wherein
the fluorine compound layer or oxyfluorine compound layer contains oxygen and carbon.

15. The magnet according to claim 9, wherein
the magnetic particles contain NdFeB as a main component.

16. The magnet according to claim 9, wherein
the plurality of precipitated fluorine compound layers and oxyfluorine compound layers are precipitated interior of the magnetic particles, and have the major axes orientated in different directions interior of the magnetic particles.

17. A processing method of a magnet comprising,
a first step where a magnetic body is coated with a fluorine compound solution, and
a second step where the magnetic body is heated after the first step and then a solvent of the fluorine compound solution is removed,
wherein the magnetic body contains iron and a rare earth element, and
wherein the fluorine compound solution is formed by dispersing a gel fluorine compound in an alcohol solvent.
